(19) United States
(12) Patent Application Publication
(10) Pub. No.: US 2026/0283291 A1
(43) Pub. Date: Sep. 24, 2026

(54) A HARD HAT WITH AN INTEGRATED ELECTRONIC SUBSYSTEM

(71) Applicant: XYZ REALITY LIMITED, London (GB)

(72) Inventors: Guy NEWSOM, London (GB); Lawrence HOAR, London (GB); Rupert WARRIES, London (GB); Edward BARRETT, London (GB); Pietro DESIATO, London (GB); Tobias KAPPELER, London (GB); Mark RANSLEY, London (GB); Kazimali KHAKI, London (GB); David MITCHELL, London (GB); Umar AHMED, London (GB)

(73) Assignee: XYZ REALITY LIMITED, London (GB)

(21) Appl. No.: 19/477,746

(22) PCT Filed: Apr. 18, 2024
(86) PCT No.: PCT/EP2024/060522

§ 371 Date: Oct. 22, 2025

(30) Foreign Application Priority Data
Apr. 26, 2023 (GB) 2306106.2

(51) Int. Cl. A42B 3/06; A42B 3/04; A42B 3/14; A42B 3/28

(52) U.S. Cl. CPC A42B 3/063; A42B 3/286; A42B 3/042; A42B 3/145

(57) ABSTRACT

A variety of improvements to equipment for use on a construction site are presented. Described improvements relate to one or more of a hard hat, a handheld controller, a tracking beacon, and a charging station, as well as sub-components of those elements and methods of use. The described improvements may be used to enhance the display of augmented reality information on a construction site. A hard hat (210) is described with at least one integrated electronic subsystem that comprises inner and outer portions. The integrated electronic subsystem may provide compute for an augmented reality display.

### FIELD OF THE INVENTION

Certain aspects of the present invention relate to devices for use on a construction site. In particular, certain examples relate to a set of components for displaying augmented reality (AR) information at a construction site. The set of components include a hard hat, removable portions of the hard hat, a controller, a tracking beacon, and a battery charging station. Methods of use are also described. Certain aspects may be used for applications on a construction site beyond augmented reality.

### BACKGROUND OF THE INVENTION

Construction sites present unique challenges for the design and use of construction tools. Historically, sophisticated electronic devices have been rare on a construction site. The design stage of a build typically takes place away from the construction site. It can involve a designer or architect producing a three-dimensional (3D) model, known as a Building Information Model (BIM), that represents the structure to be built. The design stage is typically performed in an office using high-specification computer workstations. Following the design stage, the BIM model is used to create a set of two-dimensional (2D) drawings (e.g., “blueprints”) that are sent to the construction site. There they are used to manage and guide the build. Paper is preferred as it is relatively hardy, and plans can always be reprinted if they are lost or damaged.

In recent years, advances have been made to bring together the design and build stages of construction projects. For example, WO2019/048866 A1 (also published as EP3679321), which is incorporated by reference herein, describes a headset for use in displaying a virtual image of a BIM within a construction site. In one example, the headset comprises an article of headwear having one or more position-tracking sensors mounted thereon, augmented reality glasses incorporating at least one display, and an electronic control system. The electronic control system is configured to convert a BIM defined in an extrinsic, real world coordinate system into an intrinsic coordinate system defined by a position tracking system, receive display position data from the display position device and headset tracking data from a headset tracking system and render a virtual image of the BIM relative to the position and orientation of the article of headwear on the construction site and transmit the rendered virtual image to the display which is viewable by the user. This effectively allows the user to view the proposed build as represented in the BIM as a virtual overlay on top of a view of the construction site seen through the augmented reality glasses.

WO2019/048866 A1 shows early iterations of a hard hat (e.g., as shown in FIG. 12 of that publication) and a handheld controller (e.g., as shown in FIG. 6 of that publication). The hard hat has one set of electronic components powered by a fixed internal rechargeable battery unit. The rechargeable battery unit may be recharged by coupling the battery unit to a power supply via a power connection socket (e.g., see paragraph [0256] of that publication). A set of augmented reality glasses are also provided, which are mounted inside a set of safety goggles that form part of the hard hat. The augmented reality glasses also have a fixed internal rechargeable battery unit, which again is connected to a power connector socket for recharging the battery unit.

US 2016/292918 A1, also incorporated by reference herein, additionally shows another design for a hard hat that accommodates a set of display units for viewing an augmented reality image. In US 2016/292918 A1, a hard hat is adapted to receive a display unit (e.g., see FIG. 4B of that publication), and the display unit is coupled to a wearable computer (e.g., see FIG. 2 of that publication). Preferably, in US 2016/292918 A1, the wearable computer is worn as a backpack by a user. The wearable computer is further connected to a replaceable battery that powers the whole system.

Real-world use of prototype systems, such as those shown in WO2019/048866 A1 and US 2016/292918 A1, on construction sites has identified a number of issues. Construction sites are noisy, dusty, and potentially dangerous places for the use of electronic devices, especially electronic devices that have traditionally been used for home or office applications. Safety is often paramount, but this has to be balanced with the comfort of a user, who is often on site for long periods of time. Augmented reality within the construction site also presents opportunities for new forms of user interaction to display and interrogate BIM data (e.g., person-device interactions).

EP3508087 A1 describes a ballistic helmet system, e.g. for use by military personnel, that comprises a base layer that is configured to retain an integrated circuit layer, the integrated circuit layer being electrically coupled to one or more powered devices. An outer layer serves to retain the circuit layer and integrated devices. In a main illustrated embodiment, a battery pack includes a mount which removably receives a powered shoe on a rear helmet bracket. In an alternative embodiment, a battery compartment includes mounting rails for connection to the rear of the helmet. This battery compartment may be secured in position via threaded fasteners. The battery compartment includes a housing that receives rechargeable batteries, such as 3-volt lithium (CR123) batteries. In certain embodiments, electrical circuitry within the battery compartment includes a switch for selective electrical coupling of a selected one of a set of cell batteries. This switch may be a rotary switch on a circuit board that includes a lever. A user uses the lever to switch between different batteries.

GB2608001 A describes a safety helmet for an industrial worker comprising an array of light-emitting elements, a communication module configured to provide two-way remote communication with a remote central controller, and a local controller configured to receive instructions from the central controller via the communication module and to operate the light-emitting elements in response. The colour, number, and/or intensity of the light-emitting elements operating may be controlled. The helmet may include a sensor that receives instructions from, and sends data to, the central controller, where said data may be used to control the light-emitting elements. The helmet may include an output device operated via instructions from the central controller. The light-emitting elements may be located in a cavity between inner and outer helmet layers, where the outer layer may include a diffusing element.

CN214179334 U describes a smart helmet for safe construction. A safety construction smart helmet structure is described, including a cap shell, where the cap shell is provided with a matching inner shell, and the inner shell is provided with a cap liner. The cap substrate end is hinged with a mandibular band, a locking clip is arranged on the mandibular band, an integrated circuit board and a battery are arranged between the cap shell and the inner shell, and the integrated circuit board and the battery are electrically connected. The inner shell is equipped with loudspeakers, and two sets of loudspeakers are arranged. The cap shell is provided with a power switch, the power switch is electrically connected to the battery. The front end of the cap shell is provided with a camera. A memory card is provided on the cap liner. The camera is electrically connected to the memory card through an integrated circuit board. A micro switch is provided on one side of the cap shell, and the micro switch is electrically connected to the camera. A headset is arranged on the cap shell. The headset is electrically connected to the integrated circuit board, and a flashlight is hinged on the cap shell.

CN110934370 A describes an intelligent helmet system with a real-time video monitoring function, which can provide data for later accident retrospective analysis. The safety helmet includes an outer shell, a buffer mechanism and an inner lining. The buffer mechanism is provided with a positioning module, a human body status sensor, a miniature camera, a buzzer and a communication module.

GB2603496 A1 describes a headset for use in construction at a construction site. The headset has an article of headwear, sensor devices for a plurality of positioning systems, each positioning system having a corresponding coordinate system, a head-mounted display for displaying a virtual image of a building information model, and an electronic control system with at least one processor. The at least one processor is configured to obtain a set of transformations that map between the coordinate systems of the plurality of positioning systems. The publication describes how to align multiple coordinate systems for information model rendering.

CN107951114A describes a construction protective helmet. The construction protective helmet, includes an outer protective layer. A fan is connected to the top of the outer protective layer, and an air intake plate is connected to the middle of the top of the outer protective layer.

U.S. Pat. No. 6,122,773 A describes a ventilated hardhat with an integrated fan.

US2013/254978 A1 describes a protective helmet and insert for reducing the possibility or severity of a concussion. The protective helmet may be used for sports. The insert comprises a shock absorbing portion and a flexible liner portion, the shock absorbing portion to be disposed between a helmet shell and the liner portion. The shock absorbing portion can possess a constant resistive deformation force characteristic for reducing the peak G-force applied to the head during an impact.

U.S. Pat. No. 3,758,889 A describes a shock absorbing safety or protective helmet of the hard-hat type having a head engaging suspension system which is removably interconnectable in the helmet, including free crossed crown straps, a detachable size adjustable headband and nape strap, and a detachable soft pliable sweatband, the entire suspension system being mountable by suspension lugs at the free ends of the crossed straps, the lugs having lateral side shear pins and being slidably suspended in holders on the interior of the helmet shell, the lugs and shear pins serving to resiliently resist seating of the lugs in the holders and thereby increase absorption of impact shocks on the helmet.

### SUMMARY OF THE INVENTION

Aspects of the present invention are set out in the appended independent claims. Variations of these aspects are set out in the appended dependent claims. Examples that are not claimed are also set out in the description below.

### BRIEF DESCRIPTION OF THE DRAWINGS

Examples of the invention will now be described, by way of example only, with reference to the accompanying drawings, in which:

FIG. 1A is a schematic illustration of an example augmented system in use at a construction site.

FIG. 1B is a schematic illustration showing how BIM data may be aligned with a view of the construction site.

FIGS. 2A to 2H are schematic illustrations showing different views and configurations of an example hard hat with at least one integrated electronic subsystem.

FIGS. 3A to 3D are schematic illustrations showing inner and outer portions of an example hard hat with at least one integrated electronic subsystem.

FIGS. 4A to 4E are schematic illustrations showing an example deformable ventilation coupling for the inner and outer portions of the example hard hat.

FIGS. 5A to 5G are schematic illustrations showing an example battery coupling interface and an example detachable casing portion.

FIG. 6 is a schematic illustration showing an example location of a centre of gravity for the example hard hat.

FIGS. 7A to 7C are schematic illustrations showing an example cradle height adjustment mechanism.

FIGS. 8A to 8D are schematic illustrations showing different views of an example handheld controller.

FIGS. 9A to 9C are schematic illustrations showing different views of an example tracking beacon.

FIGS. 10A and 10B are schematic illustrations showing different views of an example battery charging station.

FIG. 11 is a schematic illustration showing use of the example handheld controller.

FIGS. 12A and 12B are flow diagrams showing example methods of manipulating virtual objects in AR views using the example handheld controller.

FIG. 13 is a schematic illustration showing the performance of the example method of FIG. 12B.

FIG. 14 is a flow diagram showing an example method of preparing BIM data for use in augmented reality applications.

FIGS. 15A and 15B are schematic illustrations showing example user interfaces associated with the example method of FIG. 14.

FIGS. 16A to 16L are schematic illustrations showing a stages in an example method for aligning a building information model with an augmented reality view.

FIG. 17 is a flow diagram showing the example method for aligning a building information model with an augmented reality view.

### DETAILED DESCRIPTION

### Introduction

The present description presents a variety of improvements to equipment for use on a construction site. Described improvements relate to one or more of a hard hat, a handheld controller, a tracking beacon, and a charging station, as well as sub-components of those elements and methods of use. The described improvements are particularly suited to enhancing the display of augmented reality information on a construction site. For example, described aspects improve comfort and ease-of-use for a user, such as a user who is wearing a hard hat with an augmented reality display.

The present description sets out a number of different innovations. These include, amongst others: a hard hat with at least one integrated electronic subsystem that comprises inner and outer portions, e.g. a dual shell or layer design; a deformable ventilation coupling for a multilayer hard hat that provides air flow for a user's head and energy absorbing properties; a hard hat with at least one integrated electronic subsystem that comprises a plurality of battery coupling interfaces for coupling a plurality of removable batteries, where those batteries may be “hot swappable” whilst maintaining power to the subsystem; a detachable battery casing for a removable battery for a hard hat; a kit for use on a construction site to provide an augmented reality view of the construction site; a cradle height adjustment mechanism for a hard hat; a moveable controller, such as a handheld controller, with a distance measurement device; methods of using the moveable controller that allow a user to interact with both real and virtual worlds; and a method of preparing 3D BIM data for use in an augmented reality application. Each of these aspects may be applied and used separately or combined in any combination. Various details and advantages of each aspect are set out with the corresponding description of the aspect.

The presently described aspects improve upon the headsets described in WO2019/048866 A1 and/or US 2016/292918 A1. They provide greater user comfort, easier interaction with the virtual world, improved safety, and better longevity of use, amongst other benefits.

### Certain Term Definitions

Where applicable, terms used herein are to be defined as per the art. To ease interpretation of the following examples, explanations and definitions of certain specific terms are provided below.

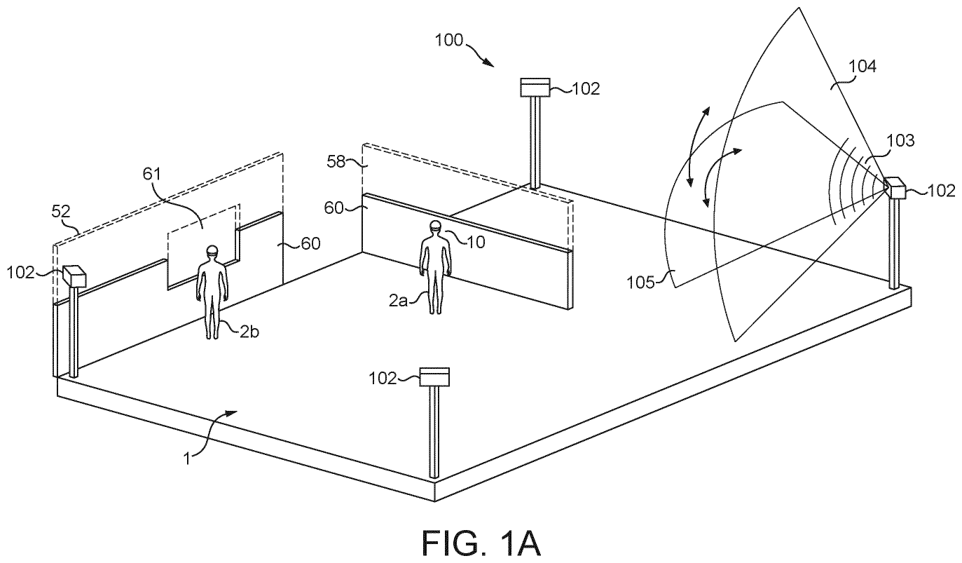

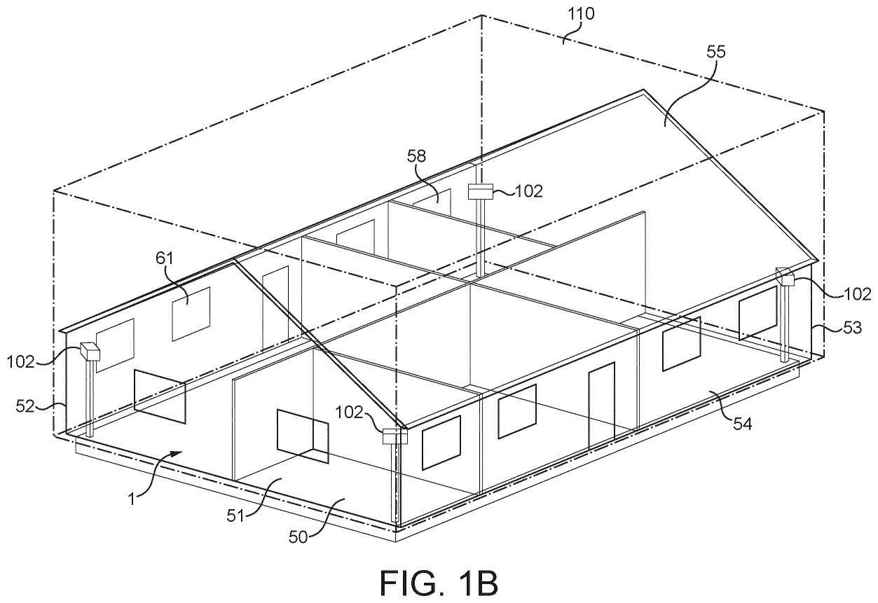

The term “positional tracking system” is used to refer to a system of components for determining one or more of a location and orientation of an object within an environment. The object in certain cases comprises a hand hat or handheld controller. The terms “positioning system” and “tracking system” may be considered alternative terms to refer to a “positional tracking system”, where the term “tracking” refers to the repeated or iterative determining of one or more of location and orientation over time. A positional tracking system may be implemented using a single set of electronic components that are positioned upon an object to be tracked, e.g. a stand-alone system installed in the headset. In other cases, a single set of electronic components may be used that are positioned externally to the object. In certain cases, a positional tracking system may comprise a distributed system where a first set of electronic components is positioned upon an object to be tracked and a second set of electronic components is positioned externally to the object (e.g., as described later with respect to FIGS. 1A and 1B). The electronic components may comprise sensors and/or processing resources (such as cloud computing resources). A positional tracking system may comprise processing resources that may be implemented using one or more of an embedded processing device (e.g., upon or within the object) and an external processing device (e.g., a server computing device). In preferred examples, a tracking system uses a kit of components that may be carried to a construction site (e.g., does not require a remote server for use). Reference to data being received, processed and/or output by the positional tracking system may comprise a reference to data being received, processed and/or output by one or more components of the positioning system, which may not comprise all the components of the positional tracking system. Certain positional tracking systems described herein comprise externally mounted tracking beacons and devices such as hard hats and handheld controllers with corresponding sensors. However, it should be noted that different improvements described herein are not necessarily limited to the use of such a positional tracking system and said improvements may be used with other types of positional tracking systems (e.g., stand-alone camera-based systems).

The term “pose” is used herein to refer to a location and orientation of an object. For example, a pose may comprise a coordinate specifying a location with reference to a coordinate system and a set of angles representing orientation of a point or plane associated with the object within the coordinate system. The point or plane may, for example, be aligned with a defined face of the object or a particular (reference) location on the object. In certain cases, an orientation may be specified as a normal vector or a set of angles with respect to defined orthogonal axes. In other cases, a pose may be defined by a plurality of coordinates specifying a respective plurality of locations with reference to the coordinate system, thus allowing an orientation of a rigid body encompassing the points to be determined. For a rigid object, the location may be defined with respect to a particular point on the object. A pose may specify the location and orientation of an object with regard to one or more degrees of freedom within the coordinate system. For example, an object may comprise a rigid body with three or six degrees of freedom. Three degrees of freedom may be defined in relation to translation with respect to each axis in 3D space, whereas six degrees of freedom may add a rotational component with respect to each axis. In other cases, three degrees of freedom may represent two orthogonal coordinates within a plane and an angle of rotation (e.g., [x, y, θ]). Six degrees of freedom may be defined by an [x, y, z, roll, pitch, yaw] vector, where the variables x, y, z represent a coordinate in a 3D coordinate system and the rotations are defined using a right-hand convention with respect to three axes, which may be the x, y and z axes. In examples herein relating to a headset, the pose may comprise the location and orientation of a defined point on the headset, or on an article of headwear that forms part of the headset, such as a centre point within the headwear calibrated based on the sensor positioning on the headwear. In certain cases, a pose of an object defined with reference to a centroid of that object may be transformed to a pose defined at another point in fixed relation to the centroid, e.g. a pose of a hard hat defined with respect to a central point within the hard hat may be mapped to a pose indicating a location and view direction for a set of coupled augmented reality glasses. It should be noted that different coordinate systems may be used (e.g., using different basis functions as axes) to represent the same location and orientation information, where defined transformations may convert between different coordinate systems. For example, polar-coordinate systems may be used instead of cartesian-coordinate systems. In certain cases, a pose may be defined using one or more of: a set of three Cartesian coordinates and a set of three Euler angles; a set of three Cartesian coordinates and a rotation matrix (e.g., that maps a set of axes of an object as defined with reference to an origin of the object to a set of axes for a reference coordinate system); a set of three Cartesian coordinates and a set of quaternions; and a homogeneous transformation matrix (e.g., that maps the origin of the object to the origin of the reference coordinate system).

The term “coordinate system” is used herein to refer to a frame of reference, e.g. as used by a positional tracking system and a BIM. For example, a pose of an object may be defined within three-dimensional geometric space, where the three dimensions have corresponding orthogonal axes (typically x, y, z) within the geometric space. An origin may be defined for the coordinate system where lines defining the axes meet (typically, set as a zero point—(0, 0, 0)). Locations for a coordinate system may be defined as points within the geometric space that are referenced to unit measurements along each axis, e.g. values for x, y, and z representing a distance along each axis. In certain cases, quaternions may be used to represent at least an orientation, of an object such as a headset or camera within a coordinate system. In certain cases, dual quaternions allow positions and rotations to be represented. A dual quaternion may have 8 dimensions (i.e., comprise an array with 8 elements), while a normal quaternion may have 4 dimensions.

The terms “intrinsic” and “extrinsic” are used in certain examples to refer respectively to coordinate systems within a positional tracking system and coordinate systems outside of any one positional tracking system. For example, an extrinsic coordinate system may be a 3D coordinate system for the definition of an information model, such as a BIM, that is not associated directly with any one positioning system, whereas an intrinsic coordinate system may be a separate system for defining points and geometric structures relative to sensor devices for a particular positional tracking system.

Certain examples described herein use one or more transformations to convert between coordinate systems. The term “transformation” is used to refer to a mathematical operation that may be performed on one or points (or other geometric structures) within a first coordinate system to map those points to corresponding locations within a second coordinate system, or to map between points within the first coordinate system. For example, a transformation may map an origin defined in a first coordinate system to a point that is not the origin in a second coordinate system. A transformation may be performed using a matrix multiplication. In certain examples, a transformation may be defined as a multi-dimensional array (e.g., matrix) having rotation and translation terms. For example, a transformation may be defined as a 4 by 4 (element) matrix that represents the relative rotation and translation between the origins of two coordinate systems. The terms “map”, “convert” and “transform” are used interchangeably to refer to the use of a transformation to determine, with respect to a second coordinate system, the location and orientation of objects originally defined in a first coordinate system. It may also be noted that an inverse of the transformation matrix may be defined that maps from the second coordinate system to the first coordinate system.

Certain examples described herein refer to “portions” or “components” of an artifact. These may comprise removable portions or separable parts of the artifact that are fastened or otherwise joined to produce a finished article. Parts described as removable or separable may be removable or separable in specific circumstances, e.g. when being assembled during manufacturing or dissembled during repair, and/or may be removable or separable in use, e.g. on completing a set of one or more actions such as uncoupling or releasing the part.

Certain examples described herein are directed towards a “hard hat”. This is used to refer to a form of helmet to be worn on the head of a user to provide protection against one or more of falling objects, impact, and electrical shock. The examples of a hard hat described herein have an outer rigid portion that provides at least one element of protection for a user's head.

Certain examples describe a hard hat that is used as a “headset”. The term “headset” is used to refer to a device suitable for use with a human head, e.g. mounted upon or in relation to the head. The term has a similar definition to its use in relation to so-called virtual or augmented reality headsets. In certain examples, a headset comprises an article of headwear, such as a hard hat, although the headset may be supplied as a kit of separable components. These separable components may be removable and may be selectively fitted together for use, yet removed for repair, replacement and/or non-use.

Although the term “augmented reality” (AR) is used herein, it should be noted that this is deemed to be inclusive of so-called “virtual reality” (VR) approaches, e.g. includes all approaches regardless of a level of transparency of an external view of the world. For example, the phrase “pass through” is sometimes used in the context of “virtual reality” to refer to an AR-like display of digital information on an image of the outside world that is acquired by cameras upon the VR headset. The use of the terms “augmented reality headset” or “augmented reality” covers such VR headsets used in a pass-through mode to provide AR information. The term “augmented reality” also covers so-called “mixed reality” (MR) approaches wherein aspects of a virtual world are “mixed” with aspects of the real world. It is noted that different terms are used depending on the fashion to refer to similar approaches to display renderings of virtual representations in relation to viewed or captured aspects of a visible world. For ease of reference, all such approaches are deemed to fall within the currently used term “augmented reality”, where a view of reality (e.g., an external world) is enhanced with rendered objects that are not present in that reality.

Certain positional tracking systems described herein use one or more sensor devices to track an object. Sensor devices may include, amongst others, monocular cameras, stereo cameras, colour cameras, greyscale cameras, event cameras, time-of-flight cameras, depth cameras, infra-red cameras, active markers, passive markers, photodiodes for detection of electromagnetic radiation, radio frequency identifiers, radio receivers, radio transmitters, and light transmitters including laser transmitters. A positional tracking system may comprise one or more sensor devices upon an object. Certain, but not all, positional tracking system may comprise external sensor devices such as swept-beam tracking beacons or camera devices. For example, an optical positioning system to track an object with active or passive markers within a tracked volume may comprise externally mounted greyscale camera plus one or more active or passive markers on the object. Certain positional tracking systems may use a combination of sensor devices to track an object, such as photo sensors and a camera assembly. In other examples, multiple positional tracking systems using different sensor devices may be used and sensor data for those tracking systems may be fused to display augmented reality views.

Certain examples provide a headset for use on a construction site. The term “construction site” is to be interpreted broadly and is intended to refer to any geographic location where objects are built or constructed. A “construction site” is a specific form of an “environment”, a real-world location where objects reside. Environments (including construction sites) may be both external (outside) and internal (inside). Environments (including construction sites) need not be continuous but may also comprise a plurality of discrete sites, where an object may move between sites. Environments include terrestrial and non-terrestrial environments (e.g., on sea, in the air or in space).

The term “render” has a conventional meaning in the image processing and augmented reality arts and is used herein to refer to the preparation of image data to allow for display to a user. In the present examples, image data may be rendered on a head-mounted display for viewing. The term “virtual image” or “augmented reality image” is used in an augmented reality context to refer to an image that may be overlaid over a view of the real-world, e.g. may be displayed on a transparent or semi-transparent display (e.g., an image overlay) when viewing a real-world object or may comprise an image composed from a captured view of a line of sight and digital information. In certain examples, a virtual image may comprise an image relating to an “information model”. The term “information model” is used to refer to data that is defined with respect to an extrinsic coordinate system, such as information regarding the relative positioning and orientation of points and other geometric structures on one or more objects. For example, the information model may be defined with respect to geodetic or geocentric coordinates on the Earth's surface plus an altitude (e.g., a height above a defined sea level or reference point). In examples described herein the data from the information model is mapped to known points within the real-world as tracked using one or more positional tracking system, such that the data from the information model may be appropriate prepared for display with reference to the tracked real-world. For example, general information relating to the configuration of an object, and/or the relative positioning of one object with relation to other objects, that is defined in a generic 3D coordinate system may be mapped to a view of the real-world and one or more points in that view.

The terms “control system” and “electronic subsystem” are used herein to refer to either hardware structure that has a specific function (e.g., in the form of mapping input data to output data) or a combination of general hardware and specific software (e.g., specific computer program code that is executed on one or more general purpose processors). An “engine” or a “control system” as described herein may be implemented as a specific packaged chipset, for example, an Application Specific Integrated Circuit (ASIC) or a programmed Field Programmable Gate Array (FPGA), and/or as a software object, class, class instance, script, code portion or the like, as executed in use by a processor. The term “integrated electronic subsystem” is used herein to describe physical components that operate by controlling the behaviour of electrons within a material. The term “integrated” is used to refer to the fact that the subsystem is provided as part of a larger system, e.g. a hard hat. The subsystem may be removable or fixed and generally has a defined position within the larger system for use. The subsystem may be mounted within the larger system. The term “subsystem” is used to refer to the fact that certain electronic components provide one or more functions within the larger system. In one case, the integrated electronic subsystem comprises a processor and memory to perform computation, e.g. the integrated electronic subsystem may comprise an embedded computer (also referred to as a compute module). The integrated electronic subsystem may also additionally comprise sensors and/or sensor processing circuitry and/or components.

The term “camera” is used broadly to cover any camera device with one or more channels that is configured to capture one or more images. In this context, a video camera may comprise a camera that outputs a series of images as image data over time, such as a series of frames that constitute a “video” signal. It should be noted that any still camera may also be used to implement a video camera function if it is capable of outputting successive images over time. Reference to a camera may include a reference to any light-based sensing technology including event cameras and LIDAR sensors (i.e., laser-based distance sensors). An event camera is known in the art as an imaging sensor that responds to local changes in brightness, wherein pixels may asynchronously report changes in brightness as they occur, mimicking more human-like vision properties.

The term “image” is used to refer to any array structure comprising data derived from a camera. An image typically comprises a two-dimensional array structure where each element in the array represents an intensity or amplitude in a particular sensor channel. Images may be greyscale or colour. In the latter case, the two-dimensional array may have multiple (e.g., three) colour channels. Greyscale images may be preferred for processing due to their lower dimensionality. For example, the images processed in the later described methods may comprise a luma channel of a YUV video camera.

The term “coupling” is used to refer to components that allow one or more of physical and electronic communication, where the meaning is typically apparent from the context of use. A physical coupling may physically join two different artifacts. An electronic coupling may allow for analogue and/or digital communication between two items of electronics. An electronic may, additional or alternatively, provide power. The term “interface” is similarly used to refer to one or more of mechanical, hardware, and software interfaces for coupling two or more components. A hardware and/or mechanical interface may comprise complementary surfaces that allow a rigid fit and, in certain cases, flow of electrical signals.

It should be noted that in the art, the acronym “BIM” is used to refer both to “Building Information Modelling” and a “Building Information Model” (as terminology has evolved organically over the last 2-3 decades). References herein to “a BIM” or “the BIM” are references to Building Information Models, i.e. Building Information Modelling models. The term “BIM model” is also sometimes used and is synonymous with use of “a BIM” or “the BIM”, i.e. both refer to a three-dimensional model of a building. The term “BIM data” is used to refer to data that defines at least a portion of a BIM model. References to a BIM and a BIM model also include references to portions of such models, e.g. a complete model for a building may have thousands or hundreds of thousands of three-dimensional elements representing construction across a plurality of different stages in a plurality of different locations, and so only a subset of the complete model may be loaded at any one time.

### General Example of AR Display on a Construction Site

A first example that introduces how augmented reality information may be displayed on a construction site is shown in FIG. 1A. It should be noted that the positional tracking system described in this example is provided for ease of understanding the present invention. While preferred, it is not to be taken as limiting; the present invention may be applied with many different types of positional tracking system.

FIG. 1A shows a location 1 in a construction site. FIG. 1A shows a positional tracking system 100 that is set up at the location 1. In the present example, the positional tracking system 100 comprises a laser-based positional tracking system similar to that described in WO2019/048866 A1; however, this positional tracking system is used for ease of explanation and the present embodiment is not limited to this type of positional tracking system. In other implementations different positional tracking systems may be used, including optical marker-based high-accuracy positioning systems such as those provided by NaturalPoint, Inc of Corvallis, Oregon, USA (e.g., their supplied OptiTrack systems), and monocular, depth and/or stereo camera simultaneous localisation and mapping (SLAM) systems. SLAM systems may be sparse or dense, and may be feature-based and/or use trained deep neural networks. So-called direct systems may be used to track pixel intensities and so-called indirect systems may be feature-based. Indirect methods may be trained using deep neural networks. Examples of “traditional” or non-neural SLAM methods include ORB-SLAM and LSD-SLAM, as respectively described in the papers “ORB-SLAM: a Versatile and Accurate Monocular SLAM System” by Mur-Artal et al. published in IEEE Transactions on Robotics in 2015 and “LSD-SLAM: Large-Scale Direct Monocular SLAM” by Engel et al as published in relation to the European Conference on Computer Vision (ECCV), 2014, both of these publications being incorporated by reference herein. Example SLAM systems that incorporate neural network architectures include “CodeSLAM—Learning a Compact Optimisable Representation for Dense Visual SLAM” by Bloesch et al (published in relation to the Conference on Computer Vision and Pattern Recognition—CVPR—2018) and “CNN-SLAM: Real-time dense Monocular SLAM with Learned Depth Prediction” by Tateno et al (published in relation to CVPR 2017), these papers also being incorporated by reference herein. It is also noted that positional tracking systems may also be based on neural network representations of a 3D space such as those based on a Neural Radiance Field (“NeRF”) representation as described in the paper “NeRF: Representing Scenes as Neural Radiance Fields for View Synthesis” by Ben Mildenhall et al published on arXiv on 19 Mar. 2020. Data from different approaches may also be fused in a combinatory or “fused” system. For example, short-term (e.g., milliseconds or seconds) tracking may be performed in combination with one or more Inertial Measurement Units (IMUs) mounted within a tracked object.

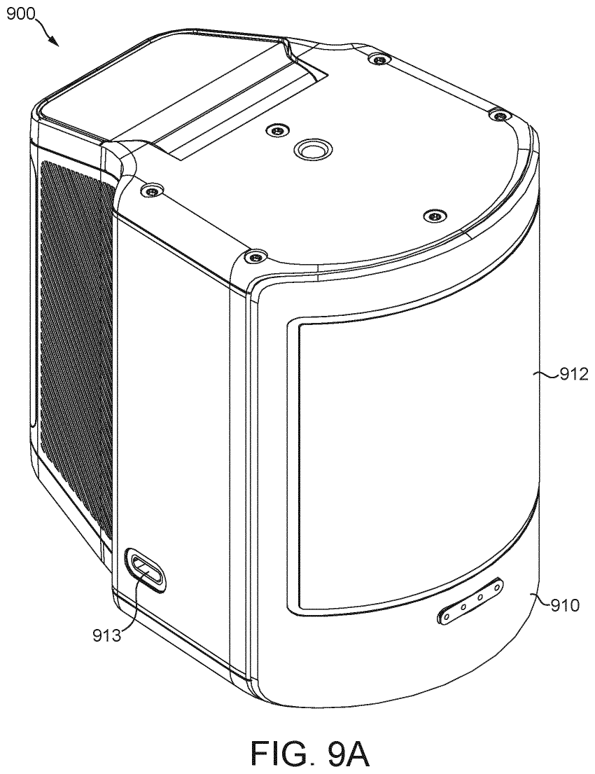

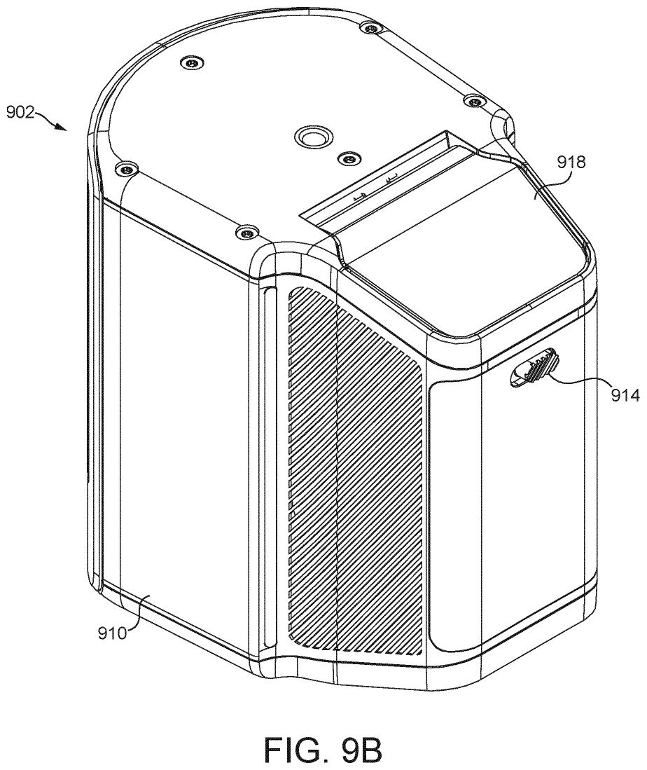

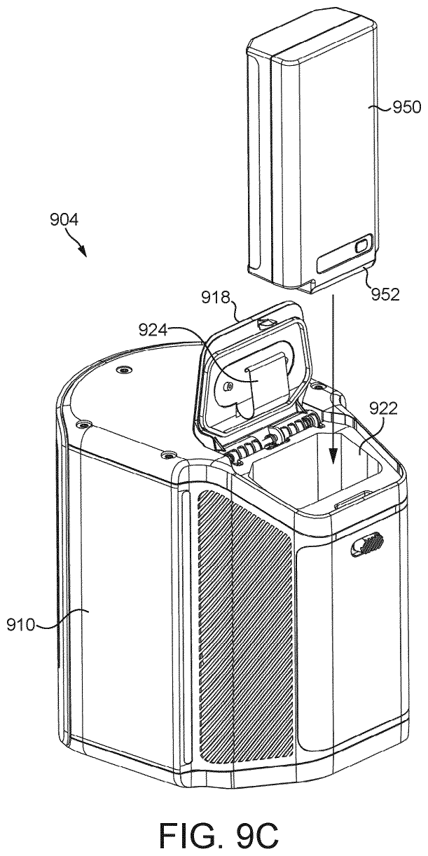

In FIG. 1A, the example positional tracking system 100 comprises a plurality of spaced apart tracking beacons 102. In one particular implementation example, a tracking beacon 102 comprises a device that is selectively operable to emit an omnidirectional synchronisation pulse 103 of infrared light and comprises one or more rotors that are arranged to sweep one or more linear non-visible optical fan-shaped beams 104, 105 across the location 1, e.g. on mutually orthogonal axes as shown. An example tracking beacon is described later with reference to FIGS. 9A to 9C. In the present example, the tracking beacons 102 are separated from each other by a distance of up to about 5-10 m. In the example of FIG. 1A, four tracking beacons 102 are employed, but in other embodiments fewer than four tracking beacons 102 may be used, e.g. one, two or three tracking beacons 102, or more than four tracking beacons. It will be understood that the tracking beacons 102 may be omitted for certain forms of SLAM positional tracking system. As described in WO2019/048866 A1, by sweeping the laser beams 104, 105 across the construction site 1 at an accurate constant angular speed and synchronising the laser beams 104, 105 to an accurately timed synchronisation pulse 103, each tracking beacon 102 in the laser positional tracking system may generate two mutually orthogonal spatially-modulated optical beams 104, 105 in a time-varying manner that can be detected by opto-electronic sensors within the tracked volume for locating the position and/or orientation of one or more tracked objects within the tracked volume. Other positional tracking systems may use other technologies to track an object using different technologies, including the detection of one or more active or passive markers located on the object as observed by tracking devices in the form of one or more cameras mounted with the tracking beacons 102 and observing the tracked volume. In SLAM systems tracking may be performed based on a stream of data from one or more camera devices (and possible additional odometry or inertial measurement unit—IMU—data).

FIG. 1A also shows two users 2a, 2b. Each user wears a hard hat 10 with an integrated augmented reality headset, wherein the device has sensors that are arranged to detect signals emitted from one or more of the tracking beacons 102. The hard hats 10 are configured to be located within the location 1. The users 2a, 2b use the augmented reality headset to view, via a head-mounted display (HMD), a virtual image of one or more internal partitions 52, 58 that are defined in the BIM and that may be aligned with part-constructed portions of a building 60.

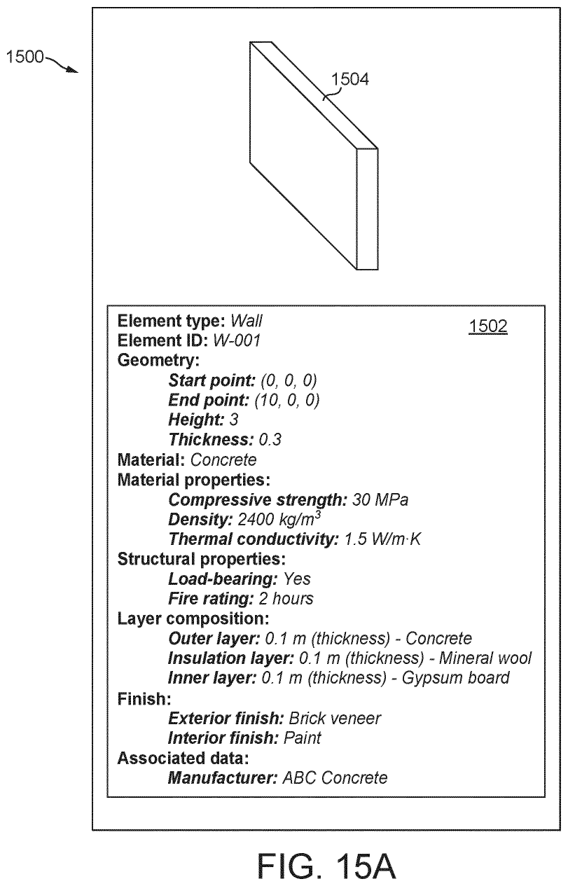

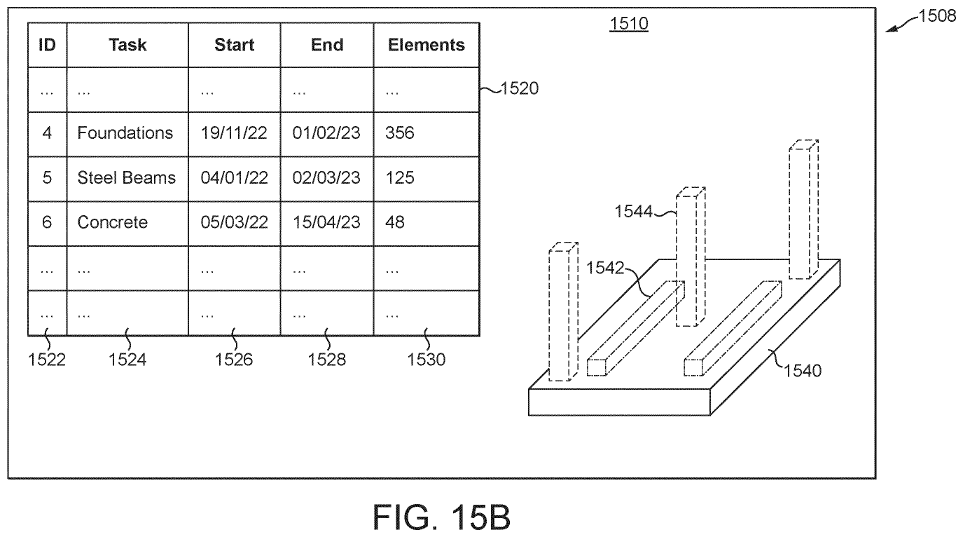

As another example, FIG. 1B shows a three-dimensional BIM 110 for a building 50 to be constructed. The building 50 has exterior walls 51, 52, 53, 54, a roof 55 and interior partitions, one of which is shown at 58. One of the walls 52 is designed to include a window 61. The BIM 110 is defined with respect to an extrinsic coordinate system, which may be a geographic coordinate system (e.g., a set of terrestrial coordinates) or a specific Computer Aided Design (CAD) reference origin. By configuring the alignment of the BIM 110 with the first location 1, a user 2a or 2b may see how a portion of the building in progress, such as window 61 matches up with the original three-dimensional specification of the building within the BIM. Adjustments may then be made to the building in progress if the building 50 is not being constructed according to the specification. The BIM may comprise multiple layers that show different parts of a building, such as services (electricity, gas, and/or communications conduits), interior constructed portions, and/or interior fittings. Further information on BIM components is set out later with reference to FIGS. 15A and 15B.

### Example Hard Hat With Integrated Electronic Subsystem

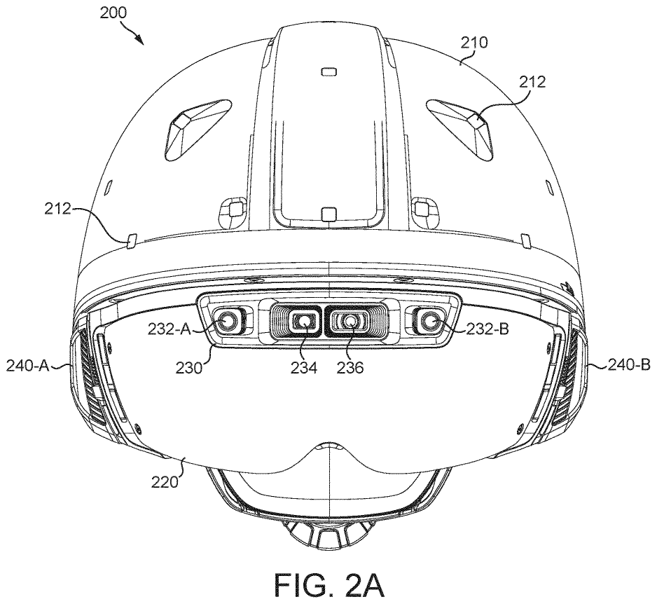

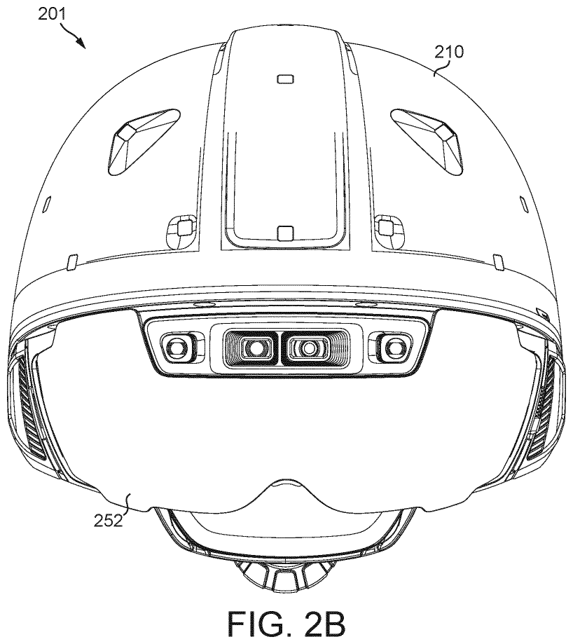

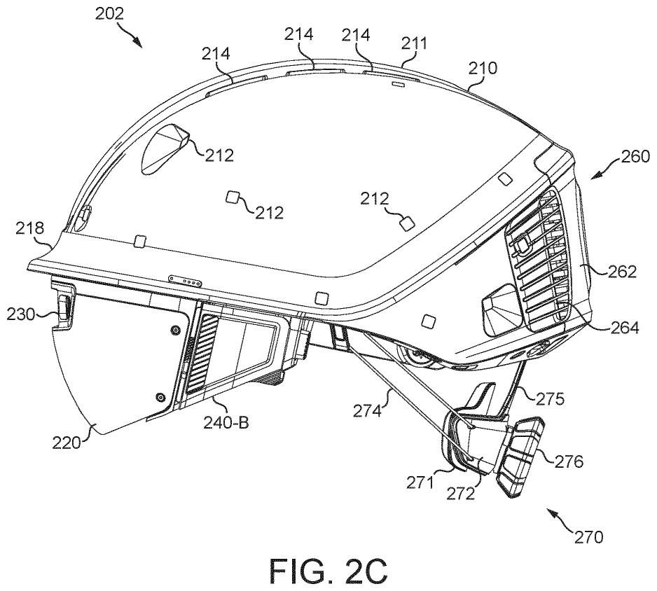

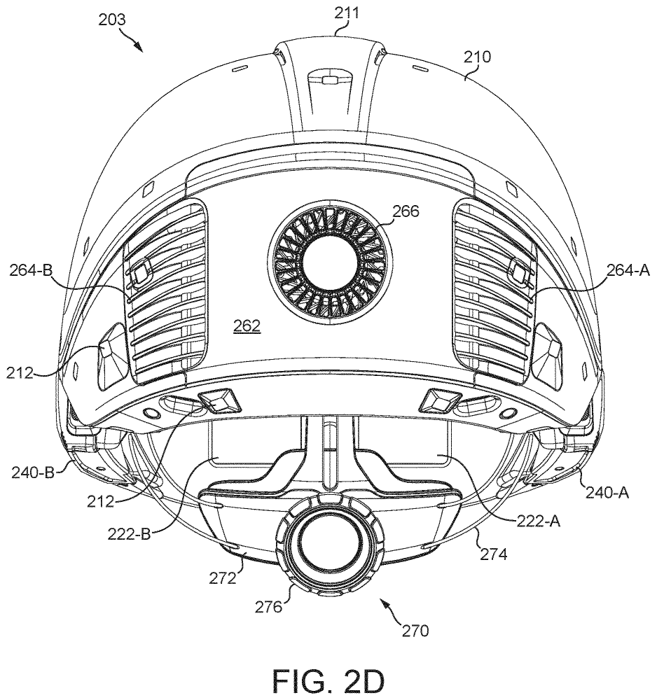

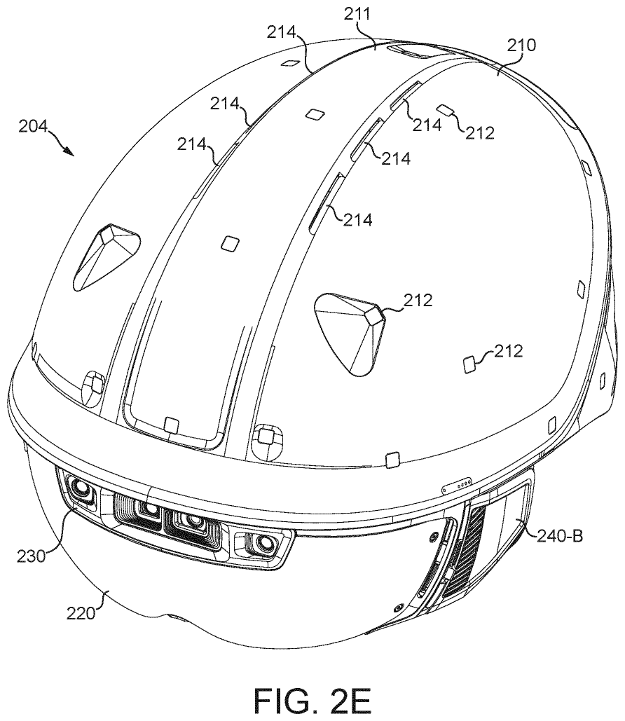

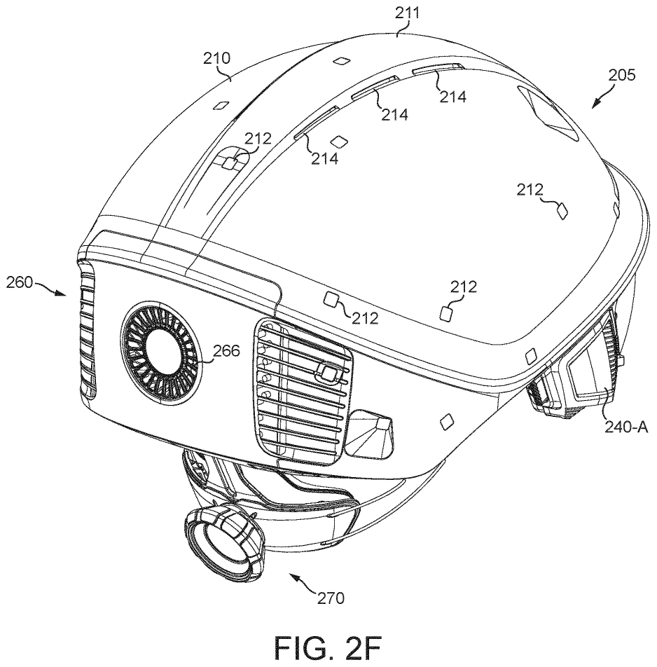

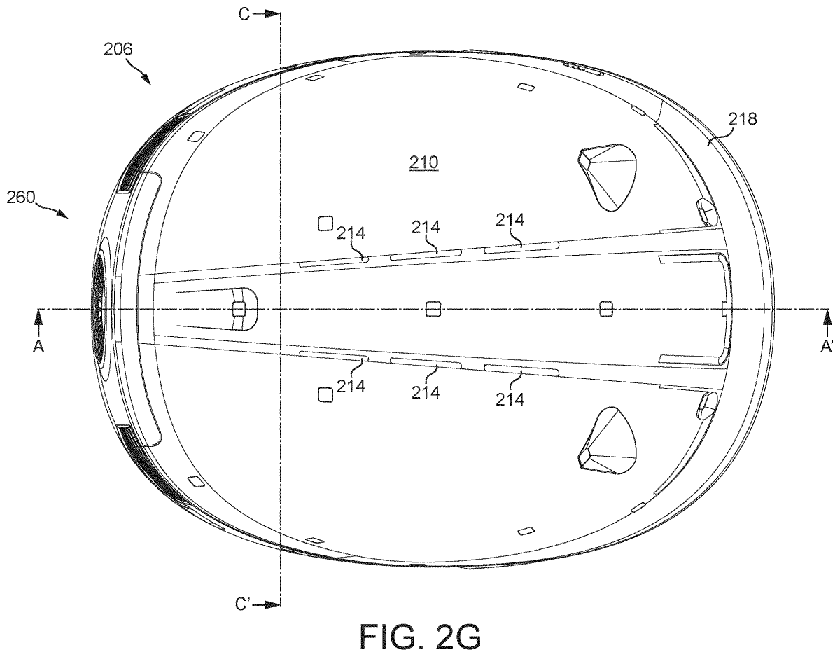

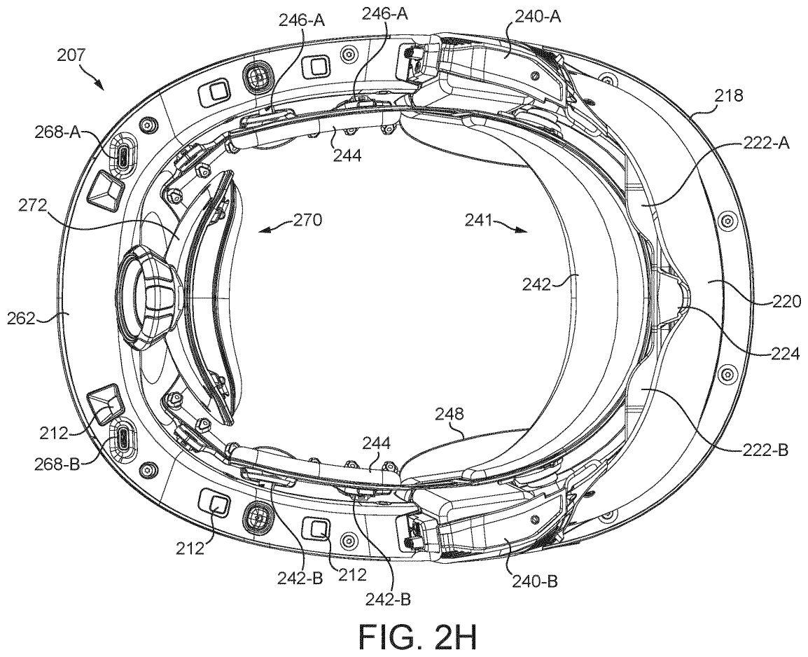

FIGS. 2A to 2H show different views and configurations of an example hard hat with an integrated electronic subsystem. In the present examples, the integrated electronic subsystem is an augmented reality system that comprises electronics to render an augmented reality image within a set of augmented reality glasses. The integrated electronic subsystem may comprise a processor and memory, i.e. a computing architecture, but may exclude the set of augmented reality glasses and display circuitry (such as a display driver) for said glasses.

FIG. 2A shows a front view 200 of the hard hat 210 in a configuration without a removable light shade. FIG. 2B shows a front view 201 of the hard hat 210 with a removable light shade 252. Starting with FIG. 2A, the hard hat 210 comprises a set of integrated safety goggles 220, a camera assembly 230, and left- and right-wing portions 240 that form part of respective detachable battery casings. Although the term “safety goggles” is used here, it should be noted that “safety glasses” or “safety visor” are comparable synonyms. The integrated safety goggles 220 may be formed from a protective polymer designed to withstand impact and built according to defined optical-wear safety standards. The surface of the hard hat 210 comprises a plurality of photo sensors 212 (ten are present in the view but only two are labelled for clarity). These photo sensors 212 may comprise photodiodes, such as silicon photodiodes, for detecting an electro-magnetic signal emitted from the tracking beacons 102 shown in FIGS. 1A and 1B. In one case, the photo sensors 212 may comprise part of an optical positional tracking system as described in WO2019/048866 A1 or WO 2016/077401 A1, the latter being also incorporated herein by reference. The optical positioning system may be inside-out (i.e., using sensors on devices that sense outwardly) or outside-in (i.e., locating objects within a tracked volume at least in part generated by external devices such as tracking beacons 102). In a preferred example, the photo sensors 212 are mounted behind apertures in the surface of the hard hat 210. The photo sensors 212 may be sealed (e.g., with silicone sealant or the like) to prevent water ingress. In certain cases, the photo sensors 212 may be moulded as part of an outer shell material to create a fully-sealed outer shell. In other examples, the photo sensors 212 may be attached to the surface of the hard hat 210.

The safety goggles 220 form an outer protective boundary for the eyes. Behind the safety goggles 220 is an augmented reality display (see, e.g., FIG. 2D). The augmented reality display, in the present example, comprises a transparent display where images may be viewed as a user observes the outside world. Hence, as a user wears the hard hat, and looks out through the augmented reality display and the safety goggles, they are able to view a virtual image that may overlayed on a view of the outside world. In other examples, the safety goggles 220 may be replaced by a closed VR or MR headset where a virtual reality view is displayed layered upon a view of the outside world as captured by the camera assembly 230 and displayed upon a non-transparent screen, such as a Liquid Crystal Display (LCD) or Light Emitting Diode (LED) display (including Organic LED—OLED—displays). Display screen technologies may additionally or alternatively include, amongst others, Liquid Crystal On Silicon (LCOS) displays (including transparent LCOS displays), Digital Light Processing (DLP) displays, and micro LED displays. Display technologies mentioned herein may be applied in both opaque and transparent forms (e.g., for VR or AR).

The camera assembly 230 comprises one or more cameras that may be used to enhance the display of augmented reality information. In the present example, four cameras are provided. These are, from the wearer's perspective: a right grayscale wide-angle camera 232-A (e.g., with a field of view greater than 90 degrees, and including fish-eye cameras with up to 180-degree field of view); a colour camera 234, such as an Red-Green-Blue (RGB) camera; a range imaging camera 236, such as time-of-flight camera and/or an Infra-Red (IR) camera for determining distance measurements based on a time of a light pulse (such as a laser or infra-red pulse) to travel to, and reflect from, a target; and a left grayscale wide-angle camera 232-B. The cameras supplied as part of the camera assembly 230 may be used for SLAM localisation and tracking as described above and/or for tracking objects in a field of view. In a preferred case, the cameras supply data that is used in combination with the positional tracking system implemented by the tracking beacons 102 and the photo sensors 212. The cameras may also be used for capturing images and/or videos of parts of the construction site for reporting and work inspections, in certain cases with virtual objects (e.g., 3D holograms) overlayed in the image or video field of view. In certain other examples, the camera assembly 230 may also contain an inertial measurement unit (IMU); in a preferred example, multiple IMUs are provided in the hard hat but are not provided in the camera assembly 230. The camera assembly 230 may be coupled to one or more of the integrated electronic subsystem and intermediate circuitry.

FIG. 2B shows how the removable light shade 252 may be clipped into place in front of the safety goggles 220. The removable light shade 252 may comprise a polarising filter that improves the visibility of virtual images in the augmented reality display in bright light conditions (such as outside on a sunny day). The removable light shade 252 may comprise a “push-to-fit” design that may be removed by unclipping the shade from the safety goggles 220 and surrounding frame portions. The removable light shade 252 may be omitted for certain provisions of the hard hat 210.

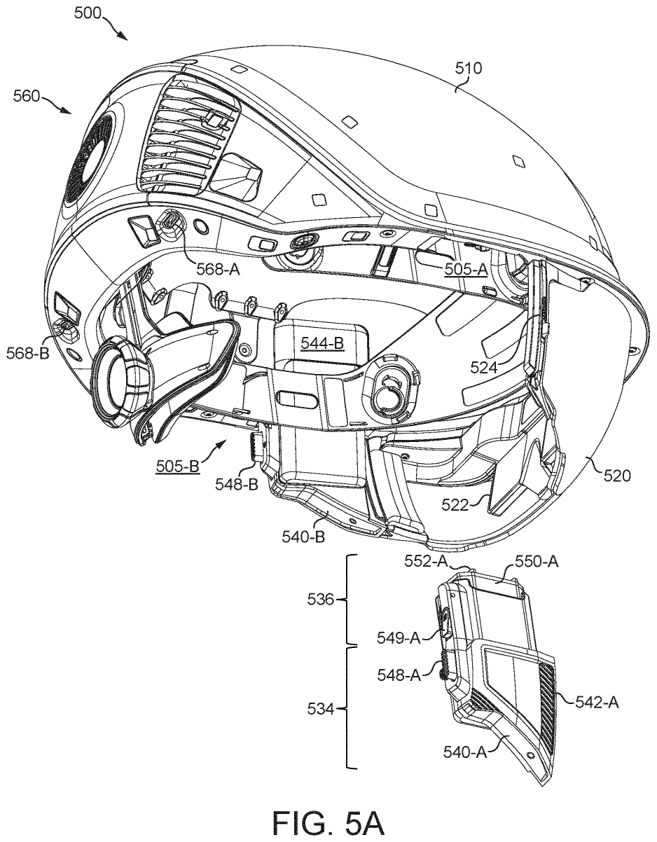

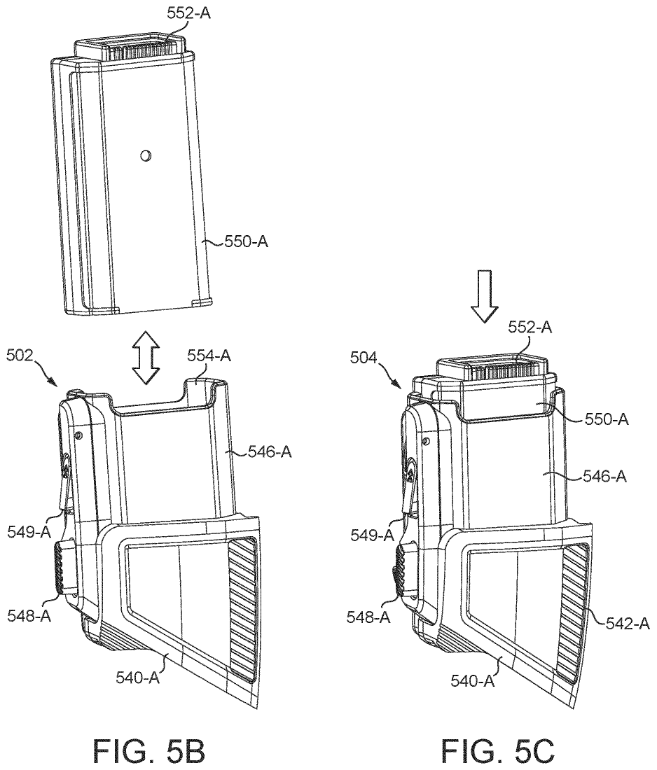

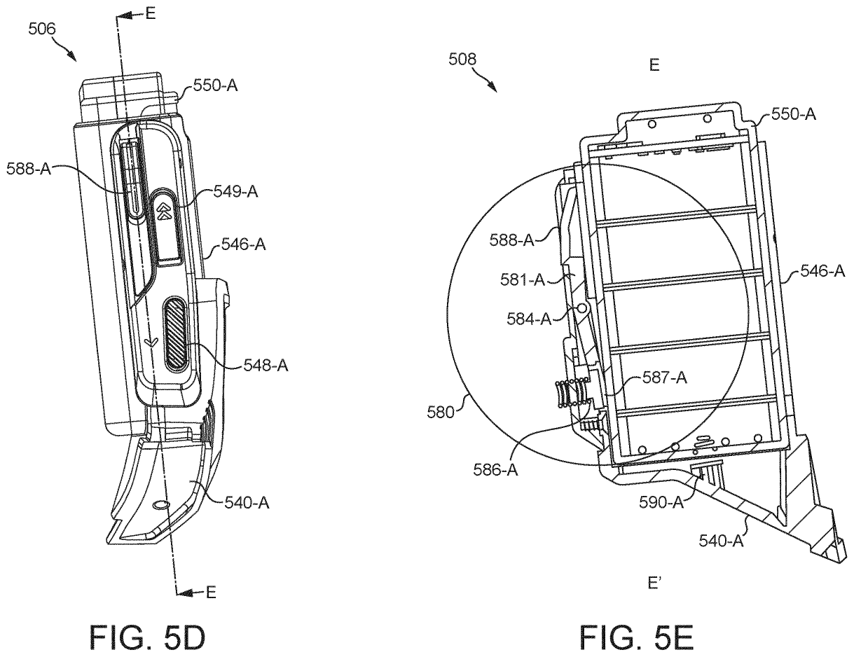

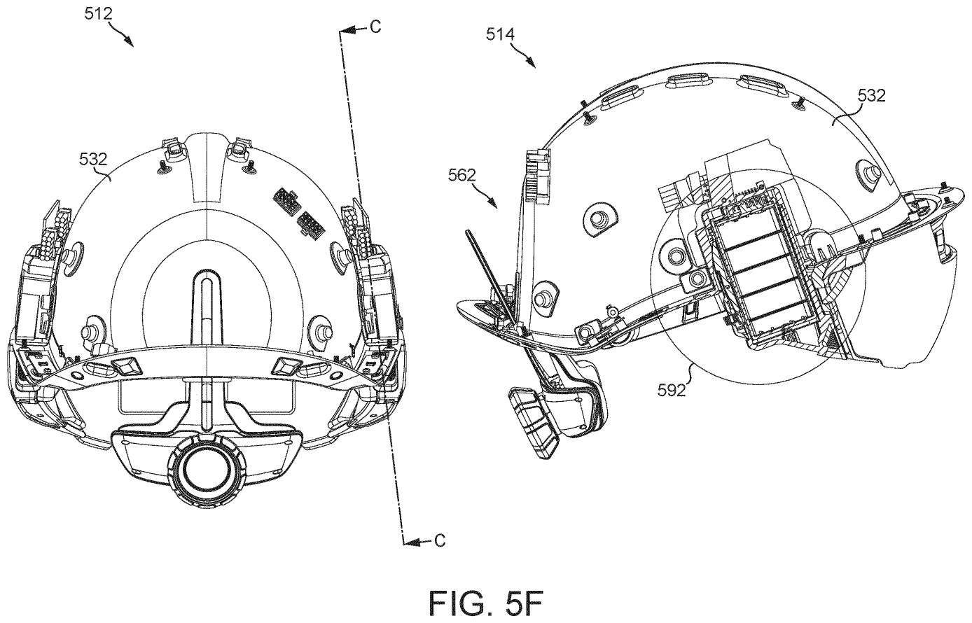

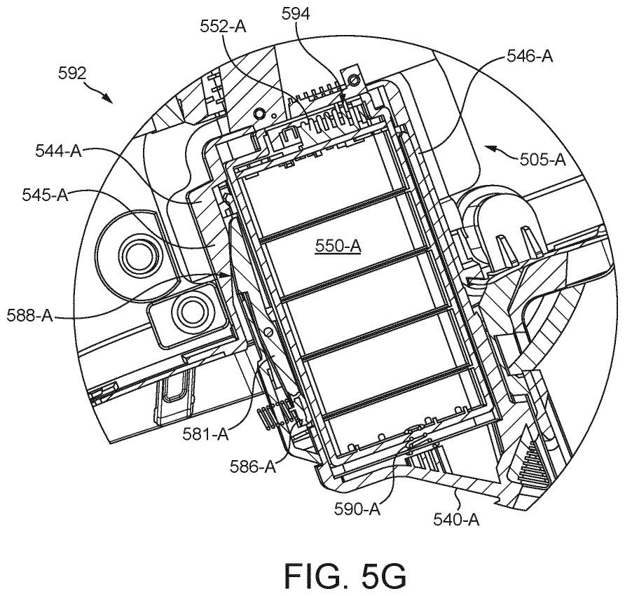

FIG. 2C shows a side view 202 of the hard hat 210 without the removable light shade 252. The side view is of a right side of the hard hat 210 as viewed from the front, which equates to a left-hand side of the hard hat 210 from the perspective of a user wearing the hard hat 210. In this description, elements of the hard hat will be referred to taking a view from the perspective of the wearer of the hard hat, as such a view is consistent despite different perspectives in the Figures. In FIG. 2C, it may be seen how a peak 218 of the hard hat 210 extends around above the camera assembly 230, the safety goggles 220, and the left-wing portions 240-B, before extending upwards at an angle towards the upper rear of the hard hat 210. At the rear of the hard hat 210 is mounted the integrated electronic subsystem 260. In the present example, the integrated electronic subsystem 260 is mounted behind a rear casing 262 that comprises ventilation gratings 264 to allow an air-flow over the subsystem for cooling. The integrated electronic subsystem 260 in the present example comprises an embedded computer, i.e. comprising at least one processor and memory (e.g., one or more of volatile and non-volatile memory). The rear casing 262 further comprises additional photo sensors 212. It may be seen how the lower edge of the safety goggles 220 and the wing portion 240-B form a continuous upward sloping line towards the back of the hard hat 210. The wing portion 240-B provides structural rigidity to the front of the hard hat 210 where the safety glasses 220 and augmented reality display (shown later) are integrated. The wing portion 240-B may also be provided in a removable form that forms a battery casing (as described later with reference to FIGS. 5A to 5G). Although only one side view is shown, it will be apparent from the other provided views that the design is symmetrical and that the right-hand side of the hard hat 210 will have similar corresponding features.

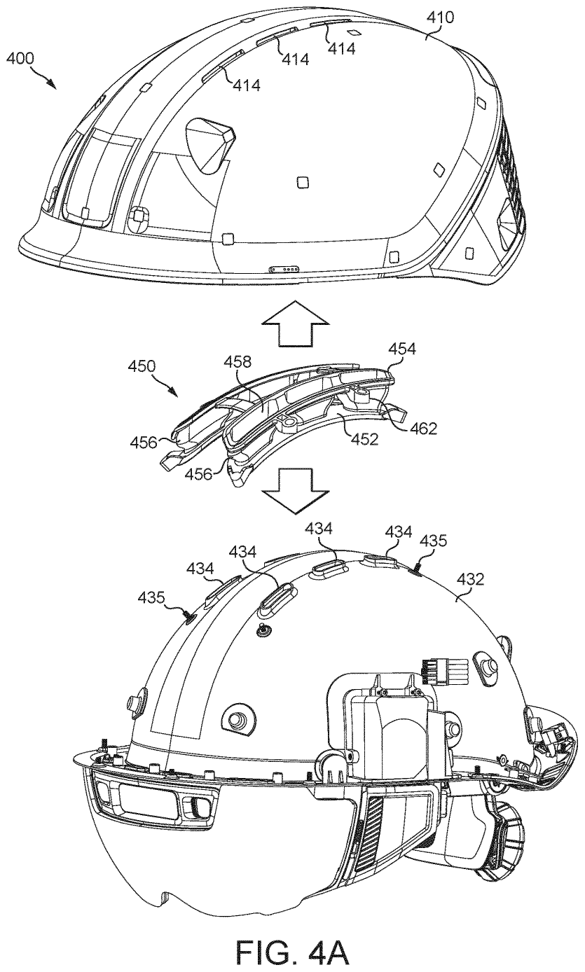

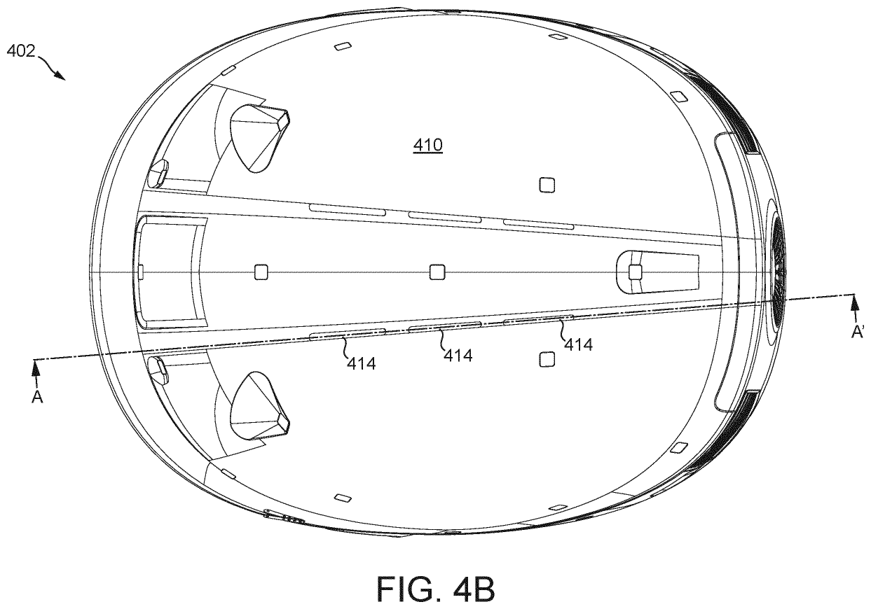

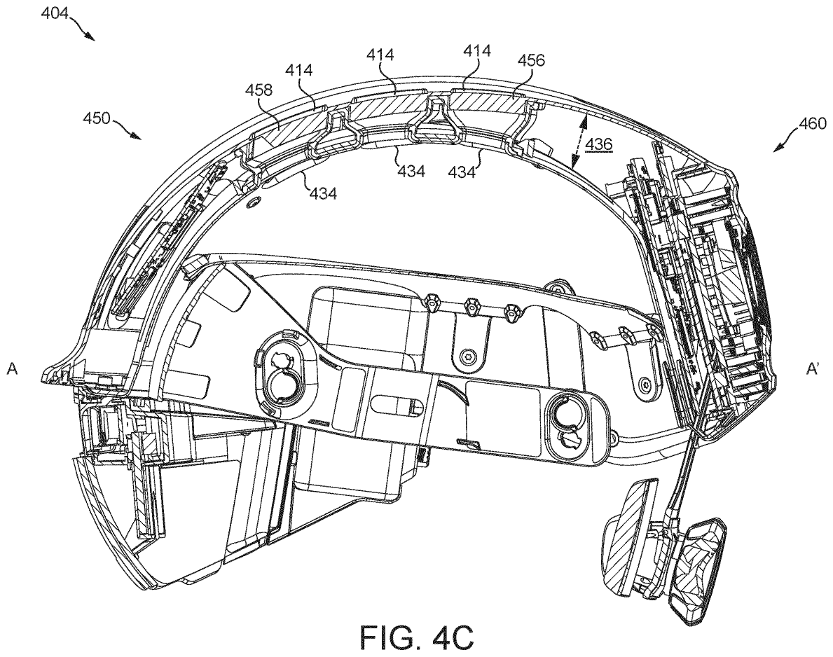

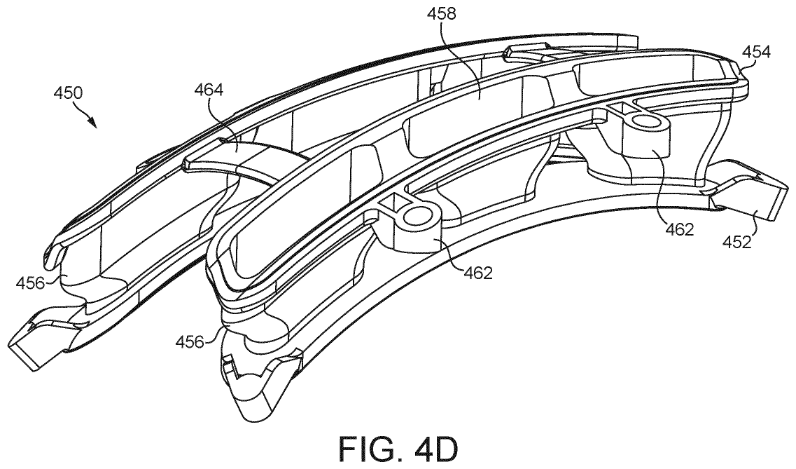

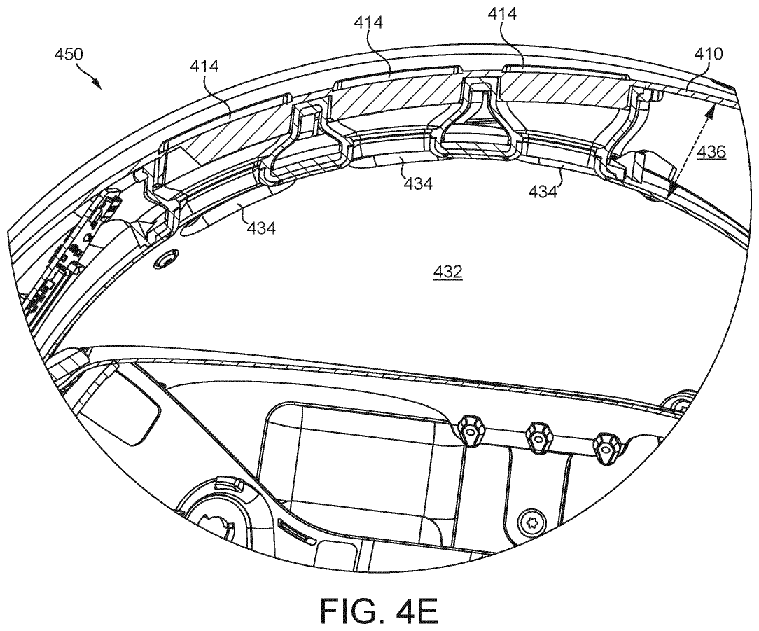

In FIG. 2C, a plurality of ventilation apertures 214 in the top of the hard hat 210 are visible. In the present example, there are three ventilation apertures 214 on each side of a central ridge 211 at the top of the hard hat 210 that runs from the front to the back of the hard hat 210. These allow an airflow with the interior of the hard hat 210 to provide a cooling effect to a user's head. The coupling of the ventilation apertures 214 with a deformable ventilation coupling is described with reference to later examples and FIGS. 4A to 4E.

At the lower rear of the hard hat 210 is an adjustable nape support 270. The adjustable nape support 270 is configured to rest against the nape of a user's neck (e.g., at the base of the head above the neck) to help with distributing the weight of the hard hat 210 with the integrated electronic subsystem 260. The adjustable nape support 270 may comprise an inner nape rest 271 and an outer rear cradle portion 272. The outer rear cradle portion 272 is coupled to an interior of the hard hat 210 via tension members 274 and rear coupling 275. Tension members 274 may comprise polymer or fabric members that are arranged to absorb a tensive force (e.g., as the adjustable nape support 270 remains static and the hard hat 210 moves forward upon the head). The rear coupling 275 may comprise polymer members that align the outer rear cradle portion 272 centrally on the nape of the user's neck.

FIG. 2D shows a rear view 203 of the hard hat 210. More of the rear casing 262 is visible in this view, as well as two ventilation gratings 264-A, B which are laterally spaced at the rear. At the centre of the rear casing 262 is a fan mounting 266, within which a fan is used to drive an airflow over cooling plates of the integrated electronic subsystem 260. In use, the fan may be used to create an air pressure difference leading to air ingress through the fan mounting 266 and an air flow over the cooling plates, then out via the ventilation gratings 264-A, B. In alternative examples, the air flow direction may be reversed to provide a similar cooling effect. The fan arrangement keeps the integrated electronic subsystem 260 suitably cool and prevents the electronics from heating and causing discomfort to the user. This is especially important as the generation of augmented reality views is a resource-intensive computation that can cause high heating in un-cooled systems.

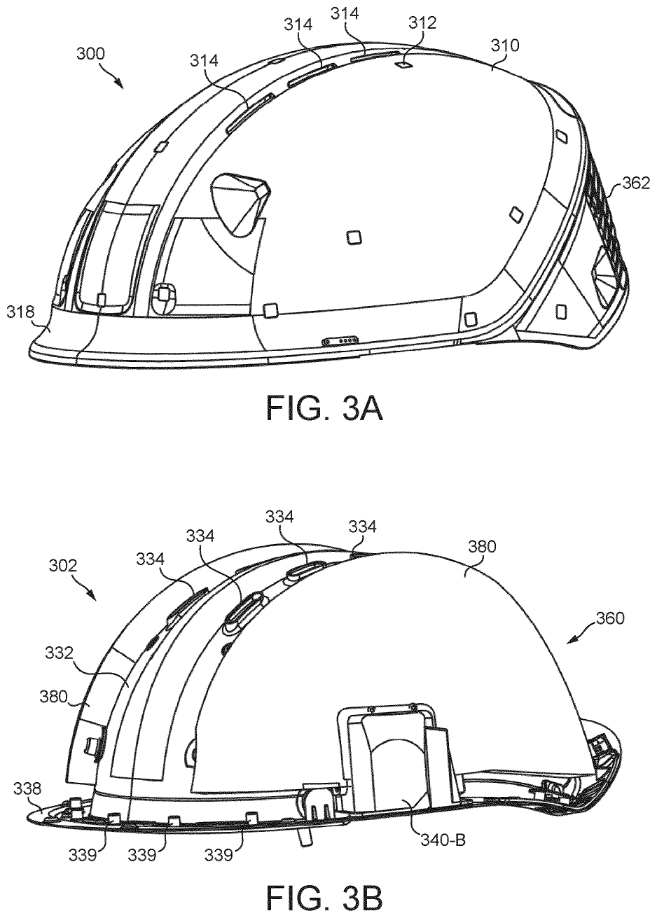

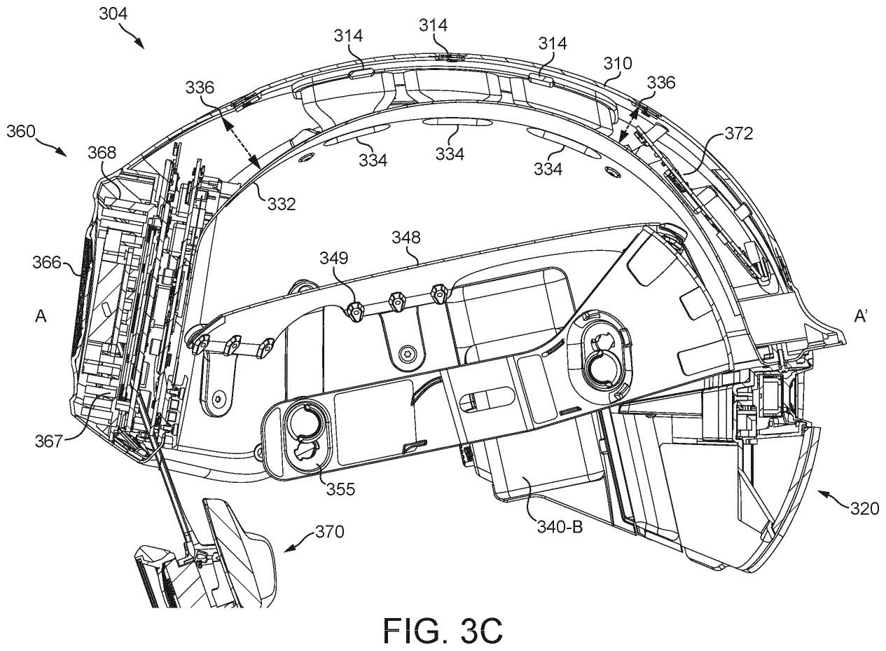

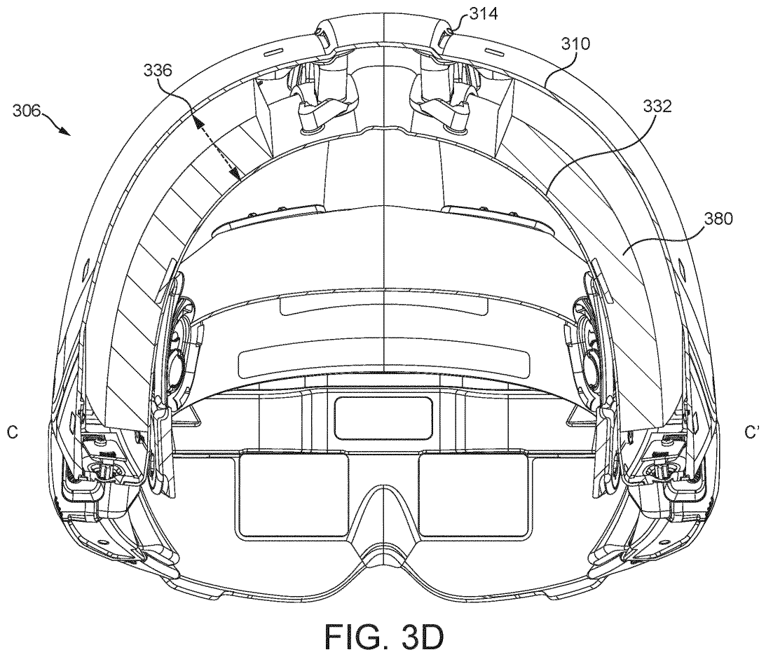

FIG. 2D also shows two panels 222 of the augmented reality display: a left-panel 222-B for a left eye and a right-panel 222-A for a right eye. The bottom of the left-wing portion 240-B and the right-wing portion 240-A are also visible. The panels 222 may be electronically coupled to driving circuitry mounted within the front of the hard hat 210 (shown in later Figures). Each display panel 222-A, B may comprise a wave guide for displaying images or frames of video as projected by a coupled mini projector. The wave guide may comprise a 40° diagonal top-injected two-plate wave guide. The set of two wave guides and corresponding projectors may be referred to as an optical module or optical engine. The optical module may be driven in a similar manner to a conventional display (e.g., via a known or custom display coupling and driven by a graphics unit for a compute module). A portion of driving electronics, e.g. forming part of an embedded graphics processing unit, may be separate from the integrated electronic control subsystem 260 (e.g., may be provided as part of front circuitry 372 as shown in FIG. 3C). FIG. 2E is a perspective view 204 of the front of the hard hat as observed from above. The central ridge 211 and the two sets of three ventilation apertures 214 are visible. FIG. 2F is another perspective view 205, but this time from of the rear of the hard hat 210. FIG. 2G is a view 206 of the top of the hard hat 210. The view 206 indicates two cross-sections A-A′ and C-C′ that are shown in later Figures.

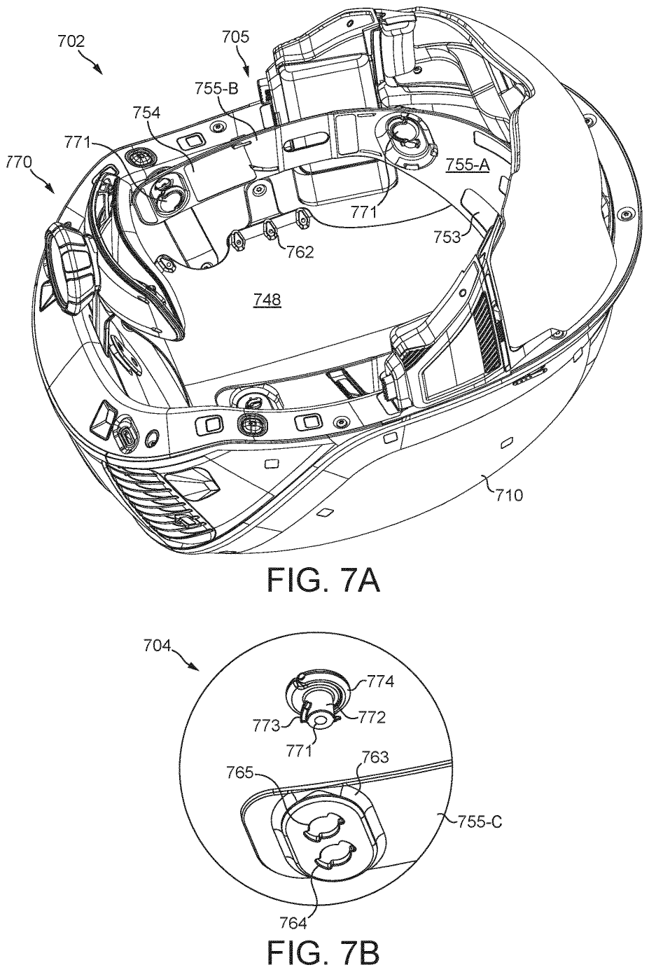

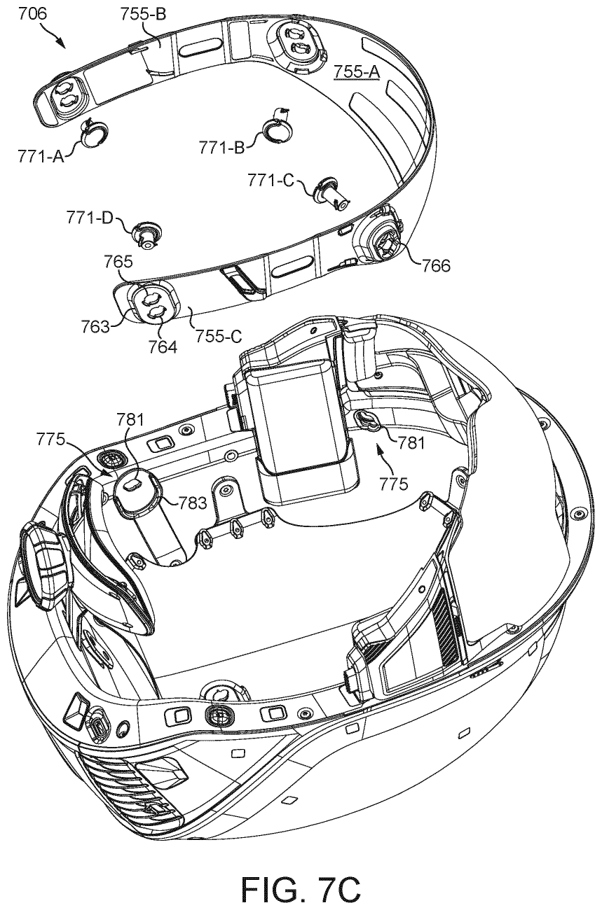

FIG. 2H is a view 207 of the underside or bottom of the hard hat 210. Certain features of the interior of the hard hat 210 are visible in this view. The safety goggles 220 are visible below the peak 218 of the hard hat 210. Portions of the right-and left-panels 222-A, B for the augmented reality display are also visible. The safety goggles 220 comprise a nose bridge 224 that helps support the goggles upon a user's nose and thus correctly locate the panels with relation to the user's eyes. In alternative examples, the nose bridge 224 may be provided between the panels themselves. The underside of the rear casing 262 (e.g., an inner shell rim) has a number (six in the Figure) of photo sensors 212 and the underside of the right-and left-wing portions 240 A, B are also visible. To complement the adjustable nape support 270, a cradle 241 for positioning the hard hat on the head of a user is provided. The cradle 241 rests on the front and sides of a user's head and comprises front support portion 242 and side support portions 244. The front support portion 242 and side support portions 244 may comprise pads that are coupled to a polymer cradle frame via hook-and-loop fasteners. The cradle frame may be adjustable. For example, the cradle frame may allow for vertical height adjustment of at least 10 mm and so allow different positioning of the hard hat 210 on a user's head. In total, the user's head may be supported by front support portion 242, side support portions 244, and rear support portion 272, where the rear support portion 272 may be adjustable independently of the front support portion 242. More details of the cradle and its adjustment are described with reference to FIGS. 7A to 7C.

FIG. 2H also shows two electrical ports 268-A and B at the rear of the hard hat 210. In the present example, these electrical ports comprise USB-C ports but may be any known electrical ports. The two electrical ports 268 may be used for one or more of powering the integrated electronic subsystem 260 and data transfer to and/or from the integrated electronic subsystem 260 (e.g., for firmware or other operating software updates, for uploading BIM data, for configuration, and/or for downloading mapping data). Either or both of the electrical ports 268 may also comprise display ports, e.g. may comprise USB-C DisplayPorts (DP) or ports for DP Alt Mode. Ports 268 may thus allow virtual overlays in images or videos that are captured during a site inspection to be viewed externally (e.g., in an on- or off-site location with an external display such as a television screen or monitor). Display output that is provided by one or more of the ports 268 may utilise graphics acceleration and/or augmented reality functions that are used to display virtual images on the built-in display panels 222, i.e. functionality of the integrated electronic subsystem 260. In one case, the electrical ports 268 may also charge removeable rechargeable batteries that are currently installed within the wing portions 240 (but this may not be provided in all implementations).

When wearing the hard hat 210, a user's head may be supported by an inner woven mesh 248 (seen in FIG. 2H and also shown in later Figures). This woven mesh 248 may comprise a fabric mesh that clips onto the side of an inside of the hard hat. The woven mesh 248 may be fire resistant and/or impact resistant. In a preferred case, the woven mesh 248 comprises an impact-resistant digital knitted weave comfort harness that is fastened with prongs to the inside of the hard hat 210.

### Example of Two Layer Hard Hat

FIGS. 3A to 3D show one example of constructing a hard hat such as the hard hat 210 of FIGS. 2A to 2H. In this example, a hard hat with an integrated electronic subsystem comprises outer and inner portions. FIG. 3A is a perspective side view 300 of an example outer portion 310 of the hard hat. FIG. 3B is then a perspective side view 302 of an example inner portion 332 of the hard hat. The outer and inner portions 310, 332 are spaced apart within the hard hat, e.g. the hard hat is constructed such that there is a spacing between the outer and inner portions 310, 332. This spacing may be approximately 20 mm. In this example, the integrated electronic subsystem is mounted between the outer and inner portions. For example, the integrated electronic subsystem may be mounted at location 360 in FIG. 3B. In certain cases, an impact foam 380 may be included to increase the protection; however, in other cases, the impact foam 380 may be omitted. The integrated electronic subsystem may be mounted upon one or more of the outer and inner portions (e.g., screw bosses may be provided on one or more of the portions to allow one or more printed circuit boards and/or compute packages to be attached with screws).

In preferred examples, both outer and inner portions are rigid, e.g. comprise “shells” that protect the head of a user. A two-layer system with these portions is able to provide safety protection for a user's head while reducing a weight on a user's head and providing a configuration that can safely house the integrated electronic subsystem. Keeping the weight low is especially important as the integrated electronic subsystem and other electronic components add to the weight of a conventional protective hard hat.

Turning to FIG. 3A, the outer portion 310 shown here may provide the outer part of the hard hat 210 that is shown in FIGS. 2A to 2H. As described with reference to those Figures, the outer portion 310 has apertures 312 for the mounting of photo sensors (e.g., 212) and ventilation apertures 314 (e.g., as shown as 214 in FIG. 2E). The outer portion 310 may comprise a polymer shell. For example, the outer portion 310 may comprise a thin 1.5 mm protective polymer shell, similar to the polymer shell of a hard hat without an integrated electronic subsystem. In certain cases, the outer portion 310 may be thinner than comparative hard hats as impact protection is distributed across both shells. The polymer shell may be moulded with apertures 312 and 314, and with peak 318. The rear portion 362 shown in FIG. 3A may be provided as a separate portion of polymer moulded casing (e.g., as explained with reference to the rear casing 262 above) or as an integrated portion. In certain cases, the main outer portion 310 and the rear portion 362 are moulded separately then joined during manufacture.

Turning to FIG. 3B, the inner portion 332 in this example comprises a rigid inner portion that provides protection for a user's head. During construction the integrated electronic subsystem is mounted at location 360 at the rear of the hard hat and the inner portion 332 and the outer portion 310 are then joined and fastened together for use. In the example shown, the outer portion 310 comprises screw bosses that align with complementary screw apertures (e.g., through holes) on the inner portion such that the inner portion 332 is screwed to the outer portion 310 to join them together. FIG. 3B also shows a set of mounting screw bosses for the front visor portion (i.e., comprising safety goggles 220). In the present example, the two portions may be separated for repair and maintenance, e.g. to access the integrated electronic subsystem. In certain cases, a seal may be created between the outer and inner portions, e.g. via silicone sealant and/or rubber O-rings or other sealing portions, to prevent water ingress into the spacing between portions. Although screws are shown here, other fastening and/or joining approaches may be used in other examples.

In a preferred case, the inner portion 332 comprises a carbon fibre inner shell. In general, the outer portion may comprise a polymer outer shell having a first thickness and the inner portion may comprise a carbon fibre inner shell having a second thickness. In a preferred case, the second thickness being less than the first thickness. The first thickness may be 1.5 mm and the second thickness may be 0.8 mm. The inner portion may be formed by hot press forming from carbon fibre sheet. Having a carbon fibre inner shell helps reduce the weight of the hard hat while maintaining impact protection. For example, a carbon fibre inner shell may provide the majority of the impact and penetration protection whereas an outer polymer shell may be used as a cosmetic outer shell and deflect an initial portion of the energy of an impact (e.g., provide remaining impact absorption).

As shown in FIG. 3B, a set of ventilation apertures 334 may be provided in the inner portion 332. These inner ventilation apertures 334 align with the outer ventilation apertures 314. These may be coupled directly (e.g., simply by alignment of the apertures on both portions), via a rubber seal, or preferably via a deformable ventilation coupling as shown and described in more detail with reference to FIGS. 4A to 4E. Apertures for ventilation and/or fastening screws may be cut within the inner portion 332 using a Computer Numerical Control (CNC) laser cutter. A CNC cutter may also be used to trim features such as the inner peak 338. In FIG. 3B, a left battery mounting unit 340-B is shown that receives a removable battery as enclosed within a detachable battery casing (e.g., corresponding to wing portion 240-B in FIG. 2C).

FIG. 3C shows a first cross-section view 304 along the cross-section line A-A′ as shown in FIG. 2G. Safety glasses (e.g., 220), augmented reality display panels (e.g., 222), and portions of a camera assembly (e.g., 230) may be seen at the front 320 of the hard hat. A removable battery may be seen as mounted using a wing portion 340-B and a portion of a cradle 355 for adjusting a vertical height of the hard hat. An adjustable nape support 370 (e.g., corresponding to 270 above) is also shown.

In FIG. 3C, the outer portion 310 and the inner portion 332 are visible. Also, a coupling between the outer ventilation apertures 314 and the inner ventilation apertures 334 is shown. In this view the integrated electronic subsystem 360 is visible at the rear of the hard hat, as mounted in a spacing 336 between the outer portion 310 and the inner portion 332. FIG. 3C shows that the integrated electronic subsystem 360 comprises at least one circuit board 367 with mounted processing electronics and a heat sink 368 with cooling fins. In use, a fan 366 drives air over the heat sink 368 to cool the electronics (e.g., as described with reference to 264 and 266 in FIG. 2D). The integrated electronic subsystem 360 may be sealed off from the internal spacing 336, e.g. may be mounted as part of a sealed moulded package to the rear of the hard hat. FIG. 3C also shows how a woven support mesh 348 (e.g., equivalent to 248 in FIG. 2H) may be fastened to multiple sets of prongs 349. There may be at least four sets of prongs 349, where each set may comprise a plurality (e.g., 3) individual prongs that hold corresponding loops and/or gaps in the weave for the woven support mesh 348. Each set of prongs may be fastened to the inner portion 332 via apertures cut or drilled in the inner portion. The woven support mesh 348 may thus be removed for regular washing and cleaning (e.g., in a washing machine or water with washing detergent).

FIG. 3C also shows front circuitry 372 that is also mounted between the outer and inner portions 310, 332. The front circuitry 372 may comprise electronics for driving the augmented reality panels (such as 222) and/or for receiving data from a front camera assembly (such as 230). In one case, the front circuitry 372 may comprise driving boards for portions of the optical assembly that renders an augmented reality image (e.g. on display panels 222). In certain cases, a front camera assembly (such as 230) may be communicably coupled (e.g., via flexi-cables) to printed circuit boards forming part of the integrated electronic subsystem 360, e.g. rather than communicably coupled to the front circuitry 372. In certain cases, the front circuitry 372 may comprise printed circuit boards (PCBs) or chipsets to provide particular functions in addition to the integrated electronic subsystem. For example, the front circuitry 372 may comprise a wireless communication module for communication with peripherals and/or other devices (e.g., such as a 2.4 GHz or 5 GHz wireless communication module). The wireless communication module may be used for data communication with the handheld controller. The front circuitry 372 may comprise one or more Application-Specific Integrated Circuits (ASICs) and/or Field-Programmable Gate Arrays (FPGAs). In the present example, the front circuitry 372 is mounted onto screw bosses provided in the outer portion 310. The spacing 336 between inner and outer portions may be approximately 20 mm but may vary across the hard hat, e.g. may increase from around 20 mm at the front to around 25 mm at the rear. In general, the outer and inner portions may be spaced by approximately 20 mm for at least half of the circumference of the hard hat.

In general, the outer and inner portions may provide a protective, waterproof, sealed chamber to house a set of complex electronics, while keeping the weight low for a head-worn product. The two-layer design may provide protection for construction safety standards (e.g., amongst others, American standards set by ANSI—American National Standards Institute—including Type I protection—ANSI Z89.1, British Standards—BS—set by the British Standards Institution—BSI, European Standards—EN, e.g. BS EN 397, and/or International Standards from the International Organization for Standardization—ISO). A carbon fibre inner portion provides a lightweight primary protective shell for one or more of impact protection and penetration protection that allows for mounting of electronics and is then complemented by an upper or outer polymer protective shell that determines the cosmetic appearance and provides outer sealing and a portion of impact protection. The outer polymer protective shell may provide protective impact absorption.

FIG. 3D shows a second cross-section view 306 along the cross-section line C-C′ as shown in FIG. 2G. In this view, the outer portion 310 and the inner portion 332 are visible, and they are separated by a spacing 336. In certain configurations, the spacing 336 may be filled, at least in part, by an impact foam 380. The impact foam may comprise, amongst others, a closed cell foam, expanded polystyrene (EPS), and non-Newtonian polymers (including so-called “smart” foams engineered to provide specific impact absorbing properties such as those provided by Design Blue Limited under the trade name “D3O”®). As such, in certain configurations a hard hat is provided with outer and inner (rigid) portions that are separated with a spacing and where an impact foam is arranged in the spacing between the outer and inner portions. The impact foam 380 may improve absorption of energy from one or more of vertical and lateral impacts. The impact foam 380 may be particularly beneficial for lateral impacts (i.e., from the side of the hard hat or at an angle to the hard hat, including from the front, rear and lateral sides). With the two-layer design, an impact foam 380 can be easily installed between the inner and outer portions 310, 332 while hiding the impact foam from view and/or damage during use. This maintains the compact profile of the hard hat. Use of impact foam as shown can allow the hard hat to meet ANSI Type II standards that require side impact absorption. The impact foam further does not affect the comfort of the user wearing the hard hat or compromise the architecture of the hard hat. Having an impact resistance foam sandwiched between a multi-layer shell provides for a side-impact certified AR construction hard hat (where “side-impact” includes impacts from approximately horizontal forces to one or more of the front, back, and sides of the hard hat, e.g. as opposed to impacts from above).

### Example of Ventilation Coupling

FIGS. 4A to 4E provide an example of a ventilation coupling that may be used with the two-layer dual-shell design described with reference to FIGS. 3A to 3D above. The ventilation coupling comprises a coupling between inner and outer portions of a hard hat (e.g., as described above), where the inner portion may comprise a carbon fibre shell and the outer portion may comprise a polymer shell. In preferred examples, the ventilation coupling comprises a deformable ventilation coupling for coupling the outer portion and the inner portion, where the deformable ventilation coupling allows for an air flow from ventilation apertures in the inner portion to an exterior of the outer portion (and/or vice versa). In certain examples, the deformable ventilation coupling provides a measure of impact absorption and reduces an energy transfer from impacts to the inner portion and then the head of a user. The deformable ventilation coupling may be provided as a replaceable component, e.g. that may be replaced as part of repair and maintenance of the hard hat. In most cases, the replaceable component is replaced by a manufacturer or certified reseller that can ensure safe operation of the hard hat (e.g., rather than a user, as this may be unsafe). If a hard hat is subject to an impact, it is recommended to be returned and not to be used again. In one case, the deformable ventilation coupling comprises a first rigid frame for coupling to an inner portion of the hard hat, a second rigid frame for coupling to an outer portion of the hard hat, and a deformable suspension system arranged between the first and second rigid frames, the deformable suspension system comprising apertures to allow air flow from ventilation apertures of the inner portion to an exterior of the outer protective portion, the apertures comprising a waterproof seal. The deformable ventilation coupling improves impact absorption while also improving cooling and comfort for a user.

FIG. 4A shows an exploded view 400 of an outer portion 410 of a hard hat and an inner portion 432 of the hard hat. The outer and inner portions 410, 432 may comprise the outer and inner portions 310, 332 as described above with reference to FIGS. 3A to 3D. In FIG. 4A, the outer portion 410, which may comprise a polymer shell, has a series of outer ventilation apertures 414 for allowing an airflow from an inside of the outer portion to an outside of the outer portion. In the present example, the apertures are arranged laterally on a central ridge of the hard hat, with a series of three elongate apertures running front to back along each side of the central ridge. The inner portion 432 also comprises a corresponding set of inner ventilation apertures 434 that allow air flow from an underside of the inner portion 432 to an upper side of the inner portion 432. In the present example, the inner ventilation apertures 434 comprise two parallel rows of three elongate apertures that are aligned with the outer ventilation apertures 414. In one case, the inner ventilation apertures 434 may be CNC cut or drilled into a carbon fibre shell.

FIG. 4A further shows a deformable ventilation coupling 450 that is mounted between the inner and outer portions 432, 410. The deformable ventilation coupling 450 forms a seal between the inner ventilation apertures 434 and the outer ventilation apertures 414, whereby air is able to flow from the inside of the inner portion 432 out through to an exterior of the outer portion 410 (and vice versa). In FIG. 4A, the inner ventilation apertures 434 comprise rubber bushings to facilitate a seal and mating with the deformable ventilation coupling 450. In the example of FIG. 4A, the deformable ventilation coupling 450 comprises a first rigid frame 452 for coupling to the inner portion 432, a second rigid frame 454 for coupling to the outer portion 410 and a deformable suspension system 456 arranged between the first and second rigid frames 452, 454. The first rigid frame 452 may comprise a moulded polymer mounting with apertures or bosses to allow fastening to the inner portion 432, e.g. via screw holes 435 that project from the surface of the inner portion allowing the first rigid frame 452 to be screwed to the inner portion 432. In other cases, bosses or prongs may be provided that comprise inserts for small moulded (or pre-drilled) apertures in the inner portion 432. In FIG. 4A there are four screw holes 435 spaced at the four corners of an area that encloses the inner ventilation apertures 434. Similarly, second rigid frame 454 may also comprise a moulded polymer mounting with apertures to allow fastening to the outer portion 410. The outer portion 410 may comprise bosses that allow for the second rigid frame 454 to be screwed to the outer portion 410. For example, screws may fasten the projecting apertures 462 to the inside of the outer portion 410 (i.e., the apertures 462 project from the second rigid frame 454 in this example). Although a removable mounting is preferred for repair and replacement (e.g., in factory conditions at the manufacturer), in alternate examples the deformable ventilation coupling 450 may be permanently fastened via welding, polymer over-moulding, or adhesive. During manufacture or repair, the deformable ventilation coupling 450 is attached to the inside of the outer portion 410 (as indicated by the upper arrow) and then the inner portion 432 is aligned such that screw holes 435 mate with an underside of the first rigid frame 452 prior to fastening the inner portion 432 to the outer portion 410 (e.g., via screws, through apertures in the inner portion and screw bosses in the outer portion as described with reference to FIG. 3B).

FIG. 4B shows an upper view 402 of the hard hat indicating a cross-section line A-A′ and the outer ventilation apertures 414 on the outer portion 410. FIG. 4C shows a cross sectional view 404 along the cross-section line A-A′. FIG. 4C shows the deformable ventilation coupling 450 as installed and may be considered complementary to FIG. 3C above. In FIG. 4C, it may be seen how the deformable suspension system 456 forms a series of channels 458 that connect the inner ventilation apertures 434 and the outer ventilation apertures 414. The series of channels 458 are formed within the spacing 436 between the outer and inner portions 410, 432, i.e. the same spacing that allows for the mounting of the integrated electronic subsystem 460. The channels 458 may be provided with a waterproof seal (e.g., at the bottom of the channel near to the inner ventilation apertures 434 or at the opening of the outer ventilation apertures 414) that prevents water ingress but allows for airflow (e.g., in the form of an air permeable but water impermeable membrane). The channels may wider towards the outer ventilation apertures 414 such that air hitting the side of the central ridge is channelled into the hard hat to cool and aerate a head of a user.

FIG. 4D shows the deformable ventilation coupling 450 as an independent component for a hard hat. For example, the deformable ventilation coupling 450 may be supplied as a spare part. FIG. 4D shows the first rigid frame 452 and the second rigid frame 454 that are coupled by a deformable suspension system 456. The deformable suspension system 456 may comprise a rubber member that absorbs energy from an impact and that reduces the amount of said energy that is transmitted to the inner portion 432. For example, in an impact, the deformable suspension system 456 may be compressed (i.e., deform) in a substantially vertical direction between the inner and outer portions 432, 410. The deformable suspension system 456 forms a series of channels 458 than provide an airflow between the outer ventilation apertures 414 of the outer portion 410 and the inner ventilation apertures 434 of the inner portion 432. This is shown in more detail in the cut-away view of FIG. 4E.
FIGS. 4A to 4E thus show a hard hat comprising an outer portion, an inner portion comprising ventilation apertures, and a deformable ventilation coupling for coupling the outer portion and the inner portion, the deformable ventilation coupling allowing air flow from the ventilation apertures to an exterior of the outer portion. The deformable ventilation coupling may be used with any multi-layer hard hat but is particularly useful for hard hats with an integrated electronic subsystem, where the integrated electronic subsystem is mounted between the inner and outer portions and the inner portion forms a base that is worn by a user, e.g. via padded supports and an inner woven mesh. A rubberised suspension system in a construction hard hart can provide utility as part of a ventilation, waterproofing, and impact absorbing system in a twin shell design. The twin shells enable lightweight and thin material walls and waterproofing of an inner spacing, while the deformable ventilation coupling provides energy absorption and a waterproofed air flow. The flexible deformable suspension system ensures that any impact is absorbed, contrary to a rigid sealing air vent system in which impact energy would transfer directly to the wearer's head. The system creates a series of sealed channels enabling through flow of air (i.e., the whole hat can breathe) without getting the user wet or allowing dust ingress. The deformable ventilation coupling provides a seal both vertically (e.g., via an air permeable waterproof member) within the hard hat and horizontally with respect to the spacing between layers.

### Example Battery Coupling Interface and Detachable Casing Portion

FIGS. 5A to 5G show example components for a battery coupling interface for a hard hat with an integrated electronic subsystem. The hard hat comprises a plurality of battery coupling interfaces for coupling a respective plurality of removable batteries. This then enables a “hot-swappable” functionality whereby a power subsystem of the integrated electronic subsystem is configured to draw power from a coupled one of the plurality of removable batteries to enable exchange of another of the plurality of removable batteries without power loss to the integrated electronic subsystem. This then enables prolonged use of the hard hat in the field (e.g., on a construction site) without downtime needed to change the batteries. This is particularly beneficial for an augmented reality device. This is because downtime may necessitate re-calibration of the system to view augmented reality images as power loss for battery exchange leads to the clearing of volatile memory.

FIGS. 5A to 5G further show an example battery coupling interface that provides a beneficial release and battery containment system. Through use of a detachable battery casing that comprises a securing mechanism to secure a removable battery held within the battery casing, batteries may be easily removed and swapped without losing or dropping the battery. This again further facilitates use of the hard hat “in the wild” of the construction site.

FIG. 5A shows a side perspective view 500 of an example hard hat 510. The hard hat 510 may comprise the hard hat as shown and described with respect to any of the previous Figures (e.g., FIGS. 2A to 2E, 3A to 3D, and/or 4A to 4E). The hard hat 510 comprises an integrated electronic subsystem 560, which, as previously described, may comprise at least one processor and memory, e.g. a compute module. The compute module may form part of an augmented reality system for the display of augmented reality images on display panels 522 mounted behind a set of safety goggles 520. The integrated electronic subsystem 560 may have features similar to those of previous examples (e.g., 260, 360, 460) and likewise the AR display panels 522 and safety goggles 520 may be configured as described with reference to FIGS. 2A to 2H (e.g., 222 and 220).

FIG. 5A shows an example with two battery coupling interfaces 505. The battery coupling interfaces 505 are arranged with the hard hat 510 and allow a removable battery 550 to be received to power the integrated electronic subsystem 560. The battery coupling interfaces 505 are laterally mounted within the hard hat 510, e.g. are mounted on either side of the hard hat near the ears of a wearer. The removable battery 550 may comprise a rechargeable battery, such as a Lithium-ion rechargeable battery or the like. The battery coupling interfaces 505 comprise a combination of mechanical and electrical interfaces to receive a removable battery 550 as carried by one of a set of wing portions 540. FIG. 5A shows a right wing portion 540-A that is removed from the hard hat 510 and a left wing portion 540-B that is retained within the hard hat 510. Each wing portion 540 forms a lower part 534 of a detachable battery casing that in use forms part of the side of the hard hat, continuing an edge 524 of the safety goggles 520. Examples of the lower parts 534 of the detachable battery casings being visible as wing portions 240-A and 240-B are provided in FIGS. 2A, 2C, 2E, and 2F. FIG. 2C, in particular, demonstrates how, in use with the battery installed in the hard hat, an upper part 536 is not visible. This upper part 536 is received within a fixed casing 544. The fixed casing 544 may comprise a moulded polymer casing that is attached to an inner portion of a multi-layer hard hat (e.g., as shown in FIGS. 3B and 4A). In other examples, the fixed casing 544 may form a moulded portion of a single layer polymer shell or an insert to a single layer shell. In examples herein, the wing portions shown as 240-A and 240-B may be considered to form a lateral wing to a viewing assembly for the augmented reality system. The viewing assembly for the augmented reality system may comprise one or more components that enable the user to view an augmented reality image (including so-called mixed reality and virtual reality as mentioned previously). The viewing assembly may comprise one or more of safety goggles 520 and the inner display panels 522.

FIG. 5A shows the hard hat 510 during a battery exchange operation. In this operation the user is swapping a right battery 550-A for a new or newly charged battery. In this arrangement, the integrated electronic subsystem 560 is powered using a battery (not shown) that is contained within the installed detachable battery casing that forms the left wing portion 540-B. The user may begin with both batteries installed and both wing portions in place (e.g., as shown in FIGS. 2A, 2C, 2E, and 2F). In this state the user may be notified that one of the batteries is low on charge (here the right battery 550-A). For example, this may be notified via a user interface shown on the augmented reality display panels 522 (e.g., as part of a head-up display—HUD) and/or via indicators (such as LEDs) on the hard hat and/or handheld controller. A charge or power status or level may be indicated via said approaches. While the user is still using the augmented reality display panels 522 to view augmented reality imagery, the user can begin the battery exchange operation by pressing release button 548-A at the rear of the wing portion 540-A. The release button 548-A mechanically releases the detachable battery casing from the battery casing interface forming part of the hard hat (e.g., from the interface 505-A formed, in part, by fixed casing 544). The user may also use a front grip portion 542 to pull on the detachable battery casing to aid its removable. Through the design of the hard hat 510, the weight of the battery 550 in the detachable battery casing also provides a force under gravity that leads to a natural downward movement of the detachable battery casing once the release button 548-A is pressed. In the present case, the release button 548-A forms a lower portion of a spring-loaded pivot latch. When installed, an upper portion 549-A of the pivot latch rests upon a tab within the inner portion (i.e., the tab forming part of the mechanical interface on the hard hat). When the release button 548-A pressed, the upper portion 549-A of the pivot latch is released, in turn releasing the latch from the tab, e.g. the upper portion 549-A moves to be flush with the rear surface of the wing portion 540-A allowing the wing portion 540-A to move downwards out of the hard hat. Once the detachable battery casing is released the battery may be removed from the casing and replaced with a charged one (e.g., as described below with reference to FIG. 5B). The detachable battery casing may then be returned to mate with the corresponding battery coupling interface 505-A of the hard hat. For example, if battery 550-A represents a new, charged battery, then an upward force may be applied to the wing portion 540-A to “clip” the upper part 536 of the detachable battery casing into the corresponding interface on the hard hat. For example, when the release button 548-A is not pressed, the base of the upper portion 549-A is urged outwards, e.g. by a spring loading. When the detachable battery casing is pushed up into the corresponding interface, the base of the upper portion 549-A pivots inwards against the urging force as the upper portion 549-A comes into contact with the corresponding interface on the hard hat and then when installed in a rest position, pivots back outwards under the urging force to clip in to a recess in the battery coupling interface 505-A of the hard hat (e.g., the lower edge of the base of the upper portion 549-A projects from the detachable battery casing and rests upon an upper edge of the recess that forms part of the tab). By pushing the wing portion 540-A back up into the interface 505-A so that it “locks” into place, the electrical terminal 552-A of the battery mates with a corresponding electrical terminal within the battery coupling interface 505-A of the hard hat such that the battery 550-A is then available to provide power to the integrated electronic subsystem 560.

Although a battery exchange operation is described above where the hard hat is worn during the exchange, it is also possible to exchange the batteries with the hard hat removed, e.g. by placing the hard hat upside down on a surface and releasing the detachable battery casing. It is also possible to exchange both batteries when the power is off. In yet another configuration, it may be possible to electrically couple the integrated electronic subsystem 560 to an external battery pack or power source via one or more of the electrical port 568-A or the electrical port 568-B (e.g., a USB-C connector as per 268 in FIG. 2H). By supplying power via one or more of the rear electrical ports, it may be possible to remove both of the detachable battery casings while maintaining a power supply to the integrated electronic subsystem 560.

FIGS. 5B and 5C provide views 502 and 504 of the right detachable battery casing 546-A as detached from the hard hat 510. Views 502 and 504 illustrate how a battery 550-A may be inserted into, and removed from, the detachable battery casing 546-A. Similar structure and functionality applies for the left detachable battery casing (but mapped symmetrically).

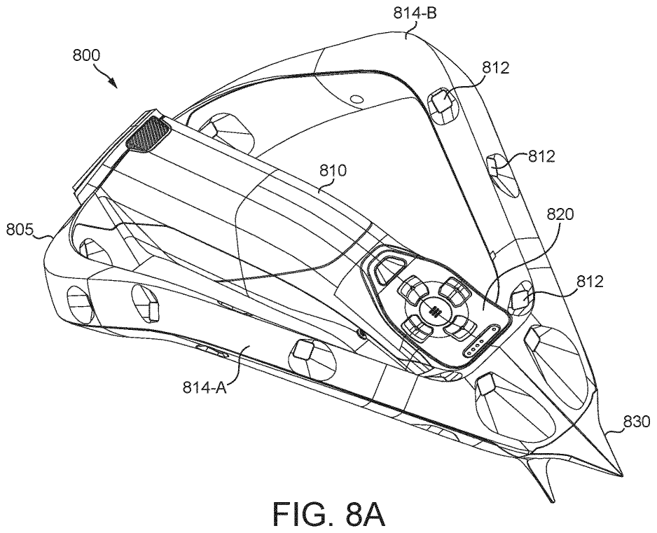

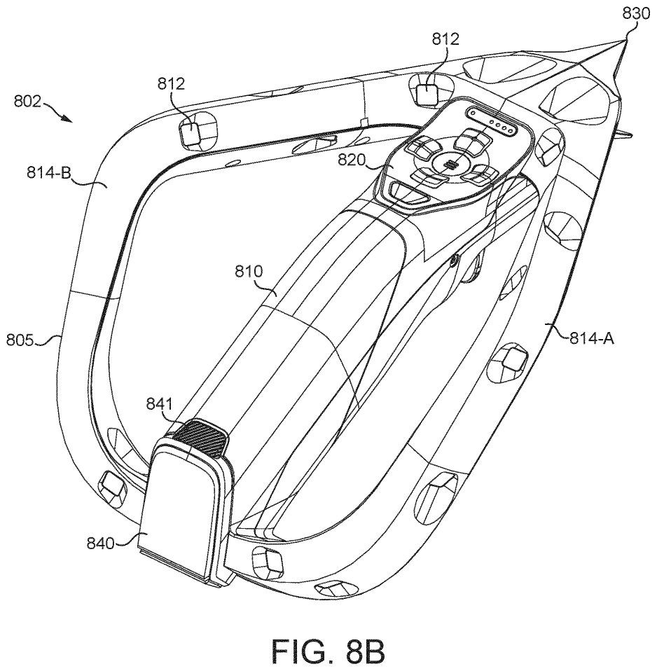

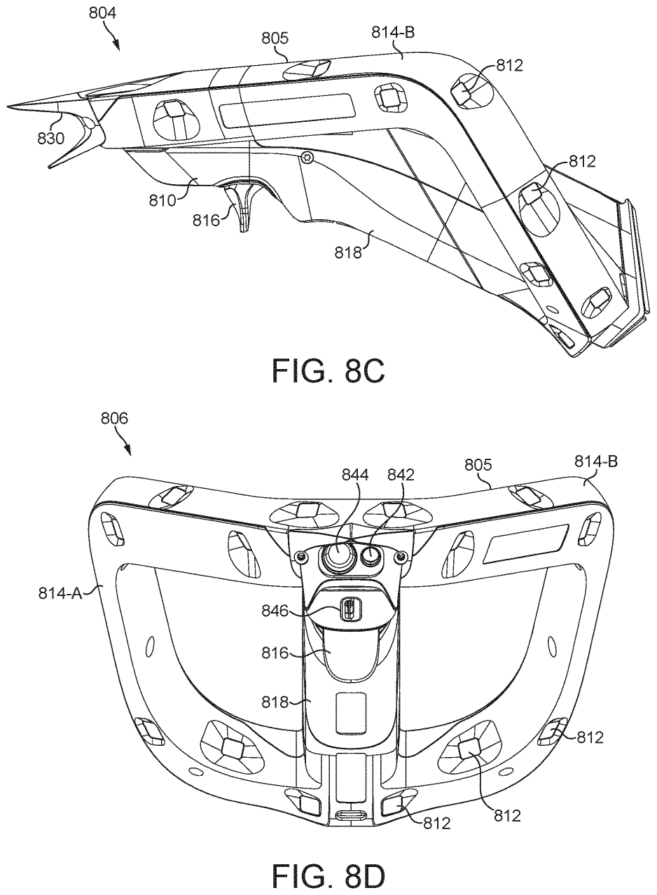

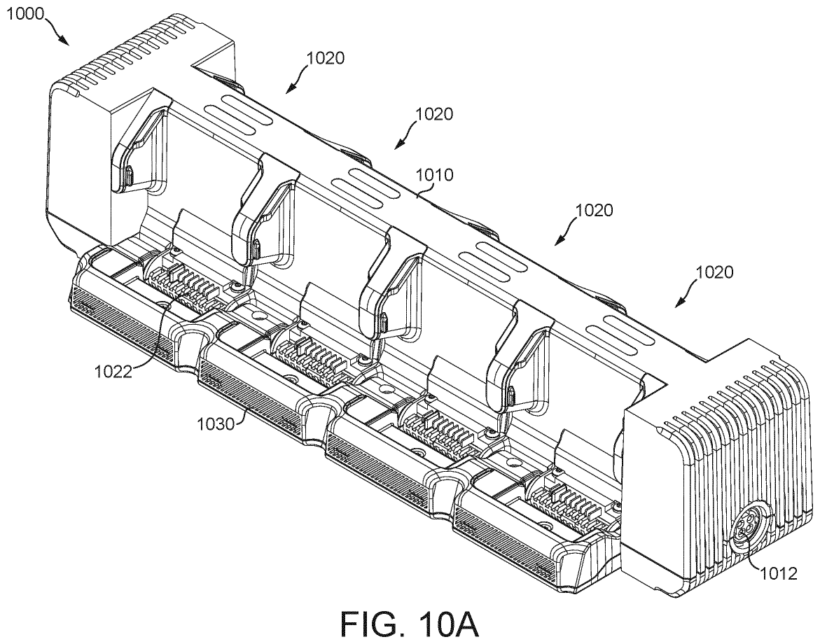

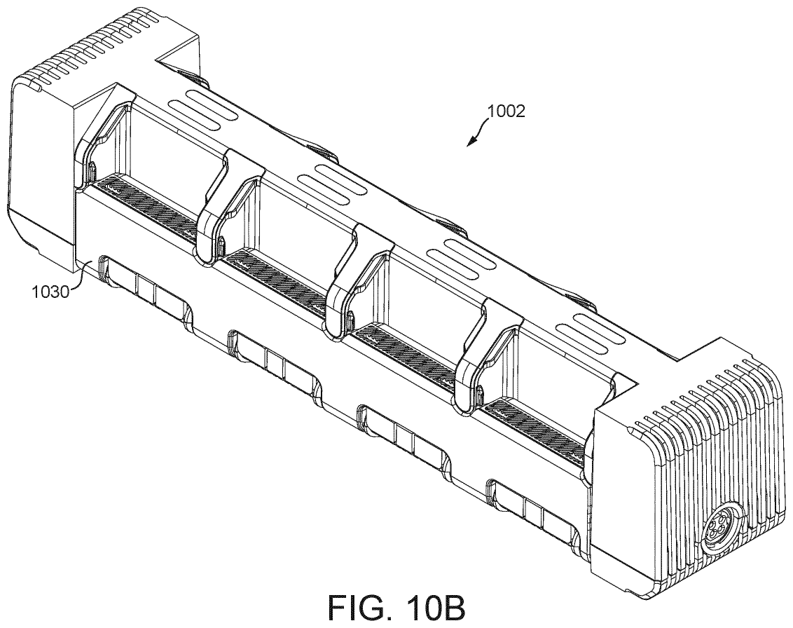

In FIG. 5B the battery 550-A is removed from the right detachable battery casing 546-A. As before the battery 550-A may be a rechargeable battery. In this case, the battery 550-A may be removed to be charged using the charging station of FIGS. 10A and 10B. In preferred examples, the battery 550-A is a rechargeable battery that may be used by a kit of components that include and accompany the hard hat 510. For example, the battery 550-A may also be used to power the handheld controller of FIGS. 8A to 8D and the tracking beacon of FIGS. 9A to 9C. Using a common rechargeable battery design for multiple components facilitates use on the construction site, where batteries may need to be quickly exchanged in the field and where electrical outlets may be limited. In FIG. 5B, a battery terminal 552-A at an upper end of the battery 550-A is visible. The battery terminal 552-A comprises an electrical interface that is configured to form an electrical coupling with a corresponding electrical interface (i.e., a battery socket) within the battery coupling interfaces 505. Similar corresponding electrical interfaces and battery coupling interfaces may be provided within the handheld controller of FIGS. 8A to 8D and the tracking beacon of FIGS. 9A to 9C.

In use, the battery 550-A is inserted into the interior 554-A of the right detachable battery casing 546-A. FIG. 5C shows the battery 550-A in place within the right detachable battery casing 546-A. As described in more detail with reference to FIGS. 5D to 5G below, the detachable battery casings 546 may comprise a securing mechanism to secure the removable battery within the detachable battery casing when the detachable battery casing is not coupled to the hard hat. In FIG. 5C, the securing mechanism holds or grips the battery 550-A within the right detachable battery casing 546-A. Hence, the right detachable battery casing 546-A with battery 550-A as shown in FIG. 5C may be tipped upside down without the battery 550-A falling from the right detachable battery casing 546-A (e.g., sliding out of the interior 554-A). As well as release button 548-A, which allows the right detachable battery casing 546-A to be mechanically decoupled from the hard hat, the right detachable battery casing 546-A also comprises mechanical latch 549-A. Pressing the battery release switch 548-A releases the mechanical latch 549-A, allowing it to pivot inwards and the right detachable battery casing 546-A to be removed from the hard hat.

FIG. 5D show a rear view 506 of the right detachable battery casing 546-A. This shows the hard hat release button 548-A and the mechanical latch 549-A, as well as a projecting portion 588-A of a pivoted member 581-A. FIG. 5D also indicates a cross section line E-E′. A cross section along line E-E′ is shown in the cross section view 508 of FIG. 5E. FIG. 5E shows the interior of the right detachable battery casing 546-A. Again, a similar design applies for the left detachable battery casing, with allowance for symmetry. It should be noted that each detachable battery casing 546 in the present example is configured to accommodate a common (i.e., the same) battery design. As such, there may be small differences in the interface design to receive the same battery on both left and right sides (e.g., with the terminal coupling rotated or configured to receive a rotated battery).

FIG. 5E shows the battery 550-A installed with the right detachable battery casing 546-A. FIG. 5E also shows a securing mechanism 580 that secures the removable battery within the detachable battery casing when the detachable battery casing is not coupled to the hard hat. While the securing mechanism 580 may be used just to secure each battery within a corresponding battery casing, the securing mechanism 580 of the present example has the additional feature of being released when the detachable battery casing is installed within the corresponding battery coupling interface. This is shown in more detail with respect to FIG. 5G. As such, in the present examples, the securing mechanism 580 is configured to secure the removable battery within the detachable battery casing when the detachable battery casing is not coupled to the hard hat and is arranged to release the removable battery when the detachable battery casing is coupled to the hard hat via a mechanical interface forming part of the battery coupling interface 505.

Turning to the securing mechanism 580 shown in FIG. 5E, in this example this comprises a gripping mechanism to apply a frictional force to the battery 550-A inside the detachable battery casing. The gripping mechanism comprises a pivoted member 581-A with a central pivot 584-A. The projecting portion 588-A forms an upper end of the pivoted member 581-A that projects out from detachable battery casing. The lower end of the pivoted member 581-A comprises a force applying member 586-A that is urged towards the battery 550-A by an urging member. In the present example, the urging member comprises a coiled spring within the detachable battery casing but may alternatively comprise a leaf spring or small electro-mechanical device. The urging member biases the force applying member 586-A towards the battery 550-A when the detachable battery casing is not installed within the hard hat 510. In the example of FIG. 5E, the force applying member 586-A further comprises a friction pad 587-A that contacts the exterior of the battery 550-A when installed within the detachable battery casing that increases the friction between the battery 550-A and the force applying member 586-A. In this example, the combination of the natural surface friction experienced by the battery 550-A when within the interior 554-A of the detachable battery casing and the additional frictional force applied by the force applying member 586-A is greater that a downward force under gravity due to the weight of the battery 550-A. As such, when the detachable battery casing is turned upside down with the battery within, the battery does not fall from the detachable battery casing. To release the battery 550-A, a user may simply pull out the battery and overcome the frictional force. In certain implementations, the user may alternatively press on the projecting portion 588-A to pivot the force applying member 586-A away from the battery. This breaks the contact of the friction pad 587-A and allows the user to pull up the battery 550-A or shake the battery out when upside down or otherwise angled downwards. In a preferred example, the friction pad 587-A comprises a Thermoplastic Polyurethane-TP-grip that provides good durability and resistance to wear and tear.

The detachable battery casing shown in FIG. 5E also comprises a battery biasing member 590-A at the bottom of the interior 554-A of the casing, within the wing portion 540-A. The battery biasing member 590-A applying a force to the base of the removable battery 550-A. While the battery 550-A is within the detachable battery casing and is not installed within the hard hat 510, the force applied by the force applying member 586-A is greater than the force applied by the battery biasing member 590-A and so the battery is not pushed upwards within the detachable battery casing. However, as shown in FIGS. 5F and 5G, when the detachable battery casing is coupled to the hard hat 510, the force applying member 586-A is disabled allowing the battery biasing member 590-A to apply an upwards force to the removable battery 550-A to facilitate an electrical coupling within the battery coupling interface 505-A, i.e. to form an electrical connection between the removable battery 505-A and the integrated electronic subsystem 560 of the hard hat 510.

FIGS. 5F and 5G provide views 512, 514 and 592 that show further details of the battery coupling interfaces 505 within the hard hat 510. In these examples, the hard hat 510 comprises a two-layer, dual shell hard hat as described, for example, with reference to FIGS. 3A to 3D; however, similar structure and functionality may also be used for single layer hard hats. FIG. 5F shows a rear view 512 and a side view 514 of an inner portion 532, which may comprise a carbon fibre shell. The carbon fibre shell may have a thickness of around 0.8 mm as described with reference to FIGS. 3A to 3D. In the views 512, 514, the inner portion 532 is shown without the integrated electronic subsystem 560. In the side view 514, the mounting position for the integrated electronic subsystem 560 is shown with arrow 562. View 512 shows a cross section line C-C′ and view 514 shows that cross section C-C′ through the battery coupling interface. Area 592 is shown in more detail in FIG. 5G.

FIG. 5G shows area 592 which is a cross section through the battery coupling interface 505-A. FIG. 5G shows the battery 550-A installed within the right detachable battery casing 546-A and the right detachable battery casing 546-A coupled to the battery coupling interface 505-A. The fixed casing 544-A forms part of a mechanical interface that holds the right detachable battery casing 546-A within the hard hat 510. When the right detachable battery casing 546-A is inserted, a portion 545-A of the fixed casing 544-A applies a force to the projecting portion 588-A of the pivoted member 581-A that pivots the lower end of the pivoted member 581-A, i.e. that pivots the force applying member 586-A away from the surface of the installed battery 550-A. This allows the battery biasing member 590-A to urge the base of the battery 550-A upwards into the battery coupling interface 505-A. This then ensures that there is a good electrical connection between the battery terminal 552-A and the corresponding electrical interface 594 of the battery coupling interface 505-A. This is advantageous on a construction site, where there may be dust and shocks and movement that tend to disrupt the electrical coupling. The electrical interface 594 may comprise a Printed Circuit Board (PCB) connector. The securing mechanism 580 and the battery biasing member 590 in combination thus prevent loss or damage of the battery while it is being exchanged yet ensures a robust connection following installation into the hard hat 510. This is especially import with an augmented reality system where power loss can interrupt the augmented reality view and require timely re-calibration and initialisation of the augmented reality system.

FIGS. 5A to 5G thus show an example of an internal, hot-swappable battery for use in a hard hat with an integrated electronic subsystem, where the subsystem may comprise a compute module for an augmented reality system. The integration of multiple battery coupling interfaces within the hard hat, and multiple corresponding removable batteries, means that an augmented reality view can be provided when swapping batteries, thus enabling all-day constant use of the augmented reality device. While described with reference to a construction environment, it should be noted that the hot-swappable battery arrangement may, in other examples, be employed in augmented reality devices that are used outside of the construction site, e.g. the approaches described herein may be applied in an augmented reality headset that is not a hard hat; however, there are particular benefits that are specifically designed for the constraints and issues experienced upon a construction site.

The described example of internal, hot-swappable battery for use in a hard hat with an integrated electronic subsystem uses hot-swappable batteries that are housed in a clip-on, detachable casing wing that provide integration into the hard hat (and more generally into an augmented reality device). Batteries may be detached with a single-handed operation whilst the headset is worn on the head or easily when the unit is not worn.

The described example provides advantages over comparative examples with fixed internal batteries or examples where the batteries need to be carried separately upon the user (e.g., in a rucksack or on a belt clip). In the latter case, the integrated detachable battery casing frees up space on the user's body, which is important for busy and often constrained spaces within a construction site. It is also safer as there are less cords and cables to snag on objects. It also overcomes the issue of battery capacity loss or fade, as batteries are easily replaceable. This is a synergistic feature when multiple components in an augmented reality kit share the same removable replaceable rechargeable battery, as a set of batteries can be charged for a day on site, and set in constant charging rotation (e.g., in a site office or the like). If one battery shows poor performance or issues, it can easily be removed from circulation and replaced with a new battery without worrying about compatibility or type.

The described examples also provide advantages over comparative examples that require an electronic or augmented reality device to be plugged in and/or taken offline to charge. This can take time and impedes the user's use of the device while it is being charged. The present example, however, allows un-disrupted power throughout the day—multiple hot swappable batteries allow a user to change the battery on the device without powering down.

The example securing mechanism described herein further prevents a user accidentally fumbling or dropping a battery during the battery exchange operation, which is a risk on busy and constrained building sites. The present examples thus provide a battery retention system that holds a battery in a removable wing when said wing is removed from a hard hat or other augmented reality device. This provides the ability to retain a battery within the removable wing housing when the housing is removed from a corresponding device (such as the hard hat) at a variety of angles, including during use or when the device is upside down on a table or in the hands.

In preferred examples, a spring-loaded force applying member or “gripper” provides a frictional hold on a side of the battery when a detachable battery casing is removed from a corresponding device. When the detachable battery casing is inserted into the device the gripper is released allowing a positive electrical connection between the battery and a corresponding circuitry connector. This ensures an electrical connection is reliably made.

In the described examples, batteries can be removed from an augmented reality hard hat on the user's head or upside down on a surface, e.g. at any angle. The securing mechanism prevents the battery falling out of the casing when inverted. This ability is provided without compromising a robust positive connection between the battery and the hard hat when the battery is stowed internally within the hard hat.

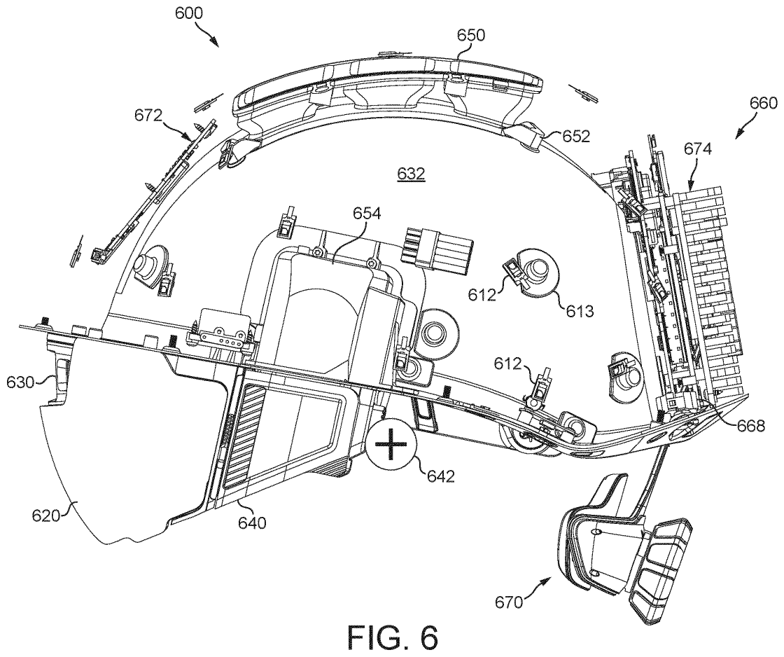

FIG. 6 is a side view 600 of an inner portion 632 of an example hard hat that illustrates how a location of a set of battery coupling interfaces also enables a location of a centre of gravity for the hard hat to be controlled. The centre of gravity may thus be positioned in a location that facilitates the comfort of the user, e.g. with regard to positioning the weight of the hard hat so it is best carried by the head of the user. The design may thus prevent negative strains being applied to sensitive areas such as the neck. Although, the example of FIG. 6 is described with reference to a two-layer, dual shell design, it is noted that the described location of the battery coupling interfaces may also be applied to other designs such as single layer helmets.

FIG. 6 shows the inner portion 632 with safety goggles 620, camera assembly 630, wing portions 640, and adjustable nape support 670. As such, the present example may comprise features similar to those described with reference to at least FIGS. 2A to 2H and 3A to 3D. FIG. 6 also shows a deformable ventilation coupling 650, which may be configures as per ventilation coupling 450 described with reference to FIGS. 4A to 4E. FIG. 6 also shows a number of electronic components in positions corresponding to their mounting positions upon either inner portion 632 or an outer portion such as 310 in FIG. 3A. These include photo sensors 612 (e.g., that are shown externally as photo sensors 212 in FIGS. 2A to 2H) which are mounted upon the outer portion, a rear circuit board 668 for an integrated electronic subsystem 660 (e.g., which may be configured as per subsystems 260 to 560), a front circuit board 672 and a heat sink 674. FIG. 6 also shows mounting plates 613. The mounting plates 613 comprise screw bosses that allow for the mounting of mesh fastening prongs (shown as 349 in FIGS. 3C and 762 in FIG. 7A) for the woven inner mesh (e.g., an impact textile mesh). The mounting plates 613 may be fastened within drilled or cut apertures in the inner portion 632 and/or attached using adhesive. The heat sink 674 comprises cooling fins that allow components of the rear circuit board 668 (e.g., at least one processor, memory, and other chips and/or electronic components) to be cooled, e.g. via the action of a fan as described with reference to features 264 and 266 in at least FIG. 2D. The front circuit board 672 may comprise driving circuitry for one or more of AR display panels (e.g., 222 in FIG. 2D), the camera assembly 630, and one or more photo sensors 612. Different configurations and couplings are possible between the electronic components.

In FIG. 6, the battery coupling interfaces are implemented within fixed casing 654 that is secured to the inner portion 632. The wing portion 640 may be inserted into the fixed casing 654 as shown in at least FIGS. 5A and 5G. In the present example, the battery coupling interfaces are located laterally upon the hard hat, such that a centre of gravity 642 of the hard hat is aligned with the head and neck of a user wearing the hard hat. For example, the main weight of the hard hat comprises the integrated electronic subsystem 660 at the rear of the hard hat, the augmented reality display panels and driving front circuitry 672, the camera assembly 630, and the batteries within the wing portions. As the augmented reality display panels and driving front circuitry 672 are constrained to be located near the front of the hard hat, the location of the integrated electronic subsystem 660 at the rear of the hard hat provides a first element of balance. However, the integrated electronic subsystem 660, e.g. including rear circuitry 668 and heat sink 674, and the corresponding fan and casing, is typically heavier than the front-located display systems. By carefully choosing the position of the wing portions 640, and thus by extension the weight of the batteries, the centre of gravity 642 may be moved forward and back along the length of the hard hat. Through user testing and force calculations, it has been found that positioning the wing portions 640 (via the positioning of fixed casing 654 on the inner portion 632) to the rear of the safety goggles 620 in the design as shown locates the centre of gravity 642 just to the rear of the wing portions 640 and below the rim or peak of the hard hat. As the hard hat is configured in a substantially symmetrical design, right and left portions of the hard hat are similarly (e.g., symmetrically) weighted and thus the centre of gravity 642 of the hard hat is located on or near a midline of the hard hat (e.g., along the cross-section line A-A′ in FIG. 2G). For user comfort it is preferred that the centre of gravity 642 is as low as possible on the user's head. By mounting multiple batteries laterally in the wing portions 640, and having a portion of the battery reside within the wing portion 640 below the rim or peak of the hard hat, the centre of gravity 642 is lowered below the rim or peak, improving comfort for long periods of wear.

Hence, in the example of FIG. 6 (and other shown examples herein), battery placement has specifically been configured for an optimised weight distribution of the hard hat. As the batteries are often the heavier (or heaviest) components of an augmented reality device, by controlling their placement within a headset or hard hat, a user's comfort can be increased, and neck strain may be reduced and/or avoided. Through prototyping, a low centre of gravity (e.g., below a rim or peak of a hard hat) was found to be most comfortable for long periods of use and so the placement of the battery coupling interfaces was carefully designed (e.g., as shown in the Figures) to provide optimal comfort and a lowest perceived weight. Having a low centralised centre of gravity such as 642 as shown, as enabled by suitably arranging the components of the hard hat, users were found to have a reduced sense of device weight and were able to be active on a construction site without pain. Although the placement has been described with respect to a hard hat, and has particular benefit for construction sites that involved long periods of use (e.g., site visits and inspections) and sometimes physically demanding access as compared to use within a home or office, it may also be used for augmented reality devices or other electronic headsets that do not comprise a hard hat.

### Example Cradle Adjustment Mechanism

FIGS. 7A to 7C show an example cradle height adjustment mechanism that may be used with the hard hat described in previous examples. The cradle height adjustment mechanism allows the height of the hard hat on the user's head to be easily and quickly adjusted. Although designed for use with a hard hat comprising an integrated electronic subsystem as per previous example, the cradle height adjustment mechanism may also be used with other forms of hard hat and helmets, including those without an integrated electronic subsystem.

FIG. 7A shows a view 702 of the example cradle height adjustment mechanism 705 in use within an example hard hat 710. The cradle height adjustment mechanism 705 comprises a cradle 755 for positioning the hard hat 710 on a head of a user and a set of cradle mounting pins 771. In the example of FIG. 7A, the cradle 755 extends around the front and sides of a user's head and complements a rear adjustable nape support 770 (e.g., as described with reference to 270 in FIG. 2C). In other examples, the cradle 755 may extend all around the head of a user and comprise front, side, and back portions. In FIG. 7A, the cradle comprises a front portion 755-A, a right side portion 755-B, and a left side portion 755-C (shown in FIGS. 7B and 7C). The cradle 755 may comprise a semi-flexible polymer. In FIG. 7A, the front and side portions comprise areas 753, 754 to attach comfort pads to rest against the user's head. For example, areas 753, 754 may comprise one half of a hook-and-fastener system that allows the comfort pads to be easily attached and removed. In other examples, the comfort pads may be attached to areas 753, 754 with adhesive. In use, the cradle 755 with comfort pads, a comfort pad of the rear adjustable nape support 770, and a woven support mesh 748 may contact the user's head to allow the user to comfortably wear the hard hat 710. As described at least with reference to FIG. 3C, the woven support mesh 748 may be hooked onto fastening prongs 762 that are located within the interior of the hard hat 710 (e.g., upon an inner portion of a two-layer design).

FIG. 7B shows a detailed view 704 of a plurality of spaced apertures 764, 765 provided within the cradle 755. These spaced apertures 764, 765 are adjustably alignable with corresponding apertures within a cradle mounting that receives the cradle 755. The cradle mounting is shown in more detail in FIG. 7C. As shown in FIG. 7B, the set of cradle mounting pins 771 are removable to select different ones of the plurality of spaced apertures 764, 765 to adjust a relative height of the cradle compared to the cradle mounting for use. For example, the height of the cradle 755 may be adjustable within the cradle mounting (and by extension the hard hat 710) by a vertical spacing of 10 mm. In the illustrated example, the set of cradle mounting pins 771 comprise quarter turn bayonet locking pins. The shaft 772 of each pin comprises two laterally spaced lugs 773 near the base of the shaft. These lugs 773 comprise protrusions that slope downwards towards the base of the shaft 772. Each spaced aperture 764, 765 comprises a central circular portion and two laterally spaced side notches that correspond to the lugs 773. FIG. 7C shows in more detail cradle mounting areas 775 that are located in positions around the interior of the hard hat 710 in a manner that corresponds to the positions of the spaced apertures 764, 765 on the cradle 755. The cradle mounting areas 775 collectively form a cradle mounting. In the present examples, there are four cradle mounting areas 775 located near four corners of the hard hat 710 and corresponding to four corners of the cradle 755. The cradle mounting areas 775 comprise apertures 781 that are shaped to match the spaced apertures 764, 765 of the cradle 755 (e.g., with a central circular portion and laterally spaced notches).

To insert the cradle 755, the user starts from the configuration shown in FIG. 7C. Four cradle mounting pins 771 are provided that correspond to the four sets of spaced apertures 764, 765 and the corresponding apertures 781 in the cradle mounting areas 775. The user aligns one of the spaced apertures 764, 765 with the mounting apertures 781 to “select” a particular spaced aperture. The user then aligns the lugs on each cradle mounting pin 771 with the notches of the apertures 764, 765, 781 and inserts the shaft of the pin 771 through the selected spaced aperture and into the mounting aperture 781. The user then turns each pin 771 through a quarter turn (e.g., clockwise or anti-clockwise by 90 degrees depending on the lug configuration) to rotate the lugs away from the notches and thus fasten the lugs behind the walls neighbouring the circular portion of the mounting aperture 781. In this manner, the cradle 755 is locked into place for the selected alignment by the set of four cradle mounting pins 771. It should be noted that although four sets of pins, spaced apertures, and mounting apertures are described, different numbers of sets may be provided in other examples.

As may be seen in each of FIGS. 7A, 7B, and 7C, each cradle mounting pin 771 may comprise a foldable handle 774 that at rest is stowed around the circumference of the pin head. However, during use in adjusting the cradle position, the foldable handle 774 may be pivoted away from the face of the pin head, i.e. to a position substantially normal to a face of each mounting pin, to facilitate turning of the pin. The foldable handle 774 may then be returned to the at rest position where it is lying prone (i.e., in line with the pin face) so that it does not dig into the head of the user when the hard hat 710 is worn. The foldable handle 774 may comprise a bent metal wire or a moulded polymer part that is clipped into small apertures on the circumference of the face of the pin. The foldable handle 774 may be designed to experience a frictional force at rest that prevents it rotating away from the face of the mounting pin unless moved by a user.

As shown in FIGS. 7A to 7C, a method is provided for adjusting a height of a hard hat as positioned on a head of a user. The method starts, for example, at the configuration shown in FIG. 7A. The method comprises a first step of turning a set of cradle mounting pins 771 to remove the pins from sets of corresponding apertures 764, 765 in a cradle 755 and a cradle mounting 775 of the hard hat 710. This allows the user to remove the cradle as is shown in FIG. 7C. Next a user selects a set of alternate mounting apertures in at least one of the cradle 755 and the cradle mounting 775. In the present example, the cradle 755 has two vertically spaced apertures and the cradle mounting 775 has a single aperture 781; however, in other examples, the cradle mounting 775 may have multiple spaced apertures as well as, or instead of, having multiple spaced apertures within the cradle 755 (e.g., the cradle may have single apertures instead). In other examples, more than two differently spaced positions may be provided to provide more than two adjustable positions. It should be noted that a user may choose to mix and match aperture pairings on the cradle and the cradle mounting to provide for different height configurations.

Returning to the method, the user moves at least one of the cradle and the cradle mounting to align the selected set of alternate mounting apertures. For example, in FIG. 7A, the shown rear pin 771 is in the upper cradle aperture 764 and the shown front pin 771 is in the lower cradle aperture 775—the user may remove one or more of the pins 771 to choose a different cradle aperture. It should be noted that a user need not remove all the pins and may choose to adjust one (or a subset) of the cradle mounting pins at any one time. Once a selection has been made, and the desired apertures aligned, the user reinserts the cradle mounting pins 771 into the aligned alternate mounting apertures (e.g., following a procedure similar to that shown in FIG. 7B). Finally, the user turns the set of one or more cradle mounting pins to lock the pins into position (e.g., to return to a configuration similar to that shown in FIG. 7A but with adjusted locations).

The example of FIGS. 7A to 7C features the use of quarter turn pins to provide for cradle height adjustment in a construction hard hat. The example is an improvement over comparative “snap-fit” adjustment mechanisms (e.g., where the cradle has a row of apertures that are snapped over corresponding prongs within the hard hat). Comparative “snap-fit” adjustment mechanisms tend to be cumbersome—it is often strenuous and difficult to detach a strong cradle connection, leading to a trade-off between a robustness of the cradle installation and an ease of adjustment. In these comparative cases, it can often be very difficult to detach the cradle, straining a user to operate the very strong cradle snap fits that are required for secure attachment. In contrast, the present example provides a strong cradle connection (e.g., via the locking mechanism of the cradle mounting pins) but also allows for easy access and adjustment (e.g., via a quick quarter turn of the pin, which may be facilitated by the foldable handle).

### Example Handheld Controller

FIGS. 8A to 8D show a handheld controller 805 that may be used together with the augmented reality hard hat described in the previous examples. The handheld controller 805 may aid a user in interacting with the visible real and virtual environments, as well as having functionality for configuring the augmented reality display. For example, the handheld controller 805 may comprise an improved version of the handheld controller described in WO2019/048866 A1. As such the handheld controller may be capable of the functionality described in WO2019/048866 A1 but with additional new features that are not found in WO2019/048866 A1.

FIG. 8A shows a top perspective view 800 of the front of the handheld controller 805. The handheld controller 805 comprises a central body 810 that is configured to be grasped by a hand of the user while viewing an augmented reality image, e.g. via the hard hat of one of the previous examples. Like the hard hat of the previous examples, the handheld controller 805 comprises photo sensors 812 that are distributed over the controller. These photo sensors 812 are similar to the photo sensors 212 arranged on the hard hat 210 in FIG. 2A. They enable the position and the orientation (i.e., the pose) of handheld controller 805 to be located within a tracked volume formed within a set of tracking beacons, such as those that implement tracking beacons 102 (e.g., as per the hard hat). Preferably the positional tracking system has millimetre accuracy. The handheld controller 805 comprises a winged design featuring a right wing 814-A and a left wing 814-B. The winged design, which differs from the single elongate body featured in WO2019/048866 A1, has a number of benefits. Firstly, it protects the user's hand from impacts around the construction site, e.g. either from objects in motion towards the user's hand or as the user gestures with the handheld controller to control an augmented reality display. Secondly, the winged design allows for improved placement of the photo sensors 212—by having a unique shape where the photo sensors 212 are more evenly distributed within a volume surrounding the central body 810, the determination of the pose of the handheld controller 805 may be improved, e.g. increasing accuracy especially while in motion for gestures. Towards the front of the handheld controller 805 on the top of the central body 810 is a series of buttons and indicators that comprise a control pad 820. In this example. the control pad 820 comprises four directional buttons and a central selection button. The control pad 820 may also comprise Light Emitting Diode (LED) indicators to show a status of the handheld controller (e.g., battery change, whether the device is on, and/or whether the device is being tracked). In other examples, the control pad 820 may comprise a (capacitive) touch pad or other user interface technology.

At the front of the handheld controller 805 is a three-pronged nose 830. The three-pronged nose 830 comprises an upper single prong and two lower prongs (these are visible in FIG. 8D). To configure a transformation that maps between a coordinate system used by the positional tracking system and a coordinate system used by a building information model (BIM), the handheld controller 805 may be used to measure the locations of a series of control points. These control points may comprise adhesive targets that are positioned within a construction site and then surveyed to determine a geodetic location of a centre of the target. A user operating the handheld controller 805 positions the two lower prongs at defined points on the target (e.g., lower corners or marked positions) and aligns the upper prong with the centre of the target. The user may then activate a button on the handheld controller 805 (e.g., the central selection button of the control pad 820 or the trigger button 816 shown in FIGS. 8C and 8D) to determine a location and orientation of the handheld controller 805 within the positional tracking coordinate system. As the tip of the prong has a known position with respect to a defined origin or central/reference coordinate of the handheld controller, an accurate location and/or orientation of the centre of the target in the positional tracking coordinate system. Once this has been performed for three or four control points, the two sets of coordinates for the control points-one set within a coordinate system used by the BIM (e.g., a geodetic coordinate system) and one set within a coordinate system used by the positional tracking system-may be processed to determine a transformation that maps between the two coordinate systems (where a forward transformation may map one way between the coordinate systems and an inverse transformation may map the other way). The transformation may be defined as a 4×4 matrix with rotation and translation terms. Further details of this calibration procedures are covered in WO2019/048866 A1.

FIG. 8B shows a rear perspective view 820 of a top of the handheld controller 805. In addition to the features shown in FIG. 8A, a battery access door 840 is further shown. The handheld controller 805 may use a rechargeable battery as is shown in FIG. 5B (550) or FIG. 9C (950), i.e. may use a common battery type that can be used in any of the devices described herein. The battery may be changed, e.g. for a newly charged battery, by pressing the release button 841.

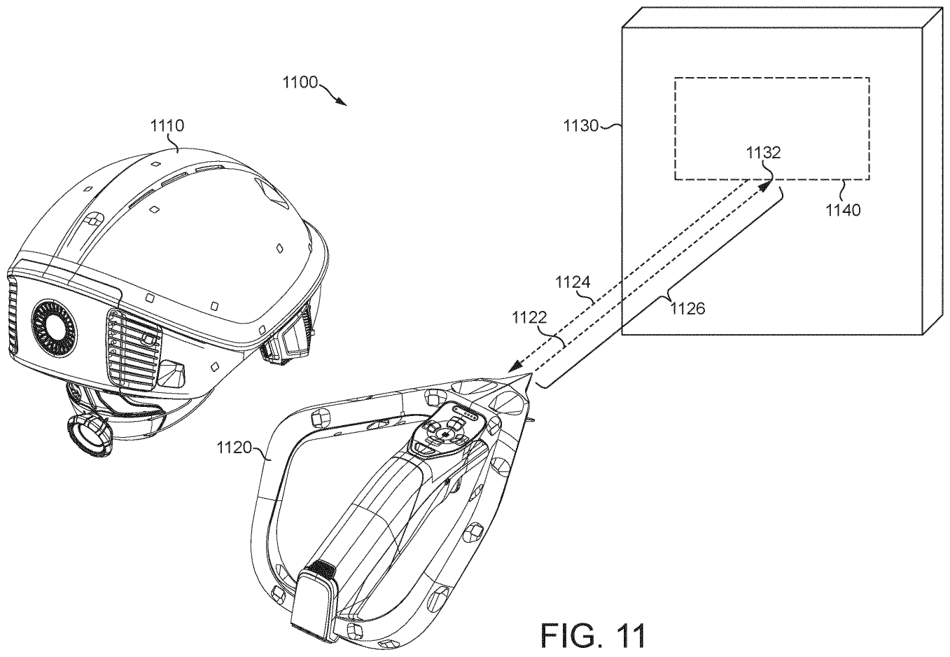

FIG. 8C shows a side view 804 of the handheld controller 805. In this view 804, the central body 810 is visible. A user may hold the handheld controller 805 like a gun, with their palm and lower fingers wrapped around a grip portion 818. The grip portion 818 may be shaped to fit the contours of a human hand. The user's trigger (index) finger is then aligned to press the trigger button 816. The trigger button 816 may be used to make selections within an augmented reality interface visible via augmented reality display panels and/or activate certain functions of the handheld controller 805 (e.g., to make a calibration measurement as described above and/or to activate a pointing measurement as described with reference to FIGS. 11 to 13).

FIG. 8D shows a front view 806 of the handheld controller 805. In the present example, the handheld controller 805 further comprises an electronic distance measurement instrument that may be used in a set of user interface methods as described later below. As well as the components described above, portions of the electronic distance measurement instrument are visible in the front view 806. In the present case, the electronic distance measurement instrument comprises a laser distance measurement device. The front of the handheld controller 805 thus comprises a laser emitter 842 and a laser receiver 844. The laser emitter 842 emits a pulse of electromagnetic radiation, which may be reflected from a surface and returned via the laser receiver 844. The laser receiver 844 comprises a lens for focussing returned radiation. The laser distance measurement device may be a laser range finder and may operate according to one or more of: time of flight measurements, multiple frequency phase-shift measurements, and interferometry. The laser range finder may comprise an off-the-shelf laser rangefinder. In other examples, electronic distance measurement instrument may use ultrasonic technology, optics (e.g., based on coincidence or stereoscopic measurements), and/or infra-red rangefinders, amongst others. In one case, a button on the control pad 820 and/or the trigger 816 may be used to activate an electronic distance measurement. The control pad 820 may also indicate to the user, e.g. via LEDs or a panel display, whether an electronic distance measurement is taking place.

FIG. 8D also shows an electrical port 846. This may comprise a USB-C port similar to the ports 268 or 568 shown in FIGS. 2H and 5A. The electrical port 846 may be used to power the handheld controller 805 and/or communicate data to and/or from the controller. For example, the handheld controller 805 may be plugged into the hard hat and/or a further computing device to download measurement data acquired during use (including the control point locations). In certain configurations, the handheld controller 805 may also comprise a wireless communications interface (e.g., Bluetooth®, Zigbee®, and/or WiFi®) to communicate data.

### Example Tracking Beacon

FIGS. 9A to 9C show different views of an example tracking beacon 910 that may be used to implement the tracking beacons 102 shown in FIGS. 1A and 1B. FIG. 9A shows a front perspective view 900, FIG. 9B shows a first rear perspective view 902, and FIG. 9C shows a second rear perspective view 904. The front of the tracking beacon 910 comprises a window portion 912 behind which are mounted emitters for emitting one or more of the beams 103, 104, and 105. The tracking beacon also comprises an electrical port 913, which may be a USB-C port similar to ports 268, 568, and 846 described with reference to FIGS. 2H, 5A, 8D above. The electrical port 913 may be used for one or more of power supply, data communication, configuration, and firmware updates. The rear of the tracking beacon 910 comprises a battery access button 914 and a battery access door 918. As shown in FIG. 9C, when the battery access button 914 is pressed the battery access door 918 opens (e.g., by releasing a spring that urges the door open).

The tracking beacon 910 in the present example is configured to use a removable rechargeable battery 950. The removable rechargeable battery 950 may be a type that can be used by all of the described devices herein (e.g., by the hard hat and the handheld controller). As explained above, this simplifies charging and battery exchange. In FIG. 9C, a newly charged battery 950 is inserted into an interior 922 of the tracking beacon 910 such that a terminal 952 of the battery 950 makes electrical contact with a corresponding battery interface within the tracking beacon 910. A user closes the battery access door 918 by rotating the door about a base pivot axis and overcoming the force of the spring loading. On the underside of the battery access door 918 is located an urging member 924 in the form of leaf spring. Similar to the battery biasing member 590 in FIG. 5G, the urging member 924 applying a force to the base of the battery 950 such that the battery terminal 952 makes a firm coupling with the corresponding battery interface within the tracking beacon 910.

### Example Charging Station

FIGS. 10A and 10B are perspective views showing two configurations 1000, 1002 of an example charging station 1010. The example charging station 1010 may be used to charge a plurality of rechargeable batteries. The rechargeable batteries may be of a design as shown in FIGS. 5B and 9C. The rechargeable batteries may comprise a common (i.e., shared) battery for a kit of interrelated components that are used for augmented reality on a construction site. For example, a hard hat may use two rechargeable batteries (e.g., as shown in FIG. 5A), a handheld controller may use one rechargeable battery (e.g., as shown in FIG. 8B), and a tracking beacon may use one rechargeable battery (e.g., as shown in FIG. 9C). The rechargeable battery may comprise a Lithium-ion battery.

The first configuration 1000 of the charging station 1010 is shown in FIG. 10A. The charging station 1010 comprises a plurality (eight in this example) of charging bays 1020 to receive a rechargeable battery for recharging. The charging station 1010 may be plugged into a power supply via power port 1012. The charging station 1010 may provide for a fast-charging mode where a high current is used to rapidly charge one or more rechargeable batteries. In one case, the charging station 1010 may have a power output for charging of over 100W. Providing power by USB ports may allow charging modes having one of 5V/3 A, 9V/3 A, 15V/2 A, and 20V/1.5 A and the battery port may allow charging at approximately 8.4V/1.19 A. Voltage and current supply may be configured in firmware for the charging station 1010. The charging rate for each charging mode may also be configurable, e.g. depending on how many batteries are coupled to the charging station 1010. The maximum power draw of the charging station, assuming a 90% efficiency and taking into account a built-in fan for cooling, may be around 158 W. A charging process may have two or more stages: a constant current stage where voltage is increased towards a peak, a saturation stage where voltage reaches a peak and current then reduces (the voltage may be maintained at a constant value at its peak), and a trickle or top-up phase when the battery is fully charged (e.g., as determined by the current reaching a set percentage of its initial constant charging current). Each charging bay comprises a battery coupling interface 1022 comprising electrical terminals that mate with corresponding terminals on the rechargeable batteries (e.g., terminal 552-A in FIGS. 5B and 5C). In the present example, there are four battery charging bays 1020 in series on each side of the battery charging station 1010. This makes for an efficient arrangement for space limited construction areas.

In the present example, the charging station 1010 comprises a pivoted base portion 1030. In use, the base portion 1030 is pivoted outwards so the battery coupling interface 1022 in each battery charging bay 1020 is exposed and able to receive a battery for charging. However, when a side of the battery charging station 1010 is not in use, e.g. when the station is being transported to and/or from a construction site, the base portion 1030 may be pivoted upwards as shown in the second configuration 1002 of FIG. 10B. As may be seen, in this second configuration 1002 the battery charging bays 1020 are closed and the battery coupling interfaces 1022 are protected, e.g. from dust and dirt and the like entering into the interfaces. In one case, the base portion 1030 of each side may be independently pivotable. In another case, the base portion 1030 of both sides may be entrained to a common gearing that coordinates the opening of the bays. In yet another case, the base portion 1030 may be individually pivotable for each bay 1020. In alternative examples, the pivoted base portion 1030 may also be replaced with a slide-able base portion 1030 that is translatable into and out of the main body of the charging station 1010 to either expose or hide the battery coupling interfaces 1022. Again, each base portion 1030 may be translatable as one side unit or individually for different bays (e.g., depending on a chosen implementation design).

The components of FIGS. 2A to 10B thus provide, in certain cases, a kit for use on a construction site. For example, the kit may comprise one or more of: a hard hat with an integrated augmented reality subsystem; a plurality of removable rechargeable batteries; a set of detachable battery casings, each detachable battery casing receiving, in use, one of the plurality of removable rechargeable batteries, at least two of the set of detachable battery cases being mechanically couplable to the hard hat in use to power the integrated augmented reality subsystem of the hard hat; and one or more tracking beacons for use in determining a position of the hard hat within the construction site, each tracking beacon being configured to receive at least one of the plurality of removable rechargeable batteries for power in a case where external power is not available. The kit may further comprise one or more of a handheld controller as shown in FIGS. 8A to 8D and a charging station to recharge one or more of the plurality of removable rechargeable batteries, e.g. as shown in FIGS. 10A to 10B.

The charging station may be arranged to recharge more than two of the plurality of removable rechargeable batteries at the same time and may comprise a plurality of battery recharge bays on each side of the charging station. A receiving portion of each side of the charging station (e.g., base portion 1030) may be moveable between two positions: an open position to receive one or more of the plurality of removable rechargeable batteries and a closed position wherein terminals for the plurality of battery recharge bays are protected (e.g., as respectively shown in the first and second configurations 1000, 1002).

### Example User Interaction Methods

FIG. 11 shows an example 1100 of using the handheld controller as a moveable device to interact with an augmented reality view of a construction site. In the example of FIG. 11, a hard hat 1110 with an augmented reality display is used to view augmented reality images. The hard hat 1110 may comprise the hard hat of previous examples (e.g., as described with reference to FIGS. 2A to 7C) or may comprise another device. The handheld controller 1120 may comprise the handheld controller 805 of FIGS. 8A to 8D or another moveable device. The handheld controller 1120 is useable to interact with a virtual representation of a construction site as viewed by a user with a head mounted display, e.g. a user wearing hard hat 1110. In this case, the handheld controller 1120 is separate to the hard hat 1110. The handheld controller 1120 comprises a set of sensors for a positional tracking system (e.g., photo sensors 812 in FIGS. 8A to 8D) and an electronic distance measurement instrument (e.g., the laser measurement device having emitter 842 and receiver 844 in FIG. 8D). The set of sensors are configured to obtain sensor data to derive one or more of a position and orientation of the handheld controller 1120 within the construction site. In a preferred case, both a position and orientation of the handheld controller 1120 (i.e., a pose) are determined with respect to a positional tracking system (e.g., the system shown in FIG. 1A). For example, a defined centre point or origin of the controller may be tracked within a coordinate system of the positional tracking system (e.g., where an origin of the positional tracking system may be defined with respect to tracking beacons 102—in certain cases one of the tracking beacons represents or a corner of a tracked volume is set as an origin or zero point). The positional tracking system may have millimetre accuracy.

In use, the electronic distance measurement instrument is configured to determine a distance from a known location on the handheld controller 1120 along a line-of-sight to an occupied portion of space within the construction site. This is shown in FIG. 11. In this example, a laser beam is emitted from the laser emitter 842 along line-of-sight 1122. It then meets a point 1132 in an occupied portion of space—in this example a point on the plane of wall 1130—and is reflected along the line-of-sight 1124 back to the handheld controller 1120 where it is received by the laser receiver 844. This process may take place, for example, when the user points the handheld controller 1120 in a given mode of operation and presses the trigger button 816 as shown in FIG. 8B. In the present case, the occupied portion of space is remote from the handheld controller 1120, e.g. it comprises a wall 1030 that is located a distance away from the user. By using a known technique for electronic distance measurement (e.g., one of the approaches described with reference to FIGS. 8A to 8D), the distance 1126 between the handheld controller 1120 and the wall 1130 along the line-of-sight 1122, 1124 may be measured. Using the sensor data and the determined distance a position of the point 1132 corresponding to the occupied portion of space may be determined that is defined in reference to the positional tracking system. The handheld controller 1120 is thus configured to be oriented by the user within the construction site to compare model-defined and measured real-world points within the virtual representation. For example, the location of real-world point 1132 within the coordinate system of the positional tracking system may be determined from the pose of the handheld controller 1120 as measured within the coordinate system of the positional tracking system and the distance measured by the electronic distance measurement instrument. This then locates the point 1132 within a virtual space. The point 1132 may thus be shown in the augmented reality view in the hard hat 1110. For example, the user may place a virtual object 1140 at the point location, e.g. against the wall 1130. Alternatively, they may associate a virtual annotation, such as a virtual “sticky note”, with the point 1132. This then provides a way to annotate virtual equivalents of real-world points (such as 1132 on the wall) in a virtual model (such as a BIM). For example, during an inspection a user may wish to annotate a digital version of a real-world object. The user thus points the controller 1120 at the object and clicks the trigger button (or activates another input mechanism) and they are able to determine the virtual equivalent point within a virtual coordinate system. Via a calibrated transformation between the positional coordinate system and a coordinate system used by the BIM, a point determined in the positional coordinate system is also mappable to a point in the BIM. The BIM can thus be annotated.

In more detail, in a preferred case, the electronic distance measurement instrument emits a directional beam to determine the distance. As described earlier the directional beam may comprise a beam of electromagnetic radiation or an ultrasound beam. The directional beam is emitted from a known location on the moveable device, e.g. emitter 842 on handheld controller 805. The known location has a fixed position with respect to a tracked reference point for the moveable device. For example, a tracked reference point for the handheld controller 805 may comprise an Inertial Measurement Unit (IMU) within the body 810 of the handheld controller 805. The IMU has a fixed position with reference to the emitter 842, e.g. a fixed transformation (translation and rotation) between the IMU position and the emitter 842 may be exported from a Computer Aided Design (CAD) specification for the handheld controller 805. Hence, if a pose of the moveable device is known, e.g. a position of the IMU within the device and an orientation of the device at that position as represented by a normal vector, then the location and orientation (i.e., pose) of the emitter 842 may be known using the fixed transformation and a line-of-sight transformation defined that models a line from the emission point with a length equal to the measured distance. This then allows the pose of the measured point 1132 to be known. In practice, calibration may be performed to set the line-of-sight transformation (e.g., it may be deemed to be projected from the emitter 842 or at a mid-point between the emitter 842 and receiver 844)—the exact line-of-sight transformation may depend on the configuration of the electronic distance measurement instrument (e.g., an effective or modelled beam projection with respect to an emitter 842 and receiver 844 assembly may be set in a manufacturers data sheet). In effect, there is a known or measurable emittance vector from a known location on the handheld controller 1120 and the point may be determined using a projected line and the measured distance. In parallel, a similar process may also be performed in a virtual space used to model the BIM and/or other information and so the directional beam may also be visually represented in the virtual space (e.g., as a cylinder with a set diameter that projects from a model of the handheld controller based on the set dimensions of the controller). In one case, a CAD model of the handheld controller may be used to create a virtual model of the controller (e.g., using the dimensions defined within the CAD model). The emittance vector and the determined distance are thus useable to determine a three-dimensional location of the point corresponding to the occupied portion of space relative to the known location on the handheld controller (e.g., the emitter 842 location), and the known location is in a known or measurable position within three-dimensional space relative to a position of the moveable device derived from the sensor data (e.g., maybe derived from the fixed transformation that relates the emitter 842 location to the IMU location that forms a reference point or origin for the handheld controller 1120).

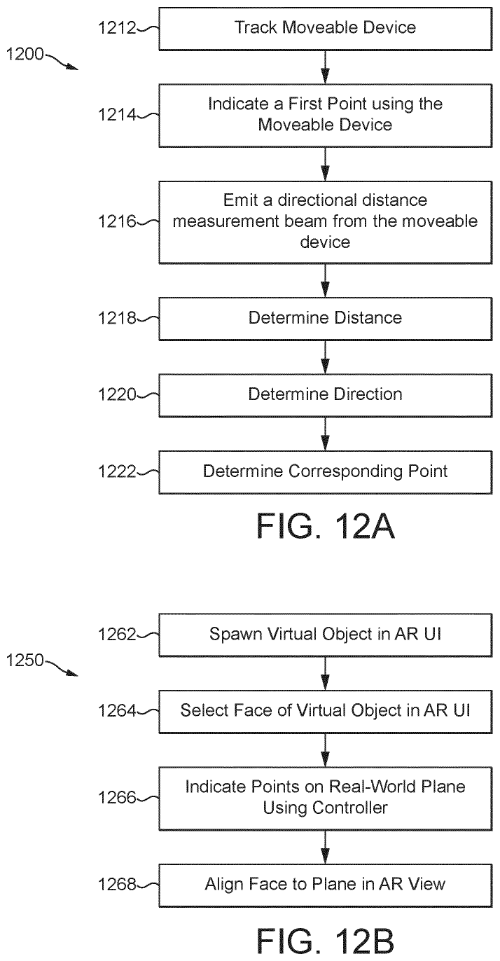

FIG. 11 thus shows an example of a method, where the method may be used to implement a man-machine interface for an augmented reality application. This method is set out in more detail in the flow diagram 1200 of FIG. 12A.

At step 1212 of FIG. 12A, the method comprises tracking a position and orientation of a moveable device within a construction site. This may comprise tracking a pose of the handheld controller 1120 using the photo sensors 812 in FIGS. 8A to 8D and the positional tracking system shown in FIG. 1A. As explained above, the pose of the handheld controller may comprise a six degrees of freedom vector specifying a location of a known reference point on the handheld controller (e.g., a defined IMU location) within a coordinate system of the positional tracking system and an orientation with respect to axes of the coordinate system. The pose may be defined as described earlier in this document. At step 1214, the user indicates a first point with the moveable device. In the case that the moveable device comprises the handheld controller 1120, this may comprise pointing the handheld controller 1120 towards an object of interest. The object of interest may be in the real world (e.g., may be a point on wall 1130) or may be a virtual object that is visible to the user via an augmented reality display of a head mounted display, such as that provided by hard hat 1110. In the former case, the handheld controller 1120 may comprise a laser pointer and emit a laser beam with a visible point (this may be the laser beam used for the directional distance measurement or a separate visible beam to complement an invisible distance measurement beam, such as an infra-red laser beam for distance measurement). The visible point may be displayed on objects in the real world (e.g., as a red light point) and when the visible point coincides with an object the user wishes to interact with, the user can indicate this via a user input device of the moveable device (such as trigger button 816 in FIG. 8C). The moveable device may thus comprise a laser pointer as well as an electronic distance measurement device or the laser pointer may form part of the electronic distance measurement device. If the user is viewing a virtual object, the augmented reality display may show a virtual line projected from a virtual model of the moveable device that stops when the virtual line intersects another virtual object within the virtual space (e.g., the user may indicate towards the virtual representation of window 1140 in FIG. 11 even if this has not been built yet within the wall 1130). The method described herein is flexible and may be used in either context (e.g., to map from real world points to virtual points or vice versa).

At step 1216, a directional distance measurement beam is emitted from the moveable device in the direction of the indicated first point. For example, in FIG. 11, the indicated point is 1132 and the directional distance measurement beam is shown as 1122. The directional distance measurement beam may be emitted when the trigger button 816 is pressed. At step 1218, a distance is determined to an occupied portion of space within the construction site using the directional distance measurement beam. For example, when using a directional distance measurement device, a laser or ultrasound beam may be emitted that passes through empty space until it meets a surface in the real world, whereby that surface reflects the beam (e.g., as shown by 1124 in FIG. 11) towards the moveable device. The reflected beam is then received by the moveable device (e.g., at receiver 844 in FIG. 8D) and a distance is determined using known methods that compare the emitted and received directional distance measurement beam (e.g., using time of flight and/or phase differences). If the user is indicating towards a virtual object as shown on the augmented reality display (e.g., of hard hat 1110) then the emitted directional distance measurement beam will not be reflected by virtual objects but only by corresponding real surfaces in the real world. This may be used during inspection, e.g. if a user indicates as a pipe fitting in a virtual space, a virtual distance may be determined by ray tracing within the virtual space from the modelled handheld controller to the virtual object. This may then be compared with an actual measured distance as determined by the reflection of the directional distance measurement beam from a corresponding real-world object (e.g., a pipe fitting as installed in the construction site). A mismatch between the virtual distance and the real-world measured distance indicates a discrepancy between the virtual model (e.g., the BIM) and the built environment.

At step 1220, a direction of the directional distance measurement beam is determined. As described above, this may comprise using the pose of the handheld controller 1120 and a fixed transformation (e.g., 4×4 matrix) derived from a CAD specification of the controller to determine a location of emittance (i.e., a modelled emittance, where there may be small differences between an actual emitted location depending on the configuration of the distance measurement device) and an orientation of emittance. For example, a pose of a modelled beam emittance location on the handheld controller 1120 may be computed (e.g., by applying the fixed transformation to the tracked reference point on the handheld controller 1120). Hence, at step 1222, the position and orientation of the moveable device, together with the direction of the distance measurement beam and the distance to the occupied portion of space, may be used to determine a location of a second point corresponding to the first point.

If the first point is a point in the real-world (e.g., a point 1132 on the physical wall 1130), then in a virtual world a virtual point corresponding to the real-world point may be determined. This may be achieved using a model of the moveable device in the virtual world (e.g., a coordinate system of the positional tracking system). The tracked pose of the moveable device in the virtual world is known via the positional tracking system and, as per step 1220, a pose of a modelled emittance location is also known. In the virtual world, a ray may be traced from the modelled emittance location, e.g. along a normal of the modelled emitter 842 surface, and continued for a distance equal to the measured distance at step 1218. A point at the end of this ray at the measured distance is thus determined, which is a virtual point (e.g., a point in a virtual coordinate system such as the positional tracking system coordinate system) that corresponds to the indicated real-world point. The virtual point may be further mapped between virtual coordinate systems, e.g. may be mapped to a coordinate system of the BIM using a calibrated transformation that maps the positional tracking system coordinate system to the BIM. Thus, a BIM location may be determined for a real-world point.

If the first point is a point in the virtual world, then a real-world point corresponding to the virtual point may be determined. For example, within the augmented reality display, a virtual line may be traced from the modelled emittance location of the moveable device (e.g., resembling 1122 but only visible via the augmented reality display) until it intersects an occupied portion of virtual space (e.g., a surface or object within the virtual space-such as a BIM object that has been mapped to the positional tracking coordinate system for display). This provides the first point as a virtual point location. Using the calibrated transformation described previously, the virtual point location may be mapped to a corresponding point in the BIM coordinate system, which may be a real-world coordinate system (e.g., representing geodetic or geocentric coordinates). Now, at step 1222, the measured distance to a corresponding real-world point with the same pose of the moveable device is also known. Hence, the position of an object or surface in the real-world along the same traced ray can also be determined. For example, the pose of the handheld controller 1120 in the BIM coordinate system represents a real-world location of the handheld controller 1120. This may be obtained using the calibrated transformation. The measured distance may be added to this (e.g., via populated transformations) to get a real-world position that corresponds the originally indicate virtual point. If the real-world surface or object is correctly modelled in the virtual world, then a mapping of the real-world point back into the virtual space (e.g., using the calibration transformation to go from the BIM coordinate system to the positional tracking coordinate system) should provide the original indicated virtual point. However, if there is a mismatch between the virtual model and the real-world, a second virtual point mapped from the real-world point may differ from a first indicated virtual point. This difference may be noted (e.g., in the BIM) as one or more of the model (e.g., the BIM) and the real-world construction may need adjusting. The method may thus be used as part of a site inspection to check whether virtual models of planned construction elements match with their real-world constructed equivalents. As a user may point at any object in the real world or in the virtual world, this provides a flexible and powerful way to quickly check that a build matches the designed specification.

As described above, in one case the virtual space is populated using data from a building information model (BIM). The BIM is defined with respect to a model coordinate system that may comprise a geodetic or geocentric coordinate system. In this case, the tracking at step 1212 is performed within a tracking coordinate system. This may comprise the positional tracking system shown in FIG. 1A or a coordinate system for a different tracking system, e.g. a SLAM system. The directional distance measurement beam is emitted from the moveable device and reflected by the occupied portion of space (e.g., as shown in FIG. 11). A reflection of the directional distance measurement beam is detected by the moveable device. In these cases, the distance to the occupied portion of space and the direction of the directional distance measurement beam are determined within the tracking coordinate system. For example, the direction of the directional distance measurement beam may be known by way of a measured or determined pose of a modelled emittance location (e.g., as determined via a tracked device position plus a fixed transformation). The modelled emittance location may be a predefined location on the handheld controller reflecting a point where the directional distance measurement beam is emitted. The measured distance may then be used to project a line of that length from the modelled emittance location (e.g., as a beam is projected perpendicular, or at a set angle to, a fixed surface such as the face of the emitter 842). The location of the real-world point within the construction site is thus determined within the tracking coordinate system (e.g., as modelled emittance location plus projected line of measured distance length).

In certain examples, a correspondence between the tracking coordinate system and the model coordinate system is determined using a calibrated transformation, the calibrated transformation mapping points between the coordinate systems. The calibrated transformation may be determined by measuring the locations of surveyed control points with the handheld controller, to thus obtain pairs of points—(tracking coordinate system point, model coordinate system point)—where a plurality of these points may be compared to derive the calibrated transformation (e.g., via least squares and/or optimisation).

As discussed with respect to the method of FIG. 12A, the virtual point may comprise a point on a surface or object defined as part of the building information model. In this case, the method comprises mapping between the tracking coordinate system and the model coordinate system using the calibrated transformation to determine corresponding locations of the virtual point and the real-world point in a common coordinate system and determining any difference between the corresponding locations of the indicated virtual point and the real-world point in the common coordinate system. As may be understood, if forward and inverse calibrated transformations are obtained, a comparison may be made either in the tracking coordinate system or in the model coordinate system (the latter also possibly being a real-world coordinate system) as long as points are mapped to the coordinate system where the comparison is to be made.

In one case, the method may comprise indicating a difference between the corresponding locations of the virtual point and the real-world point in the common coordinate system in the virtual space viewed by the user. For example, both points may be mapped to the tracking coordinate system and displayed in a two-dimensional projection that is used to generate an augmented reality image for display. If the user points the handheld controller 1120 at the physical wall 1130 and measures a real-world point 1132 on the wall, the location of real-world point 1132 in the real-world may be determined by using a pose of the handheld controller 1120 as mapped to the model (e.g., BIM) coordinate system and ray tracing the measured distance 1126. If this point as represented in the model coordinate system differs from a model of the wall as also represented in the model coordinate system (e.g., if the measured point is several centimetres in front of, or behind the modelled surface of the wall in the BIM) then there is a mismatch (i.e., difference) between the BIM and the construction site. If the user wishes to view the mismatch, both the real-world point and the modelled wall in the model coordinate system may be mapped to the tracking coordinate system and displayed within an augmented reality image. Similarly, if a user points at the model of the wall as viewed in the augmented reality image, a virtual point on this model of the wall in the tracking coordinate system may be determined by the method of FIG. 12A. A virtual point corresponding to the measured distance 1126 may also be shown and the two may be compared in the tracking coordinate system, where any difference may be highlighted in the augmented reality interface.

In certain cases, if such a difference is deemed to exist between the model and the measured real-world, then the user may instruct, e.g. via the augmented reality user interface, that the model is to be updated to reflect the measured reality. This may comprise receiving an instruction from the user to match the virtual point to the real-world point in the common coordinate system, e.g. receiving an instruction to match a point on the model of the wall to the measured real-world point location as represented in the common coordinate system. In certain cases, “matching” the points may comprise updating a location of the surface or object within the BIM.

In cases such as the example of FIG. 11, the moveable device comprises a handheld portable construction tool. In these cases, the indicating of step 1214 may comprise pointing a virtual representation of the handheld portable construction tool towards a virtual point of interest, ray-tracing from a predefined location (e.g., a modelled emittance location) on the virtual representation of the handheld portable construction tool to a virtual surface or object within the virtual space, and determining a location where a ray from the ray-tracing intersects the virtual surface or object, said location being presented as the location of the indicated virtual point. This then indicates a virtual point that may be compared to a measured real-world point.

In alternative examples, the moveable device may be worn by the user and comprises the head mounted display. For example, the moveable device may comprise the hard hat 1110. In this alternative example, the indicating of step 1214 may comprise pointing a virtual representation of one or more body parts of the user towards a point of interest. For example, using hand-tracking and/or other gesture recognition libraries, the camera assembly 230 as shown in FIG. 2A may be used to determine a location of one or more of the user's arm, hand, and fingers within the tracking coordinate system. In this case, the user may point at a point of interest as an alternative to using the handheld controller 1120. This approach may be used as well as or instead of the handheld controller. However, the methods of determining and comparing points may be similar. For example, the method may comprise ray-tracing from a location defined in relation to the virtual representation of the one or more body parts of the user to a virtual surface within the virtual space. This may involve determining a location of an axis of the user's pointing finger and ray tracing a line from the tip of the finger along the axis. Again, a location may be determined where a ray from the ray-tracing intersects the virtual surface, said location being presented as the location of the indicated virtual point. In this case, an electronic distance measurement device may be mounted within the camera assembly 230 and used to determine a corresponding real-world measured distance. This may be used where the user indicates at a particular virtual plane with their finger and the distance to a corresponding real-world plane is measured from the head mounted display. In this case, the indication of a virtual point may not need an accurate pointing device as a ray may be traced and a first object that intersects that ray determined in the virtual space. In this case, a positional tracking system may comprise a SLAM system that uses image data from the camera assembly 230 to determine a distance to the real-world surface (e.g., the real wall in the construction site). In this case, a model of the wall and the real measured location of the wall may again be compared.

In certain cases, a position and/or orientation of one or more of the handheld controller and the modelled emittance location may be determined as a statistical metric of a number of measurements. For example, the position of the handheld controller may be sampled to determine a mean position value. This may be also performed with the distance measurement, e.g. a number of distance measurements over a short time period (e.g., milliseconds) may be averaged and the average distance used in future computations. Also short-term tracking information from one or more IMUs may be used to determine one or more of position and/or orientation (e.g., via a fused output measurement). These approaches may help accuracy and reduce outlying measurements, e.g. caused by measurement or human factors. For example, over 100-200 ms the user's hand may move a certain amount and so computing and using a mean pose and distance may improve accuracy.

In certain cases, the directional distance measurement beam is emitted from a defined location on the moveable device and the direction of the directional distance measurement beam is determined based on the orientation of the moveable device. For example, the defined location may be set based on design measurements of the device (e.g., CAD drawings). The direction may be the orientation of an axis of the moveable device, if the emitter is arranged parallel to this axis (and so the directional distance measurement beam is also emitted in parallel to the axis). For example, the axis may comprise an axis aligned with the top surface of the handheld controller 805 and the upper single prong shown in FIG. 8A.

In certain cases, the directional distance measurement beam may be emitted from a defined location on the moveable device with a configurable directionality. These cases may differ from the handheld controller 805 as illustrated in FIGS. 8A to 8D. For example, an electronic distance measurement device may have an emitter-receiver assembly that is moveable (as compared to the emitter-receiver assembly shown in FIG. 8D, which is fixed with reference to the handheld controller body). In these cases of a moveable emitter-receiver assembly, determining the direction of the directional distance measurement beam comprises measuring the configurable directionality at the time of emission. For example, a moveable emitter-receiver assembly may be mounted within a gimbal that comprises electronic sensors to measure the orientation of the assembly within the gimbal.

In certain cases, the position and orientation of the moveable device are provided as a six degrees of freedom—6FOD—pose within a tracking coordinate system. In these cases, the distance to the occupied portion of space and the direction of the directional distance measurement beam are used to determine a transformation within the tracking coordinate system that defines the location of the real-world point within the tracking coordinate system. For example, this may be a transformation with respect to a reference point or origin of the moveable device where the rotation terms are based on the orientation of the moveable device and the translation terms are based on the position of the moveable device and the measured distance.

In the case that the first point comprises a virtual point, the method may comprise using the position and orientation of the moveable device, together with the direction of the distance measurement beam and the distance to the occupied portion of space, to determine a location of a corresponding real-world point for the virtual point. For example, if the user is indicating at a virtual object such as a model of a wall or column, then the real-world measured distance from the tracked moveable device along a ray representing the emitted directional distance measurement beam may be used to determine a location within the model coordinate system that represents the real-world. In this case, the method may further comprise mapping the real-world point back into the virtual space using a calibrated transformation between a coordinate system for the virtual space (e.g., the BIM coordinate system) and a coordinate system for tracking in the real-world space (e.g., the tracking coordinate system). The locations of the mapped real-world point in the virtual space and the originally indicated virtual point may then be shown, including indicating any differences between the mapped real-world point and the virtual point.

In the case that the first point comprises a real-world point, the method may comprise indicating the first point by pointing the moveable device towards the first point within the construction site. In this case, determining the location of the corresponding second point may comprise determining a location of the first point in a coordinate system used for tracking the moveable device within the construction site; mapping the location of the first point to the virtual space to determine the location of the corresponding second point, the corresponding second point comprising a virtual point within the virtual space; and indicating to the user, via the head mounted display, the location of the corresponding second point within the virtual space.

In examples described herein, the computation for mapping between spaces and/or performing the method may be performed on a single device or on a distributed system of devices. In one case, the handheld controller 1120 may comprise a compute module (e.g., at least one processor and memory) to perform computation within the controller. In one case, the handheld controller 1120 is configured to wirelessly exchange data with the hard hat 1110. In one case, a tracking computer server communicates with both the hard hat 1110 and the handheld controller 1120 to determine their location and orientation based on sensor data. In other cases, tracking may be performed within the integrated electronic subsystem of the hard hat 1110. In general, computation may be distributed between devices depending on the system configuration. For example, for standalone use of a kit of components comprising tracking beacons, a hard hat, and a handheld controller, computation may be performed within the integrated electronic subsystem 260 as described with reference to FIGS. 2A to 2H (amongst others). Although the example of FIG. 11 is presented with reference to simple objects such as walls, the real-world and modelled objects may take a variety of forms (e.g., the user can point at any object in the real-world and indicate at any object defined in, and loaded from, the BIM). For example, objects may comprise steel beams, columns, foundations, piping, cabling, HVAC (heating, ventilation, and air conditioning) units, windows, openings, doors, plumbing etc.

FIG. 12B is a flow diagram 1250 showing another method in which a moveable device, such as the handheld controller described herein, may be used to interact with an augmented reality system. The method of FIG. 12B is an example method of aligning a virtual object with a real-world location. At step 1262, a virtual object is obtained within the augmented reality user interface (e.g., as viewed by a wearer of the hard hat 1110). This may comprise spawning (i.e., generating) a virtual object from a list of defined virtual objects. For example, a BIM may have a number of defined objects or assets that represent components of the build. The user may use a graphical user interface (GUI) displayed within the augmented reality view to obtain the virtual object. The virtual object may comprise a pre-existing object within a model of a proposed construction project (e.g., a model of a wall to be built) that is selected from a list of pre-existing objects or a new object that is generated from a selected object template. In one case, the virtual object may not represent a real-world object but may comprise a form of virtual annotation.

At step 1264, the user selects a surface of the virtual object that is obtained at step 1262. For example, if the virtual object comprises a cuboid object a face of the cuboid object may be selected. Selection may be performed using the handheld controller 1120 to point at the surface within the virtual space (e.g., using the ray tracing approaches discussed above). At step 1266, the user uses the moveable device to indicate a set of real-world points (e.g., using a method similar to that described above with reference to one or more of FIGS. 11 and 12A). The locations of virtual points corresponding to the plurality of real-world points are then determined. For example, in the virtual object is being manipulated within the tracking coordinate system then the virtual equivalents of the measured real-world points (using the electronic distance measurement device) may be determined in the tracking coordinate system (e.g., by either computing the location in the tracking coordinate system using the obtained sensor data and/or by mapping from computed positions within a model coordinate system to the tracking coordinate system using the calibrated transformation). If three or more points are indicated, then a plane may be identified within the virtual space. At step 1268, the selected surface of the virtual object is then aligned with the measured real-world points, as represented within the virtual space (e.g., the tracking coordinate system). The aligned virtual object may be shown to the user in the augmented reality display. Effectively, the method generates a representation of the real-world surface using the measured points and then uses this representation to align virtual objects.

In certain variations of this method, only one measured real-world point may be needed. For example, the user may indicate a real-world point on a wall or other surface and a reference virtual object representing that wall or surface may be identified in the BIM. If the measured real-world point matches the reference virtual object in the BIM (e.g., as then mapped to the tracking coordinate system) then the selected face of the obtained virtual object may be mapped to the surface of the pre-existing reference virtual object. The reference virtual object and/or the plane generated from a plurality of measured points may or may not be displayed. If it is not displayed, when a user views the augmented reality image, the obtained virtual object will appear to be aligned with the real-world surface or object. The method may thus be used to perform a “click-to-fit” alignment of virtual objects with corresponding virtual and/or real world objects.

FIG. 13 shows an example 1300 of the method of FIG. 12B being performed, using similar schematics and components to those shown in FIG. 11. To the left of the Figure, a user moves the handheld controller 1120 to spawn a virtual object 1310 and then selects a face 1312 of the virtual object. The dashed line in this first step shows that rays are traced in a virtual world, but the electronic distance measurement device is not used to emit a distance measurement beam in the real-world. The left of the Figure thus reflects steps 1262 and 1264 of FIG. 12B. Following this, moving to the right in the Figure as indicated by the arrow, the user then uses the handheld controller 1324 to indicate three points 1322 on surface 1320, which may comprise a wall or partition within the construction site. In this case, the electronic distance measurement device is used as may be seen by distance measurement beam 1324, which is used to determine a real-world distance of each point 1322 from a tracked position of the handheld controller 1120. The user may use a visible laser beam to indicate each point on the surface 1320, then click the trigger button 816 as shown in FIG. 8C, to measure the distance to each point. The set of three points are then mapped into the coordinate system that is used to display the virtual object 1310 within the augmented reality display on hard hat 1110, which in this case is the tracking coordinate system. In cases where the virtual object is being viewed outside of the hard hat 1110 (e.g., on a remote computer display or mobile device touchscreen) then the coordinate system may be the model (e.g., BIM) coordinate system (as this may not be oriented with the view of the hard hat 1110). In at least one of the coordinate systems, a plane 1326 comprising the three points 1322 is determined (e.g., via known plane fitting algorithms). The selected face 1312 is then aligned with the plane 1326 (e.g., if they are both defined, and/or mapped to, a common coordinate system, such as the tracking coordinate system for display in the hard hat 1110. The far right of FIG. 13 shows the aligned virtual object 1330 with the selected face 1312 configured to reside in the plane 1326. To the user, the virtual object 1330 thus appears to be “clipped to” the real-world surface 1320. In one case, in an “align” mode, the virtual object 1310 may be automatically aligned with the plane 1326 as the third point 1322 is indicated in the set. The method may generally comprise obtaining a virtual object within the virtual space, using the moveable device to indicate a plurality of real-world points, determining the location of virtual points corresponding to the plurality of real-world points, and aligning the virtual object within the virtual space based on the location of the virtual points. As shown in FIG. 13, in certain cases this may specifically comprise selecting a face of the virtual object, using the virtual points to define a plane within the virtual space, and aligning the face of the virtual object with the plane in the virtual space.

In one case, a variation of the above methods may comprise mapping a set of virtual points as indicated on a virtual object in the augmented reality view to a set of real-world points as measured by the handheld controller 1120. For example, the user may indicate a series of corners forming part of an object in the virtual space as viewed by the user. For example, a user may point at the visible corners of a virtual cuboid object such as a virtual air conditioning unit as viewed in the augmented reality display. During this procedure the corresponding real-world points as determined along a distance measurement beam emitted from the handheld controller may be determined from the measured distance as described above. The user may then have the option to update the model location of the corners to the real-world point locations as measured. The BIM may then be updated such that the location of the virtual air conditioning unit matches the location of its corresponding real-world counterpart. Similarly, the user may approach this task from a view of the real-world. For example, they may use the handheld controller 1120 to point to the visible corners of an installed real-world air conditioning unit. The user may then have the option to update the model such that the indicated virtual corners of the virtual air conditioning unit match the real-world measured corners.

In general, methods as described herein may be used to align virtual objects to physical objects. In certain cases, if the virtual object is a defined shape and/or is constrained to a particular orientation, one or more points may be used to align the virtual object with the real-world. For example, the virtual point in the methods above may comprise a location in the virtual space that is defined with reference to a virtual object, wherein correspondence between the real-world point and the virtual point is used to position the virtual object in relation to the real-world point. This approach may be used, for example, to set a cub parallel to a wall in a construction site or to place a cube at a corner of a wall. In certain cases, first and second points of the described examples are used to align a virtual object in the virtual space with a physical location within the construction site.

In another example, the user may use the handheld controller to define a work area. The work area may be used to filter objects to be displayed in an augmented reality view (e.g., only parts of the BIM that are in the work area may be retrieved and rendered as part of the augmented reality view). In this example, the user may define a work area in a similar manner to indicating points 1322, e.g. the user may select a number of corners of a polygon on the floor (e.g. four for a square or rectangular area) and a volume of a predefined height may then be defined as a work area. In an extension of this, a user may alternatively select points that are used to define at least a height, width, and length of a work area. The work area may be used to set a rendering distance for a virtual space that is displayed within the head mounted display (e.g., within hard hat 1110). This can help conserve power and/or simplify the augmented reality view by avoiding the unnecessary rendering of virtual objects outside of the work area.

In one example, the methods described herein may be used to set a size of a virtual object. The user indicates a first real-world point within the construction site to be mapped to a first size reference point in the virtual space. The user then indicates a second real-world point that is to be mapped to a second size reference point in the virtual space. For example, the two real-world points may be opposite corners of a planar face of an object or different points on the object. As the real-world point locations are measurable using the above methods, the distance between the points can be accurately determined and used to set a size of a virtual object within the virtual space.

In general, the approaches described with reference to the examples of FIGS. 11 to 13 allow the positioning of virtual objects in a physical space with a handheld distance laser. Certain examples allow users to position and align virtual objects accurately in 3D space with the use of the handheld distance laser. The laser is used to get a better understanding of the 3D world and the distances of objects in the 3D world. According to those measurements, virtual objects can be positioned and aligned in the 3D world. Measurement data from the distance measurement device may be passed to a digital processing system, such as the compute module formed by the integrated electronic subsystem described herein, for use in the visualization of digital data. This provides a more accurate and efficient way to work with virtual objects in a 3D world. Users can quickly and easily provide input to accurately define, and/or interact with, virtual 3D objects. Virtual objects can then be “snapped” or “clipped” (i.e., aligned) to the actual physical space.

Additionally, the approaches described with reference to the examples of FIGS. 11 to 13 may be used to approve site inspections and reviews. For example, in a similar manner to collaborative software coding tools, “issues” may be defined and associated with specific objects in the real-world of the construction site. For example, if a beam is misaligned, the user can identify a real-world point on the beam using the handheld controller and associate that coordinate with a log of the problem within an accompanying construction management software tool. The user is able to add annotations to either the real-world point or a virtual object corresponding to the real-world point or both. Users operating computing devices on or away from the site may then view a location associated with the issues and/or a given BIM element and arrange a fix.

In certain cases, the approaches described with reference to the examples of FIGS. 11 to 13 may be used without an electronic distance measurement device. For example, instead of a using the electronic distance measurement device to measure a distance to a remote point, a point on the handheld controller or a user's body may be used to interact with a BIM model. For example, the upper single prong on the three-pronged nose 830 may be used as a pointing implement. The user may use the upper single prong to touch objects within a surrounding environment and determine both tracking space locations and corresponding BIM locations (the latter in turn possibly representing geodetic or geocentric “real-world” coordinates). Conversion between a position as determined in a tracking coordinate space (e.g., based on a tracked pose of the handheld controller in said tracking coordinate space) and a BIM or “real-world” position may be performed using a calibrated transformation as described. The location of a particular point on the controller, such as the upper single prong, may be determined in a similar manner to the modelled emittance location, e.g. be performed using a known predefined transformation with respect to a tracked origin of the handheld controller. A user may use the upper single prong to “touch” both virtual objects as seen overlaid on the display panels of the hard hat and real-world objects as seen through the display panels. The point of touch may then be determined in one or more of the tracking coordinate space and the BIM coordinate space to allow interaction with virtual objects derived from BIM data. For example, the user may touch a real world point and a set of virtual objects representing features to be installed at that point may be displayed in the virtual space. Or a user may “touch” a visible object as viewed in the display panels of the hard hat and then be informed of the real-world location of that object (e.g., within a user interface for the augmented reality view). A user may also use a point on the handheld controller to “draw” within the BIM model space, e.g. a series of tracked points in the tracking coordinate space may be converted into a series of points in a geodetic BIM model space, which may then constitute an “annotation” within the BIM model.

### Example Bim Data Processing

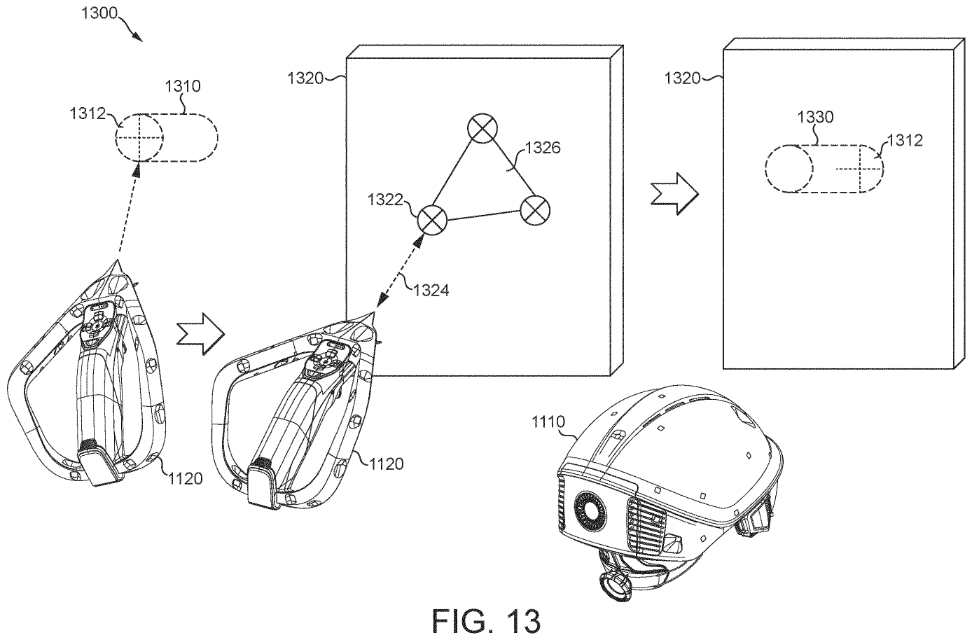

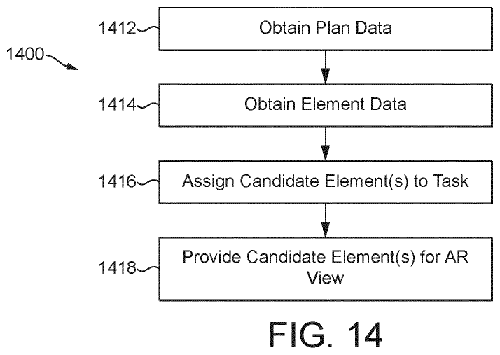

FIG. 14 is a flow diagram 1400 showing an example method of preparing three-dimensional—3D—building information model—BIM—data for use in an augmented reality application. For example, the method may be applied to aid the display of portions of the BIM within an augmented reality view on the display panels 222 of the hard hat 210 as shown in FIG. 2D (as well as the other described examples). In general, the method provides a way to filter or select 3D elements that are rendered as part of the BIM model displayed to the user in the augmented reality view. A BIM model often has hundreds if not thousands of 3D elements that are defined as part of a construction job. Rendering all of these elements would be inefficient. Similarly, loading all the 3D elements of the BIM into volatile and/or non-volatile memory of the integrated electronic subsystem of the hard hat (e.g., 260) would require overly large memories and take a long time. However, manually selecting different 3D elements to include in an augmented reality view for a particular site inspection is also time consuming. It is thus desired to provide a method that improves the management of 3D elements that are included in the BIM to help increase the efficiency of an augmented reality system providing an augmented reality application.

In construction, a BIM is a digital representation of the physical and functional characteristics of a building. It serves as a shared knowledge resource for all operators involved in the building's lifecycle, from design to construction and facility management. As such a BIM may have thousands or even hundreds of thousands of model components or elements, of varying types and categories. Some example groupings of BIM elements include architectural components, structural components, mechanical components, electrical components, civil and site components, and interior furniture and finishings. A short description of these components is set out below.

Architectural components shape the building's overall design and layout. These components include walls, doors, windows, and partitions that define the structure's boundaries and spaces. Floors, ceilings, and roofs are elements that create horizontal planes and enclose the building, while staircases and ramps facilitate vertical circulation. Columns and beams are elements that provide structural support, while room and space definitions are also provided. Elements covering exterior features, such as facades, balconies, and landscaping elements, define the building's aesthetics and overall visual appeal.

Structural components ensure the stability and integrity of a building. In a BIM, these elements include foundation systems, such as footings, piles, and grade beams, which transfer loads from the structure to the ground. Structural columns, beams, and joists are further elements that provide support and transfer loads between building elements. Reinforcement bars and pre-stressed elements enhance the strength and durability of concrete structures. Trusses, bracing, and moment frames are elements that resist lateral forces, and slabs, decks, and floor systems are elements that form horizontal surfaces that bear loads and provide usable spaces.

Mechanical components in a BIM can form part of operating devices that provide comfortable and functional indoor environments. Elements include those relating to HVAC systems, including air handling units, ducts, vents, and diffusers. Elements forming part of plumbing systems are also defined to ensure the proper distribution of water and the removal of waste. These elements include pipes, fixtures, valves, and fittings. Elements forming part of fire protection systems, such as sprinklers, pumps, and fire dampers, are defined for use in safeguarding the building and its occupants in the event of an emergency.

Electrical components in a BIM are responsible for providing power, lighting, and communication capabilities within a building. These elements include lighting fixtures, switches, and receptacles, as well as electrical panels, circuit breakers, and transformers for power distribution. Wiring, conduits, and cable trays are defined to carry electrical currents throughout the building. Elements relating to communication and data systems, such as network cabling, access points, and intercoms, are also defined to enable connectivity and information sharing. Elements may also form part of security systems, including surveillance cameras and access control devices, that help ensure the safety and protection of building occupants.

Civil and site components in a BIM address the building's surroundings and infrastructure, contributing to the overall functionality and sustainability of the building. These elements include site boundaries, topography, and contours, which define the land and terrain features. Elements may also comprise roads, pavements, and parking facilities. Elements relating to utilities infrastructure may be defined such as piping and couplings for water, sewer, and power, and elements relating to drainage systems may also be provided.

Interior design and furniture components in a BIM may be the last to be provided in a construction project. These elements include furniture and equipment, such as desks, chairs, and cabinets as well as definitions for interior finishes, including paint, flooring, and ceiling materials.

As may be understood from these examples, a BIM may include a multitude of 3D elements for display in an augmented reality view. The data representing these 3D elements may run to many gigabytes. However, not all of this data needs to be displayed on an augmented reality display during different stages of a construction project.

A construction project may have data defining an activity-based construction plan. An activity-based construction plan is a method of organizing and scheduling construction projects by breaking down the overall project into individual activities or tasks. This approach focuses on identifying, sequencing, and allocating resources to each activity to ensure timely completion and efficient use of resources. Typically, data defining an activity-based construction plan is prepared manually by a project manager or a team of managers. The data may comprise one or more of: a list of tasks to complete the project, such as site preparation, excavation, foundation work, steel reinforcement, concrete pouring, masonry, roofing, interior finishing, and landscaping; dependencies between tasks; durations for each task (e.g., in days, weeks, or months); start and finish dates; resource allocations such as identification of labour, equipment, and materials needed for each activity, including the quantity and type of resources, and their availability and cost; critical path data, indicating a sequence of activities with the longest total duration, which determines the minimum project completion time; milestones during the project; and feedback on progress including fields that are updated based on reports as the project progresses. The data defining an activity-based construction plan may be stored in a spreadsheet, in markup files, and/or in a database. For example, an activity-based construction plan may be prepared in software such as Primavera® from Oracle, Inc. (including the P6 Enterprise Project Portfolio Management application—which uses the “.xer” file format), Asta Powerproject from ProjectsAnalytics, Inc., or Microsoft Project from Microsoft, Inc (which uses the “.mpp” file format). An activity-based construction plan may be provided together with a BIM. In this case, 3D elements (e.g., assets and resources) may be manually assigned to different tasks as set out in the plan.

The method of FIG. 14 provides a way to automatically associate 3D elements of a BIM with different tasks defined in plan data for an activity-based construction plan. In the method, historical plan data is processed to learn associations between the plan data and element data defining 3D elements for the BIM. This approach uses a machine learning system. New plan data can thus be provided to the machine learning system to determine candidate 3D elements to assign to unseen tasks in the plan data. This provides a quick way of assigning 3D elements to different tasks. A user of the augmented reality application may then view a task-based augmented reality view to filter BIM elements that need to be rendered. Tasks may be selected for augmented reality views manually (e.g., via an augmented reality user interface or before the user wears the hard hat) and/or automatically (e.g., based on a current date and time and defined start and end times for the task).

The method of FIG. 14 begins with a step 1412 of obtaining plan data defining an activity-based construction plan. The activity-based construction plan comprises a plurality of tasks to be performed as part of a (current) construction project. The plan data may comprise one or more of spreadsheet data, markup language data, and database data. This step may comprise loading all or a portion of the plan data into memory. At step 1414, the method comprises obtaining element data representing a set of 3D elements that are defined within the BIM data. This step may comprise loading definitions for the set of 3D elements into memory. Each construction project may have a corresponding BIM (although multiple construction projects may also use a common BIM). Step 1414 may only load a portion of a complete definition into memory at one time, e.g. may comprise loading a name and pointer for each available element in the set, where the pointer indicates data for the element in local and/or remote non-volatile storage. The exact definition of the element data may depend on the specification of the BIM and the software used to create, define, and/or load the 3D elements. As such it may vary between different implementations; however, an import routine may be defined based on the specification of the BIM in any one particular application and/or frequently-used standardised BIM configurations.

FIG. 15A shows an example user interface 1500 where the user is viewing example 3D element data 1502 for a wall 1504. In this example, the 3D element data comprises: an element type; an element identifier; data defining the geometry of the element including coordinates of extent, height and thickness; data defining the material used; data defining properties of the material used; data defining structural properties; data defining a layered construction of the element; data defining an exterior and/or interior finish of the element; and associated data indicating a manufacturer (and in certain cases defining a product type and/or specification). For the augmented reality view at least the data defining the geometry of the element are used to render the element. In certain cases, an element may be placed in a particular location within the construction site for a particular project and/or project task. This placement information may also be present within the 3D element data. FIG. 15A shows a view of a set of underlying data fields, which may be represented in a machine-readable manner (e.g., as database fields, spreadsheet cells, and/or markup entries).

One or more of the plan data for the activity-based construction plan and the element data representing a set of 3D elements may comprise specific bespoke information related to the construction project in question. However, one or more of the plan data and the element data may reuse existing portions of data. For example, a set of 3D elements may be available for multiple construction projects (e.g., HVAC units, piping etc) but may also be specifically adapted for each project (e.g., a wall in a particular project may have a particular location and geometric parameters for each construction project). Often the plan data and the set of 3D elements have aspects that are unique to each construction project. In the present method, the plan data may relate to a specific plurality of tasks to be performed as part of an upcoming or ongoing construction project and the set of 3D elements may comprise one or more of a set of 3D elements that have been defined for the construction project and/or pre-existing 3D elements that are assignable to the construction project.

Returning to FIG. 14, at step 1416, at least one task related to the construction project as defined in the plan data is selected as a “given” tasks. In one case, the method may be performed prior to or during a given task. In another case, the method may be performed for all tasks prior to the construction project starting. At step 1416, a subset of the set of 3D elements in the element data obtained at step 1414 is assigned to the given task as a set of candidate elements. Candidate elements may comprise elements that are later confirmed by one or more of user selection and further processing. In one case, candidate elements may be selected for assignment automatically. In other cases, a user may confirm each candidate element or the set of candidate elements. The assignment process uses a machine learning system to process portions of the plan data associated with the given task and the element data and to match elements within the element data to the given task. Different approaches for performing the assignment are discussed in more detail below. In general, the assignment uses assignment data configured based on a training set of plan data with assigned 3D elements to tasks within the plan data. For example, the assignment data may comprise one or more of: a rule set; neural network weights (e.g., parameters); decision tree weights; and frequencies and/or probabilities (e.g., for Bayesian methods).

At step 1418, the candidate elements are provided for use in generating a task-specific augmented reality view of a construction site associated with the construction project, where the task-specific augmented reality view is associated with the given task. For example, the candidate elements may be reviewed and confirmed by a user prior to a site visit, e.g. using a computing device and display, and/or during the site visit when the user is wearing the hard hat of previous examples. In certain cases, only the candidate elements (or the confirmed candidate elements) may be loaded from the set of all element data for providing an augmented reality view of the construction site. This then means less data needs to be synchronised with the integrated electronic subsystem of previous examples to provide the augmented reality view.

FIG. 15B shows an example user interface 1508 that may be displayed as part of performing the method of FIG. 14. In one case, the user interface 1508 is displayed on a desktop computer or laptop prior to a site visit using one or more of the kit of augmented reality components as described herein. In another case, the user interface 1508 may form part of an augmented reality user interface that is displayed on the display panels of a user wearing the hard hat of previous examples. In FIG. 15B the user interface 1508 displays an “explorer” screen 1510 where the user may view at least a portion of an activity-based construction plan 1520 for a current construction project and 3D elements that have been assigned to each of a plurality of tasks. In FIG. 15B, the activity-based construction plan 1520 is shown as a table and the rows of the plan indicate individual tasks within the plan. The activity-based construction plan 1520 may show all or a subset of the tasks for the construction project and may be scrolled and/or filtered using known approaches. In the present example, each example task comprises: an identifier 1522; a task description 1524; a task start date 1526 (which may also include a time in certain examples); a task end date 1528 (which may also include a time in certain examples); and at least a link to a set of assigned 3D elements for the task 1530. The assigned 3D elements may comprise one or more of candidate elements assigned using the method of FIG. 14 that are not yet approved, approved candidate elements that have been confirmed by a user, and elements that have been assigned manually by a user. In the example, of FIG. 15B, three examples tasks are shown: “Foundations” (i.e., building a set of foundations); “Steel Beams” (i.e., placing and securing a set of steel beams for the structure of a building); and “Concrete” (i.e., pouring concrete to form structures within the building). As may be seen, tasks may have many associated 3D BIM elements. In one case, the “Elements” column 1530 may be initially unpopulated, and the user may select a row and activate a user interface function (e.g., via a click, touch, button press, or key press) to perform the method of FIG. 14 to assign candidate elements to the task identified in the row.

FIG. 15B also provides a preview of at least a subset of the elements assigned to each task. This preview may change as the user clicks on different rows of the activity-based construction plan to display elements associated with different tasks. In one case, the user may select multiple tasks at one time and show the elements associated with a group of selected tasks. In FIG. 15, a concrete floor 1540 is shown, together with piping 1542 and steel support columns 1544.

In certain implementations of the method of FIG. 14, providing the candidate elements comprises: displaying a list of the candidate elements to a user in association with the given task; receiving, from the user, a selection of confirmed candidate elements to use in the task-specific augmented reality view for the given task; and assigning the selection of confirmed candidate elements to the given task. Each candidate element may be confirmed and/or rejected individually and/or groups of candidate elements may be confirmed and/or rejected collectively. Data defining the selection of confirmed candidate elements and the given task may be used to configure the assignment data for further tasks, e.g. the confirmation and/or rejection of data may itself be used as part of the training data used to train the machine learning system.

For later use, the method may comprise viewing, via a head mounted display, an augmented reality view of the construction site; selecting the given task from the plurality of tasks using an augment reality user interface displayed within head mounted display; and populating the augmented reality view of the construction site with the confirmed candidate elements within a virtual layer of the augmented reality view. The head mounted display may comprise the display panels such as 222 of the hard hat 210 (and as shown in other Figures).

The assignment data may be configured based on one or more of an element name, an element type, and one or more element properties associated with the assigned 3D elements (e.g., one or more of the example data fields shown in FIG. 15A). In one case, element data for each 3D element is converted into a numeric vector form (e.g., a 256-2048 length vector of float values single or doubles) and plan data for each task is also converted into a numeric vector form (e.g., of the same or a different length). A similarity metric may then be used to compare a given task and a given 3D element. For example, a cosine similarity may be computed for any two given vectors (e.g., potential pairs of task data for a given task and element data for a given 3D element) to provide a normalised similarity measure between 0 and 1. A threshold may then be applied to select candidate elements as elements with a similarity measure above the threshold. The conversion into numeric vector form may be performed based on a trained neural network, e.g., two feed-forward neural networks may be provided that compute respective task and element embeddings. The neural networks that compute the embeddings may be trained to maximise the similarity metric for 3D elements that were assigned (and/or approved) for given tasks, e.g. the training data may comprise task data, element data, and a score of 0 and 1 or −1, 0, and 1 representing “ideal” similarity. The neural networks may then be trained on a loss that is computed as a different between the similarity computed during training and the “ideal” similarity. In one case, text values may be converted into initial numeric values based on a dictionary lookup (e.g., the element types for all element data may be parsed to generate a type lookup dictionary wherein each different type in the dictionary is assigned a number based on a hash and/or an index in the dictionary). Numeric values in the element or plan data may be carried through, normalised, and/or embedded based on values and/or ranges. In certain cases, a text description for one or more of the task data and the element data may be tokenised and converted into token number values (e.g., using known tokenisation methods). In one case, pretrained embeddings—such as FastText or BERT-based embeddings—may be used to convert words in data fields to a vector equivalent. In one case, associations may be based on term frequencies, e.g. using approaches such as Term Frequency—Inverse Document Frequency (TD-IDF), whereby the importance of terms used in one or more of the task data and the element data may be based on term frequencies as down-weighted based on their frequencies as used over the complete dataset. TD-IDF metrics may be computed for text data found in elements for different “corpuses” of task keywords.

In one case, the element data is converted into a numeric vector form and then clustering is applied in multi-dimensional space to determine if task-based clusters may be identified. In one case, 3D elements may be associated with specific zones, rooms, and/or areas that are defined explicitly or implicitly in the plan data. For example, a task having the description “Fit out data centre” may processed to extract noun phrases (“data centre”) and 3D elements that are assigned to that task in historical data may be counted. When a new task is received that has the same noun phrase (“data centre”), the frequencies may be processed and those above a particular normalised threshold selected for inclusion as candidate elements. In certain cases, BIM data for the 3D elements may be processed to determine hypernyms for part names, types, and other string tags. For example, a look-up service such as WordNet may be used and/or custom dictionaries may be defined. In this case, probability distributions may be constructed that represent the joint probability of task terms and element terms at different semantic levels. Instead of, or as well as, terms, n-gram probabilities may be computed based on descriptive string fields and used to determine correlations. In general, semantic and BIM information may be used to learn the associations.

The training procedure may comprise data preparation; model training; and inference phases. The past plan data and their assigned 3D elements may be combined into a single dataset. Feature extraction may be performed. For example, features based on one or more of task type, duration, materials, geometry, and structural properties may be extracted and represented in a consistent and comparable format. During model training a supervised learning algorithm may be selected (e.g., from the group of decision trees, random forests, support vector machines, or neural networks) and trained using the training dataset. A suitable model may be selected based on initial training results and evaluation. Model configurations and hyperparameters may be chosen in an iterative process based on training results. The trained model can then be applied to new plan data to predict suitable candidate 3D elements. For example, when training a decision tree, task-related features, such as task type, duration, and required materials, as well as 3D element features, such as geometry, material properties, and structural properties may be used as input attributes for the decision tree and the output may comprise a binary or probability value indicating assignment or likelihood of assignment. This may then be used to predict assignment probabilities for unseen task and element pairings.

In one case, assignment data may be configured based on the fact that certain types of industries and/or companies have repeated similarities in the layouts of buildings. Hence, often there are definable or learnable patterns that can enable prediction of 3D elements. For example, a type of industry (“technology infrastructure”, “water utility” or “domestic housing”) may be extracted from plan data and/or inferred as a classification performed on plan data (e.g., using a trained machine learning model). An association between the type of industry and a set of 3D elements that are commonly used (e.g., in the form of probabilities or normalised frequencies or a learnt association) may then be used to retrieve an initial candidate set of 3D elements. Similar, construction tasks within plan data may refer to a location (e.g., a room or site location). This location may be extracted and an association between the location and sets of 3D elements determined. Also, or alternatively, a type of object may be present within plan data. This may be extracted and used to map to particular 3D elements (e.g. a task may have a description “installation of sprinklers in Room E”—“sprinklers” may then be extracted as a parsed object type and mapped to 3D elements that represent sprinklers for return as a candidate set).

In one case, images and/or video from a construction site and/or a finished building may be used to determine association data. In one case, pictures taken during or following completion of a particular task may be processed to associate 3D elements with plan data for the task. For example, objects may be recognised within images and mapped to particular 3D elements to form an association. Images and/or video may be segmented and/or classified by neural network architectures. Images and/or video may be captured using the camera assembly 230 as shown in FIG. 2A and/or may be obtained from a data repository of historical site inspections where no 3D element data is available.

The method may comprise general steps of: receiving input data in the form of 3D element and plan data from the user; learning associations between the 3D elements and activities (i.e., tasks) based on semantic and BIM information such as element name, type, and other properties that are provided by the user; suggesting new pairings based on the learned associations (e.g., providing candidate elements); and reviewing and selectively confirming (or rejecting) suggested pairings of activity/task and element. The described examples provide several advantages over traditional methods for linking 3D elements to activity-based construction plans. For example, they automate the process, reducing the time and effort required to complete the assignment. Additionally, they leverage previous construction data, improving the accuracy and reliability of the associations between the 3D elements and activities. Finally, they provide a user-friendly interface for reviewing and confirming the suggested associations. The described examples address the issue that it can be a challenging and time-consuming process to link 3D elements to the activity-based construction plans, especially when there are a large number of elements involved.

In certain examples described herein, including those of FIGS. 11 to 17, functions and/or methods may be implemented by a processor (such as that forming part of the integrated electronic subsystem described herein or another electronic device) that is configured to load instructions stored within storage device into memory for execution. In use, the execution of instructions, such as machine code and/or compiled computer program code, by one or more of processors implement the functions and/or methods described herein. Although the present examples are presented based on certain local processing, it will be understood that functionality may be distributed over a set of local and remote devices in other implementations, for example, by way of network interfaces. Computer program code may be prepared in one or more known languages including bespoke machine or microprocessor code, C, C++ and Python.

### Example Model Alignment Method

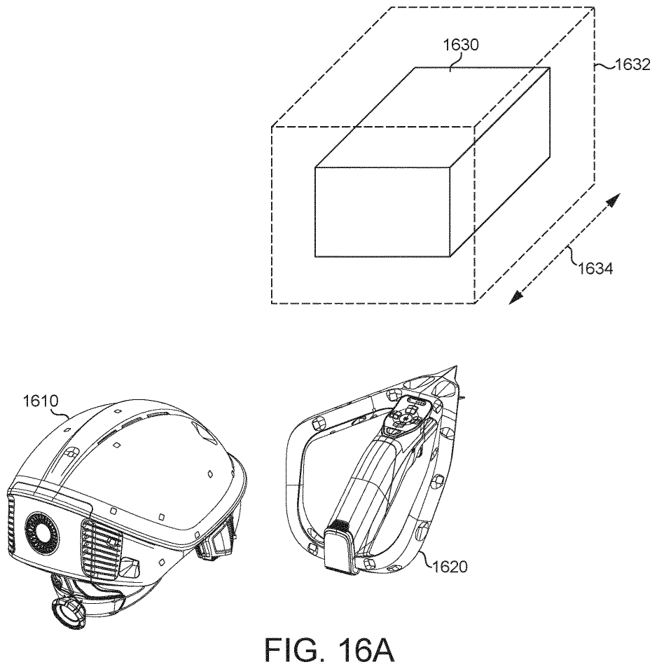

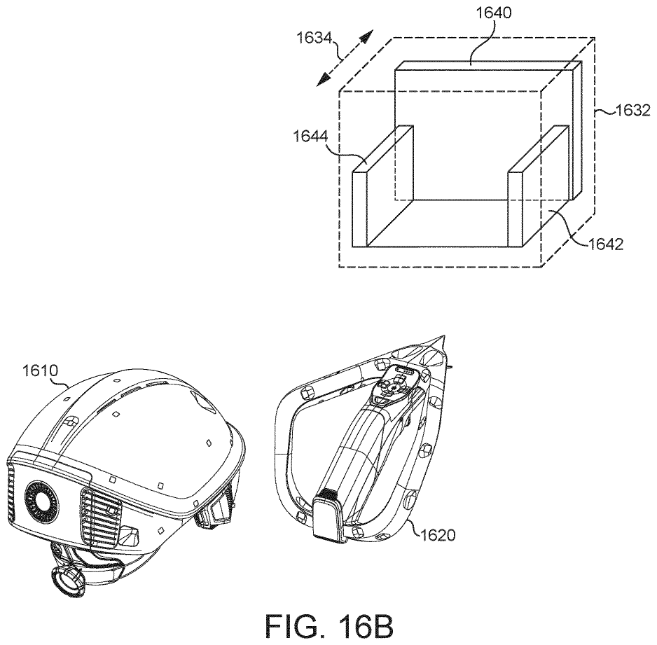

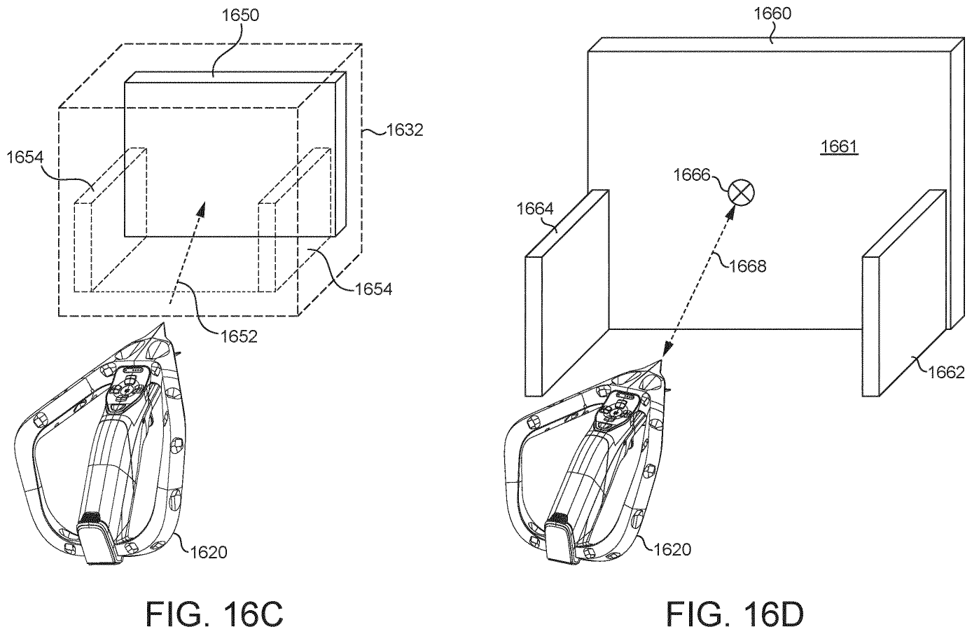

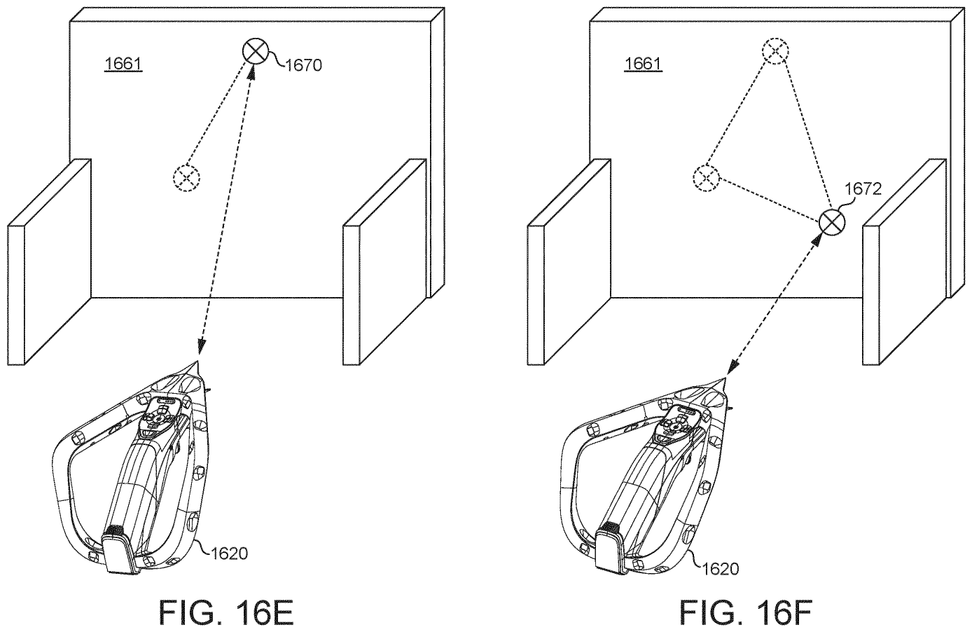

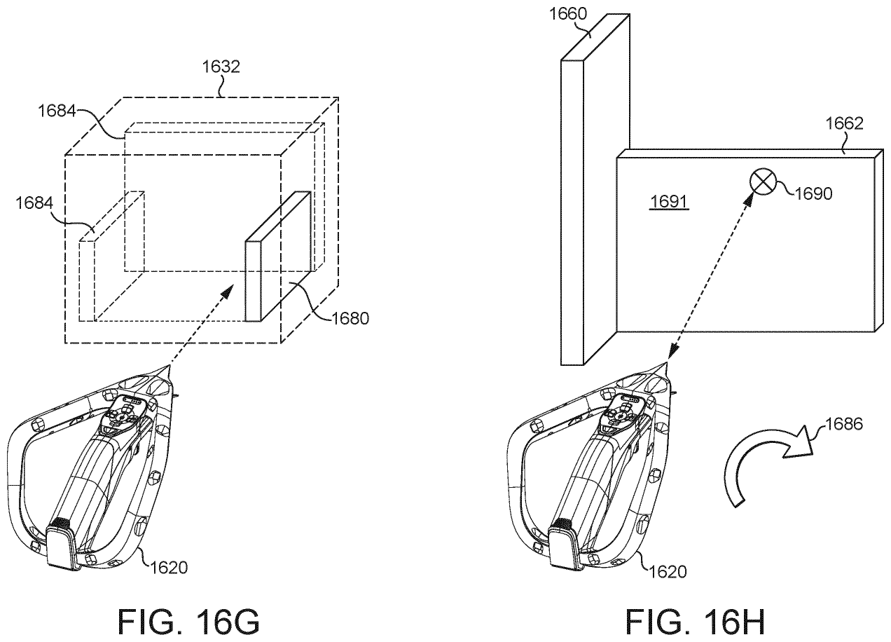

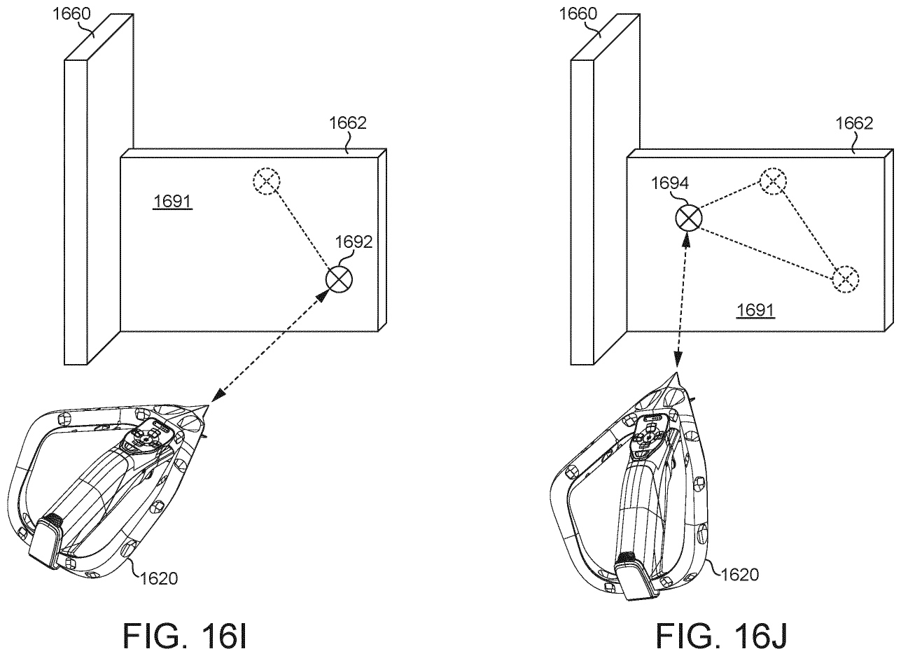

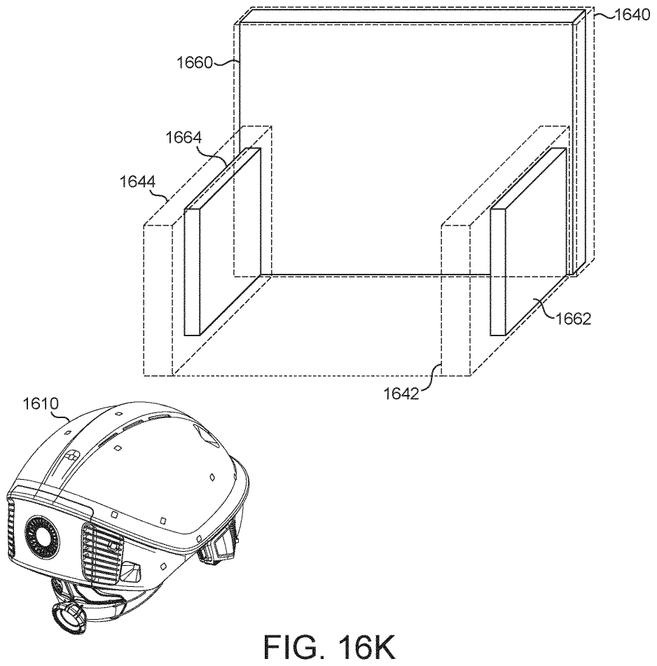

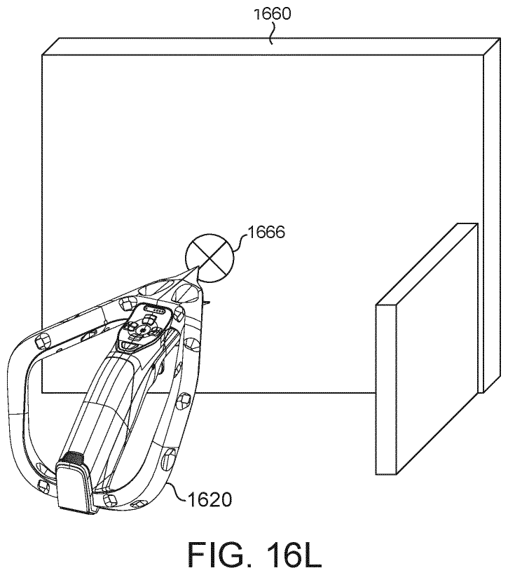

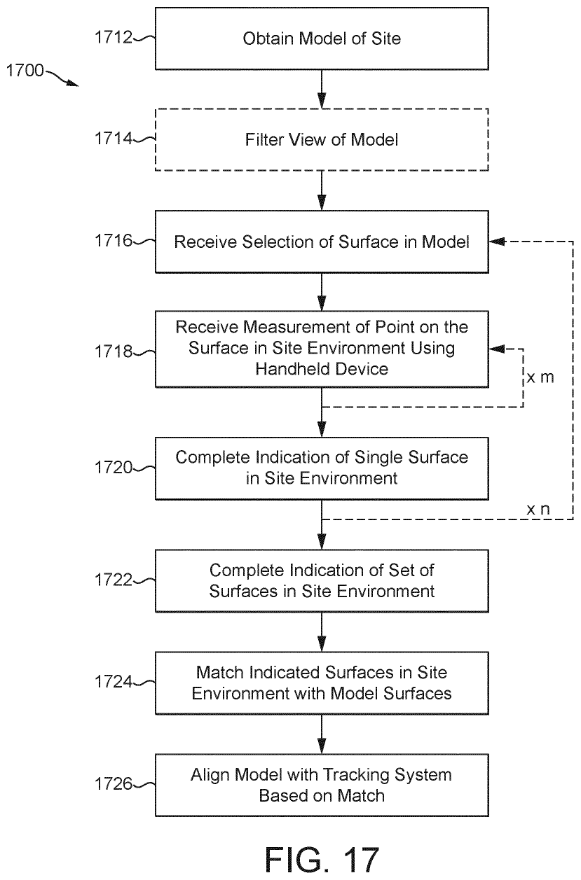

FIGS. 16A to 16L show certain stages in an example model alignment method. This method aims to provide a simple, computationally efficient method to align at least a portion of a building information model with a view of a construction site, so as to provide an augmented reality view (e.g. to overlay spatially aligned aspects of the building information model over the view of the construction site). Example stages of the method are shown schematically in FIGS. 16A to 16K and a corresponding flow diagram for the method is shown in FIG. 17.

The present example method has overlap with the example methods described with reference to FIG. 12B and FIG. 13. The present example method may use the combination of the hard hat 1110 and the handheld controller 1120 as previously described. In other cases, the present example method may alternatively be implemented using a handheld mobile device with an integrated screen, such as a tablet or smartphone.

In general, the present example method operates by measuring points that form part of a set of surfaces in the real-world (i.e., in the physical construction site) and then using those measurements to determine a transformation to apply to the building information model to align that model with a local coordinate system that is used to track a pose of a display that is showing the augmented reality view. The method may be used to avoid the need for a set of locations that have known positions in both the building information model and the real-world (e.g., a set of control points as described above). This can then reduce the need for surveying tools to measure survey markers forming control points, the need to define those control points in the building information model, and/or the need for users to actively measure those same survey markers with a tracking system. Furthermore, the use of surfaces rather than points may introduce an element of averaging that leads to more robust alignment. The method also provides greater robustness as compared to more computationally intensive, and sensitive, image-processing algorithms.

FIG. 16A shows a user with an augmented-reality hard hat 1610 and a handheld controller 1620. The hard hat 1610 may comprise the hard hat of previous examples (e.g., as described with reference to FIGS. 2A to 7C) or may comprise another device. The handheld controller 1620 is useable to interact with a virtual representation of a construction site as viewed by a user with a head mounted display, e.g. a user wearing hard hat 1610. In this case, the handheld controller 1620 is separate to the hard hat 1610. In the example of FIGS. 16D to 16F and 16H to 16J, the handheld controller 1620 comprises a set of sensors for a positional tracking system (e.g., photo sensors 812 in FIGS. 8A to 8D) and an electronic distance measurement instrument (e.g., the laser measurement device having emitter 842 and receiver 844 in FIG. 8D). The handheld controller 1620 in that example is thus similar to that described with reference to the examples of FIGS. 11 to 13. However, in certain cases, the handheld controller 1620 may omit the electronic distance measurement instrument. An example of one of these cases is described with reference to FIG. 16L. Although the present example is described with reference to a hard hat and separate handheld controller, the general method may also be applied using just an augmented or mixed reality headset and/or a mobile device with a camera and screen such as a phone or tablet. In one case, the method may be applied using a handheld device that comprises a smartphone with an inbuilt LiDAR sensor and/or infra-red depth sensor. In these latter cases, an augmented reality image may be displayed on a screen of the handheld device, e.g. as an overlay to a video feed from one or more cameras and/or as a generative video based on said video feed.

In FIG. 16A, the user views an augmented reality representation of a building information model 1630 using an augmented reality display within the hard hat 1610. The user uses the handheld controller 1620 to interface with the augmented reality environment. In FIGS. 16A and 16B the user is able to use the handheld controller 1620 to select a particular building information model 1630 and to then filter a view of that model. For example, the user may select a particular building information model from a list of available building information models using an augmented reality interface that is visible using the augmented reality display. In other cases, the building information model may be determined automatically, e.g. may be pre-loaded for a particular site inspection and/or selected based on a global positioning location. As shown in FIGS. 16A and 16B, the building information model 1630 is displayed at a reduced scale within a cuboid containing volume 1632. This containing volume 1632 may be resized as shown by arrows 1634 in order to view a particular portion of the building information model. Although this example shows a cuboid containing volume to scale and filter the building information model, other implementations may just show the model and/or use a different interface method to view and/or filter portions of the model. The volume also need not be cuboid but may comprise any polygonal containing volume.

In the example of FIG. 16B the building information model is filtered to show three structures within the model. These include a rear wall 1640, a right side wall 1642, and a left side wall 1644. Each of the three structures has a number of planar surfaces. It should be noted that the example has been simplified for ease of explanation; actual building information models may comprise many more structures—e.g., a door or window opening may comprise multiple surfaces forming the recess for the door or window. The surfaces also need not be planar (e.g., may comprise a cylindrical column with a measurable geometry). The user may select one of the faces of the containing volume 1632 and move it within the augmented reality view to focus on a filtered set of structures within the building information model 1630. For example, only portions of the building information model that are present in the containing volume 1632 may be shown and/or the building information model may be cropped to fit within the containing volume 1632.

FIGS. 16C to 16F show a process of selecting a surface 1650 with the building information model 1630 and then measuring points upon a corresponding real-world surface in the construction site. FIGS. 16G to 16J show a similar process for a further surface 1680. Using correspondences between measured points and selected (virtual) surfaces in the building information model, the building information model may be aligned with a tracked pose of the hard hat 1610 such that an augmented reality view of the building information model is aligned with a user view of the construction site. This aligned view is shown in FIG. 16K.

Returning to FIG. 16C, the user views an unaligned augmented reality view of the building information model. For example, the structures 1640 to 1644 may be of a reduced scale and rotated as compared to any actual structures in the external construction site. In the unaligned augmented reality view, the user selects a surface 1650 of one of the structures. This may be achieved using the handheld controller 1620 to navigate a user interface in virtual space, as shown by arrow 1652. In this case, a front face of the structure 1640 is selected. Surfaces 1654 of other structures are not selected.

Following selection, the user then moves to a view of the external environment. This is shown in FIGS. 16D to 16F. The external environment may be viewed by hiding the containing volume 1632, i.e. hiding virtual aspects of an augmented reality view of the building information model such that the user views the outside world through the transparent display panels 222. In a case where a mobile device is used, a camera feed may be shown on the mobile device display. The external environment has a number of structures that correspond to the structures of the building information model. These include a rear wall 1660 and two side walls 1662 and 1664. Following selection of the virtual surface 1650, the user then proceeds in FIGS. 16D to 16F to measure the location of the corresponding real-world surface 1661 (i.e., the front plane of the rear wall 1660). The method of FIGS. 11 and 12A may be used to measure a real-world location of point 1666 on the real-world surface 1661 (e.g., using a tracked pose of the handheld controller 1620 and a distance measurement 1668). Alternatively, in cases where the handheld controller does not comprise an electronic distance measurement instrument, the point 1666 may be measured by locating the tip of the handheld controller 1620 upon the real-world surface (e.g. mating the upper single prong of the three-pronged nose 830 with the rear wall). An example of this direct measurement is shown in FIG. 16L, wherein the user aligns the tip of the handheld controller 1620 with a point 1666. As the handheld controller 1620 is tracked by a tracking system, which is also the tracking system used by the hard hat 1610, it may be located within a tracking coordinate system. In other implementations, a handheld controller may be tracked by a separate tracking system that is referenced to the hard hat (e.g., an infra-red tracking system mounted in the hard hat). It should be noted that the point 1666 need not be any special or particular point on the real-world surface 1661, it may simply be a first location selected at random that forms part of the surface. In cases where a mobile device is used instead of the handheld controller, the point 1666 may be measured using a LiDAR camera of the mobile device and/or by moving the mobile device to the point and holding the mobile device in a pre-determined orientation.

In FIGS. 16E and 16F, the user indicates and measures a further two points 1670 and 1672 on the surface 1661. This then forms a triangle. The measured points may be shown with virtual annotations within the augmented reality view. For example, they may be highlighted with a yellow circle and virtual lines may be drawn to connect the points, as illustrated in the figures with the dashed joining lines. Following the process of FIGS. 16C to 16F, a set of three measured points in a tracking coordinate system may be assigned to the model surface 1650. As described with reference to previous examples, the tracking coordinate system is used by a tracking system that tracks the location and/or orientation of the hard hat 1610 and the handheld controller 1620.

In FIGS. 16G to 16J the process of FIGS. 16E to 16F is repeated for another model surface. In FIG. 16G a surface in the form of the inner face 1680 of the (virtually-shown) right wall structure 1642 is selected by the user using the handheld controller 1620. The other surfaces 1684 of the other structures are deselected. In the real-world, the user moves within the construction site to align themselves with the corresponding structure 1662 in the real-world. In FIG. 16H, the user turns to the right as shown by arrow 1686. The user then follows a similar process to FIGS. 16D to 16F in FIGS. 16H to 16J to measure the locations of the three points 1690, 1692 and 1694 on the real-world surface 1691.

The process shown in FIGS. 16E to 16F and 16G to 16J is repeated until a suitable number of real-world surfaces have been measured to allow an unambiguous alignment of a model coordinate system used for the building information model with the tracking coordinate system. In a simplest case, a building information model with a single wall structure may only require the measurement of three points on a single wall surface to align the building information model. However, more complex building information models, which typically have multiple structures and surfaces, may require multiple real-world surfaces to be measured to allow for an unambiguous alignment. In one case, three perpendicular surfaces (e.g., the two surfaces 1661, 1691 and the floor or ceiling) may provide robust alignment. Increasing the number of surfaces may remove matching and scale ambiguities depending on the building information model. The number of surfaces to measure may be configured dynamically for each alignment routine based on the building information model and/or existing measured surfaces. For example, a user may be prompted via the augmented reality user interface to measure another surface if there is not enough data to compute an alignment.

As described earlier with reference to a set of control points, coordinates for three or four points in each coordinate system are enough to derive a transformation that maps between a model coordinate system and the tracking coordinate system. The transformation allows renders of the building information model to be aligned with the location and orientation of a display providing the augmented reality view. Four points provides a more robust mapping and allows proper scale calibration. Parameters for a transformation matrix (e.g., rotation and translation parameters) may be derived by solving a set of equations that define the selected surfaces in the building information model and the measured surfaces in the real-world. In certain cases, these parameters may be derived using known optimisation techniques (e.g., least squares). In one case, the normal vectors for each set of surfaces (BIM vs measured) may be defined as two matrices, one matrix N with the BIM surface normal vectors arranged in columns of the matrix and another matrix N′ with the measured surface normal vectors arranged in columns of that matrix. The singular value decomposition (U, Σ, V) of the matrix product (e.g., N^{T}N′, representing the covariance of the two sets of normal vectors) may be computed and used to derive a rotation matrix (e.g., R=VU^{T}). A translation vector may be derived by comparing two corresponding points in each coordinate system (e.g., subtracting the rotated origin of one coordinate system using R from the origin of the other coordinate system). The transformation matrix may then be determined from the rotation matrix and translation vector. The approach to compute the transformation matrix may be based on the Kabsch algorithm or solutions to Wahba's problem or the orthogonal Procrustes problem.

FIG. 16K shows a virtual view of the aligned building information model. In this case, the virtual structures 1640, 1642, and 1644 are respectively aligned with their real-world counterpart structures 1660, 1662, and 1664. Once a transformation matrix is determined to map between the building information model coordinate system and the tracking coordinate system, a suitable two-dimensional projection of the building information model that aligns with the plane of the augmented reality display may be computed. The transformation matrix may then be used to render aligned augmented reality views of the building information model as the user explores the construction site. The aligned augmented reality view may be used for, amongst other things, site inspections and guiding building work.

FIG. 17 shows a method 1700 of aligning a building information model (or portion of such a model) with an augmented reality view of a construction site. The method 1700 corresponds to the actions shown in FIGS. 16A to 16K. It may be executed by a processor within the hard hat (e.g., that forms part of integrated electronic subsystem 660) or a processor within another mobile device.

At block 1712, a building information model is obtained. In one case, a user may select and load a building information model that is stored within a storage device of the hard hat 1610 using an augmented reality interface. In another case, a single building information model may be pre-stored for a particular site operation and may be loaded (at least partially) into memory on activation of the hard hat 1610. In yet another case, a suitable building information model may be automatically downloaded from a remote server device based on a tracked location of a mobile device that is displaying the augmented reality view. At this stage, the building information model is not aligned with the augmented reality view. For example, the building information model may be defined within a model coordinate system with a defined origin; in the augmented reality view a default transformation matrix may be used to map the origin of the model coordinate system to the tracking coordinate system (e.g., based on an identity rotation matrix and view-based translation).

At block 1714, the building information model may be filtered to allow a user to better see different objects and/or structures within the model. For example, the sequence shown in FIGS. 16A and 16B may be performed. Filtering may involve cropping and/or hiding portions of the building information model based on a moveable containing volume visible in the augmented reality view. In other cases, certain objects and/or structures may be selected from a list displayed in the augmented reality view.

At block 1716, a selection of a model surface in the building information model is received. For example, a user may use the handheld controller 1620 to select a surface of a particular object or structure in the building information model. The model surface may be a plane of the particular object and/or structure. An example of this step is shown in FIGS. 16C and 16G. The model surface may also be one of a ceiling portion or floor portion. The model surface may be determined by determining the intersection of a ray deemed to project from the tip of a virtual twin of the handheld controller. In cases where a mobile device is used, the user may use a touch screen to select a model surface displayed as part of an augmented reality view.

At block 1718, a measurement of a point in the external, real-world is received. For example, as per FIGS. 11 and 12A, a user may use the handheld controller 1620 to indicate a remote point on a real-world surface. An electronic distance measurement device may then determine a distance from the handheld controller to the remote point. This distance, a known emittance location, and the tracked pose of the handheld controller may then be used to locate the remote point within the tracking coordinate system. In other cases, such as those shown in FIG. 16L, the handheld controller 1620 may be physically moved such that a known point on the controller indicates a point that is then measured using the tracked pose of the handheld controller and known design distances for the handheld controller.

As shown in FIG. 17, block 1718 may be repeated m times to measure the position of m points on the real-world surface that corresponds to the model surface selected in block 1716. The locations of these points in the three-dimensions of the tracking coordinate system are thus known. In one case, m is greater than or equal to 3, such that by repeating block 1718, the user indicates a triangular area on the real-world surface. This is shown in FIGS. 16D to 16F and 16H to 16J. At block 1720, a check is made to determine if the indication of a single surface in the construction site environment is complete. For example, this may comprise checking whether a required number of points have been measured. It may also comprise certain validation routines. For example, if the selected model surface is horizontal or vertical within the building information model and the plane formed by the m points deviates from the horizontal or vertical by a predetermined threshold, the user may be prompted to repeat the measurement.

At shown in FIG. 17, blocks 1716, 1718, 1720 are repeated n times to provide measured data for a set of n surfaces. In one case, n is greater than or equal to 3. The selection of model surfaces may be constrained at block 1716, such that a diverse set of model surfaces are selected. For example, more reliable alignment may be achieved with a set of perpendicular surfaces and/or a set of surfaces that are separated by more than a predetermined distance threshold. In other cases, the user may be free to select surfaces and blocks 1716, 1718, 1720 are repeated until enough data is gathered to provide a robust alignment. Checks on the number and form of surfaces may be applied at block 1722 until a desired number of model surfaces have been selected and corresponding surfaces in the real-world measured (i.e., such that there are sets of model surfaces defined in the model coordinate system and real-world surfaces defined in the tracking coordinate system).

At block 1724, data defining the selected model surfaces and corresponding measured points on the real-world surfaces is processed to match the indicated surfaces in the construction site environment with the model surfaces. For example, this may comprise solving a set of equations defining respect planes, or normal vectors to those planes, e.g. as described above. The matching at block 1724 may comprise computing a transformation matrix that comprises a rotation matrix and a translation vector. A scaling factor may be determined by comparing distances between pairs of surfaces in the model and pairs of measured surfaces. In this manner, the building information model may be mapped to the tracking coordinate system for display of an aligned augmented reality view at block 1726. Depending on the match at block 1724, transformation matrices in either direction may be defined (e.g., either by swapping data points in equations to be solved or by computing an inverse transformation matrix). A mapping between the tracking coordinate system and the model coordinate system may allow objects tracked within the tracking coordinate system to be displayed within the building information model (e.g., the user and/or handheld controller may be displayed in the augmented reality views shown in FIGS. 16A and 16B).

### Additional Examples and Information

To display augmented reality information, a positional tracking system, such as the positional tracking system 100 may be used. It should be noted that in other examples other positional tracking systems may be used such as an optical tracking system and the photo sensors replaced with equivalents in those systems, such as active and/or passive optical markers. Combinations of positional tracking systems may also be used, e.g. as is described in WO 2022/167505 A1, which is incorporated herein by reference. For example, data from the camera assembly may be used in approaches that fuse multiple positioning systems as described in the aforementioned publication. In the example of FIGS. 1A and 1B, a plurality of sensor devices on an example hard hat and an example handheld controller track the position of the hard hat and the handheld controller within a tracked volume defined by a positional tracking system that is set up at a construction site, e.g. using a set of tracking beacons as described herein. Although the examples comprise particular sensor devices for particular positioning systems, these are provided for ease of explanation only; implementations may use any type or technology for the positioning systems, including known or future “off-the-shelf” positioning systems. One or more of the hard hat and the handheld controller may further comprise one or more inertial measurement units (IMU) of the kind found in virtual reality and augmented reality headsets, which comprises a combination of one or more accelerometers and one or more gyroscopes. The IMU may comprise one accelerometer and one gyroscope for each of pitch, roll and yaw modes. These may be used to assist with short-term positional tracking in combination with longer term positioning provided by the positional tracking systems (e.g., it is well-known that IMU drift caused by the finite accuracy of IMU sensors causes any position that is tracked using an IMU to be unusable after a few seconds). In certain variations, eye-tracking devices may also be used. These may not be used in all implementations but may improve display in certain cases with a trade-off of additional complexity. The examples described herein are implemented without eye-tracking devices.

In certain examples, one or more camera devices, e.g. in the camera assembly 230 shown in FIG. 2A, are arranged to provide positioning data. For example, the one or more camera devices may comprise one or more camera devices with a wide-angle field of view (e.g., within a horizontal extent) so as to capture images of the area surrounding the hard hat 210. Here, the term “wide” may refer to a field of view that is greater than 90 degrees in the horizontal direction. The quality of the camera devices may be selected based on a tracking accuracy. For example, relatively low-resolution camera devices may be able to capture images that enable the relative position and orientation of the hard hat 210 and/or objects within a line-of-sight of the hard hat to be determined. In certain cases, multiple camera devices as shown in FIG. 2A may be provided. Images from the one or more camera devices may be supplied to one or more computer programs, e.g. running within the integrated electronic subsystem and/or within a set of distributed computing devices, for detection of objects within the field-of-view and determination of one or more of position and orientation of the same and/or the hard hat 210. For example, firmware or other computer program code may be loaded into a memory and executed by a processor of a compute module to determine poses of objects that feature within images captured by the one or more camera devices. In certain cases, the one or more camera devices may comprise video devices or the like that are arranged to provide a stream of images (e.g., video frames). Detection of objects and determination of one or more of position and orientation of the same may be performed on one or more frames supplied from this stream. Processing may be performed on every frame or every n-frames (e.g., depending on computing resources). In one case, a conditional processing pipeline may comprise detection and pose determination stages, which may be sequential. The detection stage may comprise a function optimised for speed that may run on every frame, or on every m frames, where m is selected to provide the processing of a relatively high number of frames per second (e.g., 5-20). Responsive to an object being detected within a frame, said frame may then be passed to the pose determination for determination of the position and orientation of the object within the frame. Hence, the detection stage may act as a filter such that the pose determination is performed conditional on objects being detected in the vicinity.

For object detection, and/or obtaining SLAM positioning data for the hard hat, a pose determination stage of a compute module may use one or more frames to determine the position and orientation of objects visible to the camera assembly 230. For example, this pose determination stage may comprise a computer vision function provided by an image processing library that is configured to determine a pose of a located object. This pose determination stage may differ from any pose determination that is performed for the hard hat 210 based on data from photo sensors 212 using tracking beacons 102. The pose determination stage may receive positioning data indicating the position of the located object within an image (e.g., in the form of a bounding box or centroid). The pose determination stage may determine a pose relative to one or the one or more camera devices on the hard hat 210. For example, the pose determination stage may solve a perspective-n-point (PNP) problem, given the locations of n 3D points on an object and corresponding points with a captured image. This pose determination stage may be supplied (e.g., in the form of data loaded into memory) with the intrinsic parameters of the one or more camera devices (e.g., focal length, optical centre, and radial distortion parameters). Alternatively, these may be approximated during image acquisition. Any used intrinsic parameters of the one or more camera devices may be measured and stored as part of a setup or calibration phase prior to use or loaded based on a factory calibration. The pose determination stage may use one or more of the solvePnP or the solvePnPRansac functions provided by the OpenCV library. Alternatively, the pose determination stage may utilise a trained deep neural network. In one case, both detection and pose determination stages may be combined as one inference process for a deep neural network that receives a frame of image data (e.g., greyscale, YUV or RGB) and outputs one or more 6 degrees-of-freedom poses (i.e., a 6-parameter variable) for detected objects. Such a deep neural network may be based on a convolutional neural network followed by a feed-forward neural network.

### Example Clauses

In this section a variety of clauses are presented. These may or may not be claimed depending on the specific patent application.

In a first aspect, a multi-layer hard hat is provided. This may be provided in a hard hat having at least one integrated electronic subsystem. The multi-layer hard hat improves safety and comfort for a user. In a second aspect, a hard hat having an impact foam is provided. The impact foam may be positioned between two layers of a multi-layer hard hat. The impact foam helps improve safety, especially against side impacts. In a third aspect, a deformable ventilation coupling for a hard hat is described. Again, this may be used with a multi-layer hard hat having at least one integrated electronic subsystem. The third aspect may improve airflow within the hard hat and increase user comfort during long periods of use, such as site visits. In a fourth aspect, a hard hat with an integrated electronic subsystem comprises a plurality of battery coupling interfaces for coupling a plurality of removable batteries, where power may be supplied by one of the plurality of batteries while another of the plurality batteries is exchanged. This enables continuous use of the integrated electronic subsystem, e.g. in the form of an augmented reality system, without re-calibration. In a fifth aspect, a detachable battery casing for a removable battery for a hard hat with an integrated electronic subsystem is provided. The detachable battery casing may comprise a unique securing mechanism for improving ease of battery exchange. In a sixth aspect, a positioning of a plurality of battery coupling interfaces on a hard hat with an integrated electronic subsystem is configured to lower a centre of gravity of the hard hat to improve stability and comfort on a user's head. In a seventh aspect, a kit of components is provided for an augmented reality application on a construction site. The kit may comprise various combinations of different aspects discussed herein as well as one or more of: a common-specification rechargeable battery, a handheld controller, a tracking beacon, and a battery charging station. In an eighth aspect, a cradle height adjustment mechanism is provided for a hard hat. The eighth aspect may also comprise a method of adjustment. The eighth aspect can improve configurability of the hard hat as described herein and increase user comfort and safety. In a ninth aspect, a moveable device, such as a handheld controller, comprises a set of sensors for a positional tracking system and an electronic distance measurement instrument. This device may be used in methods to interact with an augmented reality system, include those that map between locations in the real-world of the construction site and a virtual world as displayed on the augmented reality display. The ninth aspect may provide an improved man-machine interface. In a tenth aspect, a method is provided of preparing three-dimensional building information model data for use in an augmented reality application. This aspect can accelerate the preparation of BIM data for augmented reality views on site.

The above aspects may be provided individually or may be combined in a variety of different combinations. While the individual aspects have their own advantages, different combinations also provide additional emergent or synergistic advantages.

With reference to the first three aspects, there may be provided a hard hat with at least one integrated electronic subsystem, the hard hat comprising: an outer portion; and an inner portion, wherein the outer and inner portions are spaced apart within the hard hat, and wherein the at least one integrated electronic subsystem is mounted between the outer and inner portions. The outer and inner portions may comprise rigid portions or shells. The outer portion may comprise a polymer outer shell having a first thickness and the inner portion may comprise a carbon fibre inner shell having a second thickness, the second thickness being less than the first thickness. The first thickness may be around 1.5 mm and the second thickness may be around 0.8 mm. The outer and inner portions may be spaced by approximately 20 mm for at least half of the circumference of the hard hat. A first integrated electronic subsystem may be mounted at a rear of the hard hat between the outer and inner portions. The first integrated electronic subsystem may comprise a fan and a spacing between the outer and inner portions allows an air flow over the first integrated electronic subsystem. The inner portion may provide one or more of impact protection and penetration protection. The outer portion may be arranged to absorb at least a portion of an energy of an impact. The hard hat may comprise an impact foam arranged between the outer and inner portions. The integrated electronic subsystem may be mounted upon the inner portion and/or may be mounted on the outer portion. The inner portion may comprise ventilation apertures, and the hard hat may further comprise a deformable ventilation coupling for coupling the outer portion and the inner portion, the deformable ventilation coupling allowing air flow from the ventilation apertures to an exterior of the outer portion. The deformable ventilation coupling may comprise a waterproof seal to prevent water entering the ventilation apertures. The deformable ventilation coupling may be attached to the outer portion and the inner portion. The deformable ventilation coupling may comprise: a first rigid frame for coupling to the inner portion; a second rigid frame for coupling to the outer portion; and a deformable suspension system arranged between the first and second rigid frames. The deformable ventilation coupling may comprise a rubber member. The deformable ventilation coupling may comprise two parallel sequences of three apertures. The outer portion may comprise air vents that are aligned with the deformable ventilation coupling in use. The integrated electronic subsystem may comprise at least one processor and memory. The integrated electronic subsystem may comprise a compute module for an augmented reality system.

In one case, there may be provided a hard hat with at least one integrated electronic subsystem, the hard hat comprising: an outer portion; and an inner portion, wherein the outer and inner portions are spaced apart within the hard hat, wherein the at least one integrated electronic subsystem is mounted between the outer and inner portions, and wherein an impact foam is configured between the outer and inner portions. In another case, a deformable ventilation coupling for a hard hat, the hard hat having an integrated electronic subsystem, may comprise: a first rigid frame for coupling to an inner portion of the hard hat; a second rigid frame for coupling to an outer portion of the hard hat; and a deformable suspension system arranged between the first and second rigid frames, the deformable suspension system comprising apertures to allow air flow from ventilation apertures of the inner portion to an exterior of the outer portion, the apertures comprising a waterproof seal. In yet another case, a hard hat with an integrated electronic subsystem may comprise an outer protective portion; an inner separable portion for mounting the integrated electronic subsystem, the inner separable portion being worn by a user, the inner portion comprising ventilation apertures; and a deformable ventilation coupling for coupling the outer protective portion and the inner separable portion, the deformable ventilation coupling allowing air flow from the ventilation apertures to an exterior of the outer protective portion.

Referring to the fourth to seventh aspects, a hard hat with an integrated electronic subsystem may comprise a plurality of battery coupling interfaces for coupling a plurality of removable batteries, wherein the integrated electronic subsystem comprises a power subsystem configured to draw power from a coupled one of the plurality of removable batteries to enable exchange of another of the plurality of removable batteries without power loss to the integrated electronic subsystem. The hard hat may further comprise the plurality of removable batteries, wherein the removable batteries comprise rechargeable batteries. The battery coupling interfaces may be laterally mounted within the hard hat. Each of the plurality of battery coupling interfaces may comprise: a battery socket within the hard hat; and a detachable casing portion to receive one of the plurality of removable batteries, the detachable casing portion being couplable to the hard hat around the battery socket to align the one removable battery with the battery socket. The integrated electronic subsystem may comprise a compute module for an augmented reality system and wherein each detachable casing portion forms a lateral wing to a set of glasses for the augmented reality system. The plurality of battery coupling interfaces may allow removal of at least one of the plurality of removable batteries during use on the head of a user. The detachable casing portion may be removable with a single hand of the user. The battery coupling interfaces may be laterally mounted such that, when the removable batteries are coupled to the hard hat, the centre of gravity of the hard hat is below a circumferential rim of the hard hat. The plurality of battery coupling interfaces may be symmetrically aligned with respect to a front of the hard hat such that the centre of gravity of the hard hat is located on or near a midline of the hard hat. The plurality of battery coupling interfaces may be laterally mounted such that, when the removable batteries are coupled to the hard hat, the centre of gravity of the hard hat is located to the rear of the coupled removable batteries. One or more of the plurality of removable batteries may be further usable to power other peripheral devices used with the hard hat.

In one case, a detachable battery casing for a removable battery for a hard hat with an integrated electronic subsystem, comprises: a mechanical interface for coupling with the hard hat, and a securing mechanism to secure the removable battery within the detachable battery casing when the detachable battery casing is not coupled to the hard hat, wherein the securing mechanism is arranged to release the removable battery when the detachable battery casing is coupled to the hard hat via the mechanical interface. The securing mechanism may comprise a gripping mechanism, the gripping mechanism comprising: a pivoted member; and a force applying member, wherein, when the detachable battery casing is not coupled to the hard hat, the force applying member applies a force to a first end of the pivoted member to frictionally secure the removable battery within the detachable battery casing, wherein, when the detachable battery casing is coupled to the hard hat, the mechanical interface applies a counteracting force to a second end of the pivoted member to move the pivoted member to release the removable battery within the detachable battery case. The detachable battery casing may further comprise a battery biasing member, wherein, when the detachable battery casing is coupled to the hard hat, the battery biasing member applies a force to the removable battery to form an electrical connection between the removable battery and the integrated electronic subsystem of the hard hat.

In another case, a kit for use on a construction site is provided, comprising: a hard hat with an integrated augmented reality subsystem; a plurality of removable rechargeable batteries; a set of detachable battery casings, each detachable battery casing receiving, in use, one of the plurality of removable rechargeable batteries, at least two of the set of detachable battery cases being mechanically couplable to the hard hat in use to power the integrated augmented reality subsystem of the hard hat; and one or more tracking beacons for use in determining a position of the hard hat within the construction site, each tracking beacon being configured to receive at least one of the plurality of removable rechargeable batteries for power in a case where external power is not available. The kit may further comprise a charging station to recharge one or more of the plurality of removable rechargeable batteries. The charging station may be arranged to recharge more than two of the plurality of removable rechargeable batteries at the same time and/or may comprise a plurality of battery recharge bays on each side of the charging station. A receiving portion of each side of the charging station may be moveable between two positions: an open position to receive one or more of the plurality of removable rechargeable batteries and a closed position wherein terminals for the plurality of battery recharge bays are protected. The kit may further comprise a handheld controller. The kit may comprise any combination of components as described in the different examples herein.

According to an eight aspect, a cradle height adjustment mechanism for a hard hat is provided, comprising at least: a cradle for positioning the hard hat on a head of a user; and a set of cradle mounting pins, wherein the cradle comprises a plurality of spaced apertures that are adjustably alignable with corresponding apertures within a cradle mounting that receives the cradle, and wherein the set of cradle mounting pins are removable to select different ones of the plurality of spaced apertures to adjust a relative height of the cradle compared to the cradle mounting for use. The cradle mounting pins may comprise quarter turn bayonet locking pins. The cradle mounting pins may comprise a foldable handle, the foldable handle having a position substantially normal to a face of each mounting pin to turn the pin. The cradle may comprise multiple sets of at least two apertures that are spaced at least vertically with respect to the hard hat. In one case, the cradle comprises four sets of two apertures that are evenly spaced around the cradle. The height of the cradle may be adjustable within the cradle mounting by a vertical spacing of 10 mm. The mechanism may further comprise a cradle mounting for coupling the cradle to the hard hat, the cradle mounting comprising a plurality of apertures corresponding to the plurality of spaced apertures in the cradle of the cradle height adjustment mechanism. A hard hat may be provided comprising this cradle height adjustment mechanism, including its variations. An accompanying method of adjusting a height of a hard hat as positioned on a head of a user may comprise: turning a set of cradle mounting pins to remove the pins from sets of corresponding apertures in a cradle and a cradle mounting of the hard hat; selecting a set of alternate mounting apertures in at least one of the cradle and the cradle mounting; moving at least one of the cradle and the cradle mounting to align the selected set of alternate mounting apertures; reinserting the cradle mounting pins into the aligned alternate mounting apertures; and turning the set of cradle mounting pins to lock the pins into position.

As part of a ninth aspect, a method comprises: tracking a position and orientation of a moveable device within a construction site; indicating, using the moveable device as operated by a user wearing a head mounted display, a first point comprising: a real-world point within the construction site, or a virtual point within a virtual space viewed by the user; emitting a directional distance measurement beam from the moveable device in the direction of the indicated first point; determining a distance to an occupied portion of space within the construction site using the directional distance measurement beam; determining a direction of the directional distance measurement beam; using the position and orientation of the moveable device, together with the direction of the distance measurement beam and the distance to the occupied portion of space, to determine a location of a second point corresponding to the first point, the second point comprising a corresponding virtual point for the real-world point or a corresponding real-world point for the virtual point. The moveable device may comprise the handheld controller described herein. The virtual space may be populated using data from a building information model that is defined with respect to a model coordinate system. The tracking may be performed within a tracking coordinate system. The directional distance measurement beam may be emitted from the moveable device and reflected by the occupied portion of space, a reflection of the directional distance measurement beam being detected by the moveable device. The distance to the occupied portion of space and the direction of the directional distance measurement beam are determined within the tracking coordinate system; and the location of the real-world point within the construction site is determined within the tracking coordinate system. A correspondence between the tracking coordinate system and the model coordinate system may be determined using a calibrated transformation, the calibrated transformation mapping points between the coordinate systems. The virtual point may comprise a point on a surface or object defined as part of the building information model and the method may comprise: mapping between the tracking coordinate system and the model coordinate system using the calibrated transformation to determine corresponding locations of the virtual point and the real-world point in a common coordinate system; and determining any difference between the corresponding locations of the indicated virtual point and the real-world point in the common coordinate system. The method may also comprise indicating a difference between the corresponding locations of the virtual point and the real-world point in the common coordinate system in the virtual space viewed by the user. An instruction may be received from the user to match the virtual point to the real-world point in the common coordinate system; and the method may comprise updating a location of the surface or object within the building information model.

In the case the moveable device comprises a handheld portable construction tool, said indicating may comprise: pointing a virtual representation of the handheld portable construction tool towards a virtual point of interest; ray-tracing from a predefined location on the virtual representation of the handheld portable construction tool to a virtual surface or object within the virtual space; and determining a location where a ray from the ray-tracing intersects the virtual surface or object, said location being presented as the location of the indicated virtual point.

In a case where the moveable device is worn by the user and comprises the head mounted display; said indicating may comprise: pointing a virtual representation of one or more body parts of the user towards a point of interest; ray-tracing from a location defined in relation to the virtual representation of the one or more body parts of the user to a virtual surface within the virtual space; and determining a location where a ray from the ray-tracing intersects the virtual surface, said location being presented as the location of the indicated virtual point.

The directional distance measurement beam may be emitted from a defined location on the moveable device; and the direction of the directional distance measurement beam may be determined based on the orientation of the moveable device. The directional distance measurement beam may be emitted from a defined location on the moveable device with a configurable directionality, wherein determining the direction of the directional distance measurement beam comprises measuring the configurable directionality at the time of emission. The position and orientation of the moveable device may be provided as a six degrees of freedom—6FOD—pose within a tracking coordinate system; and the distance to the occupied portion of space and the direction of the directional distance measurement beam may be used to determine a transformation within the tracking coordinate system that defines the location of the real-world point within the tracking coordinate system.

The first point may comprise a virtual point and the method may comprise: using the position and orientation of the moveable device, together with the direction of the distance measurement beam and the distance to the occupied portion of space, to determine a location of a corresponding real-world point for the virtual point; mapping the real-world point back into the virtual space using a calibrated transformation between a model coordinate system for the virtual space and a coordinate system for tracking in the real-world space; and displaying the locations of the mapped real-world point in the virtual space and the originally indicated virtual point, including indicating any differences between the mapped real-world point and the virtual point.

The first point may comprise a real-world point and the method may comprise: indicating the first point by pointing the moveable device towards the first point within the construction site; wherein, in this case, determining the location of the corresponding second point comprises: determining a location of the first point in a coordinate system used for tracking the moveable device within the construction site; mapping the location of the first point to the virtual space to determine the location of the corresponding second point, the corresponding second point comprising a virtual point within the virtual space; and indicating to the user, via the head mounted display, the location of the corresponding second point within the virtual space.

The method may comprise: selecting, by the user, a virtual surface or object in the virtual space as viewed by the user; using the position and orientation of the moveable device, together with the direction of the distance measurement beam and the distance to the occupied portion of space, to determine one or more locations of real-world points corresponding to the selected virtual surface or object; detecting a gesture from the user in relation to the virtual surface or object; updating the location of the virtual surface or object in the virtual space based on the one or more locations of real-world points corresponding to the selected virtual surface or object; and updating the displayed location of the virtual surface or object in the virtual space as viewed by the user. The method may also or alternatively comprise indicating, by the user, a series of corners forming part of an object in the virtual space as viewed by the user; using the position and orientation of the moveable device, together with the direction of the distance measurement beam and the distance to the occupied portion of space, to determine corresponding locations of real-world points corresponding to the series of corners; mapping the locations of real-world points to the virtual space; and updating the location of the series of corners in the virtual space using the mapped locations. The method may comprise: obtaining a virtual object within the virtual space; using the moveable device to indicate a plurality of real-world points; determining the location of virtual points corresponding to the plurality of real-world points; and aligning the virtual object within the virtual space based on the location of the virtual points. The method may further comprise: selecting a face of the virtual object; using the virtual points to define a plane within the virtual space; and aligning the face of the virtual object with the plane in the virtual space. The locations of a plurality of virtual points may be used to define a work area, the work area setting a rendering distance for the virtual space within the head mounted display. The first and second points may be used to align a virtual object in the virtual space with a physical location within the construction site. The virtual point may comprise a location in the virtual space that is defined with reference to the virtual object, wherein correspondence between the real-world point and the virtual point may be used to position the virtual object in relation to the real-world point. The first point may comprise a real-world point within the construction site, wherein the corresponding virtual point in the virtual space may be used to set a size of a virtual object within the virtual space. The method may comprise indicating at least two real-world points within the construction site; determining corresponding virtual points for the two real-world points; and using a distance between the corresponding virtual points within the virtual world to set the size of the virtual object.

As part of the ninth aspect, there may be a moveable device for interacting with a virtual representation of a construction site as viewed by a user with a head mounted display, the moveable device being separate from the head mounted display, comprising: a set of sensors for a positional tracking system, the set of sensors being configured to obtain sensor data to derive one or more of a position and orientation of the moveable device within the construction site; and an electronic distance measurement instrument configured to determine a distance from a known location on the moveable device along a line-of-sight to an occupied portion of space within the construction site, the occupied portion of space being remote from the construction tool, wherein the sensor data and the determined distance are usable to determine a position, defined in reference to the positional tracking system, of a point corresponding to the occupied portion of space, and wherein the moveable device is configured to be oriented by the user within the construction site to compare model-defined and measured real-world points within the virtual representation. The moveable device may comprise a handheld portable construction tool that is useable with the head mounted display, wherein the head mounted display comprises a set of sensors for the positional tracking system configured to obtain sensor data to derive one or more of a position and orientation of the head mounted display within the construction site. The electronic distance measurement instrument may emit a directional beam to determine the distance, the directional beam being emitted from the known location on the moveable device with a known or measurable emittance vector from the known location, wherein the emittance vector and the determined distance are useable to determine a three-dimensional location of the point corresponding to the occupied portion of space relative to the known location, and wherein the known location is in a known or measurable position within three-dimensional space relative to a position of the moveable device derived from the sensor data. The electronic distance measurement instrument may comprise one or more of: an ultrasound distance measurement device; and a laser distance measurement device. The moveable device may comprise: an orientation sensor to determine an orientation of the moveable device, wherein the orientation from the orientation sensor and at least a position derived from the sensor data from the set of sensors for the positional tracking system may be used to determine a three-dimension pose of the moveable device within a coordinate system for the positional tracking system. The moveable device may comprise an electronic control system to obtain the sensor data and the determined distance and to determine the position of the point corresponding to the occupied portion of space within a coordinate system for the positional tracking system. Alternatively, these control functions may be distributed over one or more electronic devices including one or more of: the moveable device, an integrated electronic subsystem of a hard hat, and a remote server. The electronic control system may be configured to: determine the positions of multiple points of occupied space; obtain data representing corresponding known positions of the measured points within a coordinate system used to define a building information model; and use a correspondence between the measured and known positions of the multiple points to compute a transformation to align the building information model and the coordinate system for the positional tracking system.

In certain cases, the methods described herein may be provided as a computer program and/or a computer program product. In one case, a non-transitory computer readable medium stores instructions that, when executed by one or more processors, cause the one or more processors to: obtain data representing a position of a moveable device from a positional tracking system in use at a construction site, the position being defined with respect to a coordinate system of the positional tracking system; obtain data representing an orientation of the moveable device with respect to the coordinate system of the positional tracking system; obtain data representing a distance from the moveable device to a point of occupied space within the construction site, the distance being obtained using a distance measurement beam emitted by the moveable device towards the point, the point being located remotely with respect to the moveable device, the moveable device being oriented to indicate the point; obtain data representing a direction of the distance measurement beam when emitted by the moveable device; and compute a position of the point at least within the coordinate system of the positional tracking system by combining the position and orientation of the moveable device, the direction of the distance measurement beam and the distance from the moveable device to the point.

In a tenth aspect, there is a method of preparing three-dimensional—3D—building information model—BIM—data for use in an augmented reality application, the method comprising: obtaining plan data defining an activity-based construction plan, the activity-based construction plan comprising a plurality of tasks to be performed as part of a construction project; obtaining element data representing a set of 3D elements that are defined within the BIM data; for at least one given task in the plurality of tasks, processing portions of the plan data associated with the given task and the element data to assign a subset of the set of 3D elements as candidate elements for the given task, said processing comprising using assignment data configured based on a training set of plan data with assigned 3D elements to tasks within the plan data; and providing the candidate elements for use in generating a task-specific augmented reality view of a construction site associated with the construction project, the task-specific augmented reality view being associated with the given task. Providing the candidate elements may comprise: displaying a list of the candidate elements to a user in association with the given task; receiving, from the user, a selection of confirmed candidate elements to use in the task-specific augmented reality view for the given task; and assigning the selection of confirmed candidate elements to the given task. The data defining the selection of confirmed candidate elements and the given task may be used to configure the assignment data for further tasks. The method may further comprise: viewing, via a head mounted display, an augmented reality view of the construction site; selecting the given task from the plurality of tasks using an augment reality user interface displayed within head mounted display; and populating the augmented reality view of the construction site with the confirmed candidate elements within a virtual layer of the augmented reality view. The assignment data may be configured based on one or more of an element name, an element type, and one or more element properties associated with the assigned 3D elements.

According to an eleventh aspect, there is a method of aligning a building information model with an augmented reality view based on surface matching. The method comprises: obtaining an unaligned three-dimensional building information model to use for an augmented reality view of a construction site, the unaligned three-dimensional building information model being defined within a model coordinate system; for each of a plurality of model surfaces within the three-dimensional building information model: receiving an indication of a model surface in the plurality of model surfaces within the augmented reality view; receiving respective measurements of a plurality of locations upon a corresponding real-world surface in the construction site by tracking a moveable handheld device within the construction site, said measurements being defined within a tracking coordinate system; determining a plane representing the corresponding real-world surface within the tracking coordinate system using the measured plurality of locations; and assigning the plane to the indicated model surface; and computing a transformation matrix to align the three-dimensional building information model with the augmented reality view using the plurality of model surfaces and the corresponding set of assigned planes.

The method allows a building information model to quickly and robustly be aligned with a tracking coordinate system to allow an augmented reality view of the construction site (i.e., with relevant portions of the building information model overlaid over a view of the construction site). The method has benefits as describes with reference to FIGS. 16A to 17.

According to one variation of the eleventh aspect, an augmented reality view is provided within a set of display panels of an augmented reality headset, the augmented reality headset being tracked within the tracking coordinate system. The moveable handheld device may comprise a handheld controller. In this case, receiving measurements of a plurality of locations upon a corresponding real-world surface in the construction site comprises, may comprise, for each location: determining a pose of the handheld controller in the tracking coordinate system; using an electronic distance measurement device, measuring a distance to an indicated remote point on the corresponding real-world surface; and using the pose of the handheld controller, the measured distance, and a known spatial configuration of the handheld controller, determining a location within the tracking coordinate system. Receiving measurements of a plurality of locations upon a corresponding real-world surface in the construction site may additionally or alternatively comprise: interfacing the handheld controller with the corresponding real-world surface; determining a pose of the handheld controller in the tracking coordinate system; and using the pose of the handheld controller and a known spatial configuration of the handheld controller, determining each of the plurality of locations within the tracking coordinate system. For example, the handheld controller may be physically placed upon the real-world surface.

According to another variation, the method comprises: obtaining a spatial definition of the plurality of model surfaces within the model coordinate system; obtaining a spatial definition of the planes of the corresponding real-world surfaces; and computing a transformation matrix that maps between the spatial definitions, the transformation matrix comprising rotation, translation, and scaling parameters. Indication of each of the plurality of model surfaces may be constrained such that the model surfaces are orthogonal. Obtaining an unaligned three-dimensional building information model may comprise using an augmented reality interface to filter portions of the unaligned three-dimensional building information model prior to the indication of the model surfaces within the augmented reality view.

If not explicitly stated, all of the publications referenced in this document are herein incorporated by reference. The above examples and aspects are to be understood as illustrative. Further examples and aspects are envisaged. Although certain components of each example and aspect have been separately described, it is to be understood that functionality described with reference to one example or and aspect may be suitably implemented in another example or and aspect, and that certain components may be omitted depending on the implementation. It is to be understood that any feature described in relation to any one example or and aspect may be used alone, or in combination with other features described, and may also be used in combination with one or more features of any other of the examples or and aspect, or any combination of any other of the examples or and aspect. For example, features described with respect to the system components may also be adapted to be performed as part of the described methods. Furthermore, equivalents and modifications not described above may also be employed without departing from the scope of the invention, which is defined in the accompanying claims.

1. A hard hat with at least one integrated electronic subsystem, the hard hat comprising:
an outer portion;
an inner portion, wherein the outer and inner portions are spaced apart within the hard hat, and the at least one integrated electronic subsystem is mounted between the outer and inner portions; and
a plurality of battery coupling interfaces for coupling a plurality of removable batteries,
wherein the integrated electronic subsystem comprises a power subsystem configured to draw power from a coupled one of the plurality of removable batteries to enable exchange of another of the plurality of removable batteries without power loss to the integrated electronic subsystem, wherein the plurality of battery coupling interfaces are laterally mounted within the hard hat and wherein each of the plurality of battery coupling interfaces comprises:
a battery socket positioned between the inner and outer portion; and
a detachable casing portion to receive one of the plurality of removable batteries, the detachable casing portion being couplable to the hard hat around the battery socket to align the one removable battery with the battery socket.

2. The hard hat of claim 1, wherein the detachable battery casing comprises:
a mechanical interface for coupling with the hard hat, and
a securing mechanism to secure the removable battery within the detachable battery casing when the detachable battery casing is not coupled to the hard hat,
wherein the securing mechanism is arranged to release the removable battery when the detachable battery casing is coupled to the hard hat via the mechanical interface.

3. The hard hat of claim 2, wherein the securing mechanism comprises a gripping mechanism, the gripping mechanism comprising:
a pivoted member; and
a force applying member,
wherein, when the detachable battery casing is not coupled to the hard hat, the force applying member applies a force to a first end of the pivoted member to frictionally secure the removable battery within the detachable battery casing, and
wherein, when the detachable battery casing is coupled to the hard hat, the mechanical interface applies a counteracting force to a second end of the pivoted member to move the pivoted member to release the removable battery within the detachable battery case.

4. The hard hat of claim 1, wherein the detachable battery casing further comprises:
a battery biasing member,
wherein, when the detachable battery casing is coupled to the hard hat, the battery biasing member applies a force to the removable battery to form an electrical connection between the removable battery and the integrated electronic subsystem of the hard hat.

5. The hard hat of claim 1, wherein the plurality of battery coupling interfaces are laterally mounted such that, when the removable batteries are coupled to the hard hat, the centre of gravity of the hard hat is below a circumferential rim of the hard hat.

6. The hard hat of claim 5, wherein the plurality of battery coupling interfaces are symmetrically aligned with respect to a front of the hard hat such that the centre of gravity of the hard hat is located on or near a midline of the hard hat.

7. The hard hat of claim 5, wherein the plurality of battery coupling interfaces are laterally mounted such that, when the removable batteries are coupled to the hard hat, the centre of gravity of the hard hat is located to the rear of the coupled removable batteries.

8. (canceled)

9. The hard hat of claim 1, wherein one or more of the plurality of removable batteries are further usable to power other peripheral devices used with the hard hat.

10. The hard hat of claim 1, wherein the plurality of battery coupling interfaces allow removal of at least one of the plurality of removable batteries during use on the head of a user, wherein the detachable casing portion is removable with a single hand of the user.

11. (canceled)

12. The hard hat of claim 1, wherein the integrated electronic subsystem comprises at least one processor and memory, wherein the integrated electronic subsystem comprises a compute module for an augmented reality system, and wherein each detachable casing portion forms a lateral wing to a viewing assembly for the augmented reality system.

13-14. (canceled)

15. The hard hat claim 1, wherein the outer portion comprises a polymer outer shell having a first thickness and the inner portion comprises a carbon fibre inner shell having a second thickness, the second thickness being less than the first thickness.

16. The hard hat of claim 15, wherein the first thickness is around 1.5 mm, the second thickness is around 0.8 mm, and wherein the outer and inner portions are spaced by approximately 20 mm for at least half of the circumference of the hard hat.

17. The hard hat of claim 1, wherein a first integrated electronic subsystem is mounted upon one or more of the inner portion and the outer portion at a rear of the hard hat between the outer and inner portions, wherein the first integrated electronic subsystem comprises a fan and a spacing between the outer and inner portions allows an air flow over the first integrated electronic subsystem.

18. (canceled)

19. The hard hat of claim 1, wherein the inner portion provides one or more of impact protection and penetration protection, and wherein the hard hat further comprises an impact foam arranged between the outer and inner portions.

20. (canceled)

21. The hard hat of claim 1, wherein:
the inner portion comprises ventilation apertures, and
the hard hat further comprises:
a deformable ventilation coupling for coupling the outer portion and the inner portion, the deformable ventilation coupling allowing air flow from the ventilation apertures to an exterior of the outer portion.

22. The hard hat of claim 21, wherein the deformable ventilation coupling comprises a waterproof seal to prevent water entering the ventilation apertures, wherein the deformable ventilation coupling is attached to the outer portion and the inner portion, wherein the deformable ventilation coupling comprises a rubber member, and wherein the outer portion comprises air vents that are aligned with the deformable ventilation coupling in use.

23. (canceled)

24. The hard hat of claim 1, wherein the deformable ventilation coupling comprises:
a first rigid frame for coupling to the inner portion;
a second rigid frame for coupling to the outer portion; and
a deformable suspension system arranged between the first and second rigid frames.

25-26. (canceled)

27. The hard hat of claim 1, comprising:
a cradle mounting;
a cradle for positioning the hard hat on a head of a user; and
a set of cradle mounting pins,
wherein the cradle comprises a plurality of spaced apertures that are adjustably alignable with corresponding apertures within the cradle mounting that receives the cradle, and
wherein the set of cradle mounting pins are removable to select different ones of the plurality of spaced apertures to adjust a relative height of the cradle compared to the cradle mounting for use.

28. The hard hat of claim 27, wherein the set of cradle mounting pins comprise quarter turn bayonet locking pins, and wherein the cradle mounting pins comprise a foldable handle, the foldable handle having a position substantially normal to a face of each mounting pin to turn the pin.

29. (canceled)

30. A hard hat with an integrated electronic subsystem comprising:
a plurality of battery coupling interfaces for coupling a plurality of removable batteries,
wherein the integrated electronic subsystem comprises a compute module for an augmented reality system,
wherein the integrated electronic subsystem comprises a power subsystem configured to draw power from a coupled one of the plurality of removable batteries to enable exchange of another of the plurality of removable batteries without power loss to the integrated electronic subsystem,
wherein each of the plurality of battery coupling interfaces comprises a battery socket and is configured to couple a detachable casing portion, the detachable casing portion being configured to receive one of the plurality of removable batteries, the detachable casing portion being couplable to the hard hat to align the one removable battery with the battery socket, and
wherein the plurality of battery coupling interfaces are laterally mounted on opposing sides of the hard hat and wherein, when coupled, each detachable casing portion forms a lateral wing to a viewing assembly for the augmented reality system.

31-93. (canceled)
